(19) United States
(12) Patent Application Publication
(10) Pub. No.: US 2011/0129196 A1
(43) Pub. Date: Jun. 2, 2011

(54) DISPLAY CONTROL APPARATUS, DISPLAY CONTROL SYSTEM, AND REMOTE CONTROL APPARATUS

(75) Inventor: Morihiko HAYASHI, Kanagawa (JP)

(73) Assignee: Sony Corporation, Tokyo (JP)

(21) Appl. No.: 12/914,158

(22) Filed: Oct. 28, 2010

(30) Foreign Application Priority Data
Nov. 27, 2009 (JP) 2009-269406

(51) Int. Cl. H04N 5/765; H04N 5/44

(52) U.S. Cl. 386/234; 348/734; 386/E05.002; 348/E05.096

(57) ABSTRACT

A display-control apparatus includes: an acquisition portion acquiring contents; a display controller displaying the contents on a display-portion; a user-detection portion detecting whether or not a user viewing the contents exist in the surrounding area; a communication controller controlling communication with a different display-control apparatus displaying the contents; and a controller configured so that, in the case where the contents are displayed by the different display-control apparatus, when the user does not exist in a surrounding area of the different display-control apparatus, after absence information indicating that the user does not exist, which is transmitted from the different display-control apparatus, is received by the communication controller, in the case where it is detected by the user-detection portion that the user exists, the controller allows the acquisition-portion to acquire the contents displayed by the different display-control apparatus which transmits the absence information and displays the contents on the display portion.

### BACKGROUND OF THE INVENTION

1. Field of the Invention

The invention relates to a display control apparatus, a display control system, and a remote control apparatus, and more particularly, to a display control apparatus, a display control system, and a remote control apparatus capable of improving convenience of an apparatus such as a TV (television set) which displays contents such as a television broadcast program.

2. Description of the Related Art

For example, in a TV, contents such as a television broadcasting program is received and displayed on a display panel such as a liquid crystal panel.

In a current TV, an operating mode of performing a normal operation such as display of contents on a display panel is referred to as a normal mode. In a recent TV, a power saving mode for saving power by limiting power supply to some blocks such as a backlight of the display panel or by performing power supply to only the minimum number of necessary blocks is provided as one of operating modes.

The power saving mode is an operating mode of which the power consumption is smaller (lower) than that of the normal mode. The operating mode is changed from the normal mode to the power saving mode if necessary, so that wasteful power consumption may be prevented (reduced).

For example, there is disclosed a TV having a function of changing the operating mode from the normal mode to the power saving mode if an absence of user (person) is detected (for example, refer to Japanese Unexamined Patent Application Publication No 2002-218343).

### SUMMARY OF THE INVENTION

The function of detecting the absence of user and changing the operating mode from the normal mode to the power saving mode is a function of an individual TV but it is not a function of considering cooperation with other TVs. Therefore, it is difficult to improve the convenience in cooperation with other TVs.

On the other hand, for example, when a user viewing contents through a TV in a living room moves to another room such as a bedroom, it is convenient that the contents that are viewed through the TV in the living are automatically displayed on a TV in the bedroom.

It is desirable to improve convenience of a contents displaying apparatus or the like such as a TV.

According to a first embodiment of the invention, there is provided a display control apparatus including: an acquisition portion configured to acquire contents; a display controller configured to display the contents on a display portion; a user detection portion configured to detect whether or not a user viewing the contents exist in the surrounding area; a communication controller configured to control communication with a different display control apparatus displaying the contents; and a controller configured so that, in the case where the contents are displayed by the different display control apparatus, when the user does not exist in a surrounding area of the different display control apparatus, after absence information indicating that the user does not exist, which is transmitted from the different display control apparatus, is received by the communication controller, in the case where it is detected by the user detection portion that the user exists, the controller allows the acquisition portion to acquire the contents which are displayed by the different display control apparatus which transmits the absence information and displays the contents on the display portion.

According to a second embodiment of the invention, there is provided a display control system including: a display control apparatus including: an acquisition portion configured to acquire contents; a display controller configured to display the contents on a display portion; a user detection portion configured to detect whether or not a user viewing the contents exist in the surrounding area; a communication controller configured to control communication with a different display control apparatus displaying the contents; and a controller configured so that, in the case where the contents are displayed by the different display control apparatus, when the user does not exist in a surrounding area of the different display control apparatus, after absence information indicating that the user does not exist, which is transmitted from the different display control apparatus, is received by the communication controller, in the case where it is detected by the user detection portion that the user exists, the controller allows the acquisition portion to acquire the contents which are displayed by the different display control apparatus which transmits the absence information and displays the contents on the display portion, and a different display control apparatus including: a different acquisition portion configured to acquire contents; a different display controller configured to display the contents on a different display portion; a different user detection portion configured to detect whether or not a user viewing the contents exist in the surrounding area; a different communication controller configured to control communication with the display control apparatus so that, in the case where the contents are displayed on the different display portion, when it is detected by the different user detection portion that the user does not exist, the different communication controller transmits the absence information to the display control apparatus.

According to a third embodiment of the invention, there is provided a remote control apparatus including: a communication controller configured to transmit a command of remotely controlling a display control apparatus which displays contents on a display portion; a user detection portion configured to detect movement of a user viewing the contents; a controller configured so that, in the case where the contents are displayed by the display control apparatus, after it is detected by the user detection portion that the user moves from a surrounding area of the display control apparatus, when it is detected that the user moves to a surrounding area of a different display control apparatus, the controller controls the different display control apparatus to display the contents displayed in the display control apparatus.

In the display control apparatus according to the first embodiment of the invention, the contents are acquired and displayed on the display portion. In addition, it is detected whether or not the user viewing the contents exists in the surrounding area, and the display control apparatus is configured to communicate with the different display control apparatus which displays the contents. In addition, in the case where the contents are displayed by the different display control apparatus, when the user does not exist in the surrounding area of the different display control apparatus, in the case where the absence information indicating that the user does not exist, which is transmitted from the different display control apparatus, is received and, after that, in the case where it is detected that the user exists, the contents which are displayed by the different display control apparatus which transmits the absence information are acquired and displayed on the display portion.

In the display control system according to the second embodiment of the invention, in the display control apparatus, in the case where the contents are displayed by the different display control apparatus, when the user does not exist in the surrounding area of the different display control apparatus, in the case where the absence information indicating that the user does not exist, which is transmitted from the different display control apparatus, is received, and after that, when it is detected that the user exists, the contents which are displayed by the different display control apparatus which transmits the absence information are acquired and displayed on the display portion. On the other hand, in the different display control apparatus, in the case where the contents are displayed, when it is detected that the user does not exist, the absence information is transmitted to the display control apparatus.

In the remote control apparatus according to the third embodiment of the invention, in the case where the contents are displayed by the display control apparatus, after it is detected that the user moves from the surrounding area of the display control apparatus, when it is detected that the user moves to the surrounding area of the different display control apparatus, the different display control apparatus is controlled so as to display the contents which are displayed in the display control apparatus.

In addition, the display control apparatus and the remote control apparatus may be separate apparatuses. Alternatively, the display control apparatus and the remote control apparatus may also be internal blocks constituting one apparatus.

According to the first to third embodiments of the invention, it is possible to improve convenience of the apparatus.

### BRIEF DESCRIPTION OF THE DRAWINGS

FIG. 1 is a diagram illustrating an example of a configuration of an embodiment of a home network system employing the invention.

FIG. 2 is a block diagram illustrating an example of a configuration of a recorder.

FIG. 3 is a block diagram illustrating an example of a configuration of a digital TV.

FIG. 4 is a block diagram illustrating an example of a configuration of a digital TV.

FIG. 5 is a block diagram illustrating a first example of a configuration of a mobile terminal.

FIG. 6 is a diagram illustrating a reverting process in a reverting mode #1 performed by a home network system.

FIG. 7 is a diagram illustrating a reverting process in a reverting mode #1 performed by a home network system.

FIG. 8 is a flowchart illustrating a process performed by a digital TV in a reverting process of a reverting mode #1.

FIG. 9 is a diagram illustrating a reverting process in a reverting mode #2 performed by a home network system.

FIG. 10 is a diagram illustrating a reverting process in a reverting mode #2 performed by a home network system.

FIG. 11 is a flowchart illustrating a process performed by a digital TV in a reverting process of a reverting mode #2.

FIG. 12 is a flowchart illustrating a process performed by a recorder in a reverting process of a reverting mode #2.

FIG. 13 is a diagram illustrating a reverting process in a reverting mode #3 performed by a home network system.

FIG. 14 is a diagram illustrating a reverting process in a reverting mode #3 performed by a home network system.

FIG. 15 is a flowchart illustrating a process performed by a digital TV in a reverting process of a reverting mode #3.

FIG. 16 is a flowchart illustrating a process performed by a recorder in a reverting process of a reverting mode #3.

FIG. 17 is a block diagram illustrating a second example of a configuration of a mobile terminal.

FIG. 18 is a diagram illustrating a reverting process in a reverting mode #1 performed by a home network system.

FIG. 19 is a flowchart illustrating a process performed by a mobile terminal in a reverting process of a reverting mode #1.

FIG. 20 is a diagram illustrating a reverting process in a reverting mode #2 performed by a home network system.

FIG. 21 is a flowchart illustrating a process performed by a mobile terminal in a reverting process of a reverting mode #2.

FIG. 22 is a diagram illustrating a reverting process in a reverting mode #3 performed by a home network system.

FIG. 23 is a flowchart illustrating a process performed by a mobile terminal in a reverting process of a reverting mode #3.

FIG. 24 is a block diagram illustrating a third example of a configuration of a mobile terminal.

FIG. 25 is a diagram illustrating a device information collection process performed by a mobile terminal.

FIGS. 26A to 26C are diagrams illustrating examples of a display screen displayed on an input/output mechanism of a mobile terminal.

FIG. 27 is a diagram illustrating an example of a device list.

FIG. 28 is a flowchart illustrating a process of a mobile terminal.

### DESCRIPTION OF THE PREFERRED EMBODIMENTS

### Embodiment of Home Network System Employing the Invention

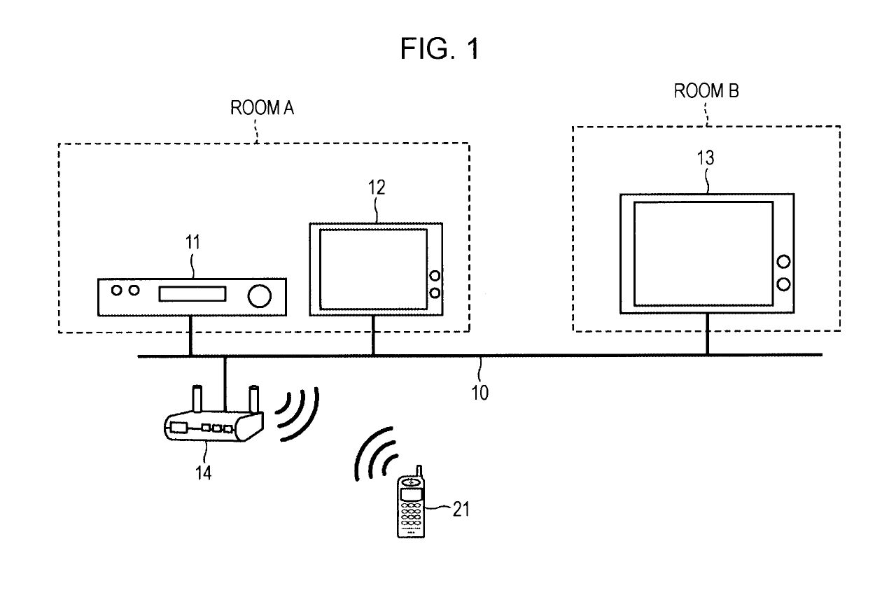

FIG. 1 is a diagram illustrating an example of a configuration of an embodiment of a home network system employing the invention. The term “system” denotes a logical set of plural apparatuses, and it is not considered whether or not constituent apparatuses are included within the same casing.

In FIG. 1, the home network system is configured to include a recorder 11, a digital TVs (digital television sets) 12 and 13, an access point 14, and a mobile terminal 21.

The network 10 is, for example, a wired LAN (Local Area Network). The recorder 11, the digital TVs 12 and 13, and the access point 14 are connected to the network 10. The recorder 11, the digital TVs 12 and 13, and the access point 14 are configured to communicate with each other through the network 10.

The recorder 11 has a recording reproducing function of recording and reproducing contents and is, for example, a HD (Hard Disk) recorder. The recorder 11 receives contents of a television broadcasting program or the like transmitted through a terrestrial wave, a satellite circuit, a CATV (Cable Television), or the like or from a server on the Internet and records the contents if necessary.

In addition, the recorder 11 reproduces the recorded contents and transmits the contents through the network 10 to the digital TV 12 or 13.

Similarly to the recorder 11, the digital TVs 12 and 13 receive the contents and display the contents (images corresponding to the contents).

In addition, the contents received through the terrestrial wave or the like may be exchanged through the network 10 between the recorder 11 and the digital TVs 12 and 13.

The access point 14 functions as a repeater of connecting clients (wireless LAN client) capable of performing wireless LAN communication and a bridge of connecting a wireless LAN and a wired LAN.

Therefore, the wireless LAN client may communicate through the access point 14 with the recorder 11 or the digital TVs 12 and 13, which are connected to the network 10 as a wired LAN.

The mobile terminal 21 is a small-sized terminal (PDA (Personal Digital Assistant)) that may be portably carried by a user. The mobile terminal 21 has at least a function as a remote commander (remote control apparatus) of remotely controlling an electronic device such as a recorder 11 and digital TVs 12 and 13 and a function as a wireless LAN client in FIG. 1.

The mobile terminal 21 transmits a command or the like of allowing the recorder 11 or the digital TVs 12 and 13 to perform a predetermined process in response to user's manipulation or the like through the wireless LAN.

The command or the like transmitted by the mobile terminal 21 is transmitted through the access point 14 and the network 10 to the recorder 11 or the digital TVs 12 and 13.

In addition, the mobile terminal 21 may have a function of transmitting a command to the recorder 11 or the digital TVs 12 and 13 through a method using infrared ray, Bluetooth (registered trade mark), or the like besides the wireless LAN.

In the home network system having the aforementioned configuration, for example, if a user manipulates the mobile terminal 21, the mobile terminal 21 transmits a command corresponding to the manipulation.

The command from the mobile terminal 21 is transmitted through the access point 14 and the network 10 to the recorder 11 or the digital TVs 12 and 13. In the recorder 11 or the digital TVs 12 and 13, according to the command from the mobile terminal 21, a predetermined process such as power on/off, channel selection, and volume adjustment is performed.

In addition, in FIG. 1, one recorder, that is, the recorder 11 and two TVs, that is, the digital TVs 12 and 13 are connected to the network 10. However, the number of recorders and TVs connected to the network 10 is not limited thereto.

In addition, in FIG. 1, the recorder 11 is connected through the network 10 to the digital TVs 12 and 13. However, the recorder 11 may be directly connected to the digital TV 12 or 13.

Moreover, the digital TV 12 or 13 may have recording reproducing functions that are the functions of the recorder 11. In this case, the later-described process of the recorder 11 may be performed by the digital TV 12 or 13 having the recording reproducing functions.

Herein, in FIG. 1, the recorder 11 and the digital TV 12 are installed, for example, in a room A such as a living room of user's house. In addition, the digital TV 13 is installed in a room different from the room A, for example, in a room B such as a bedroom.

In the home network system of FIG. 1, the following reverting process is performed.

The reverting process is a process of, in the case where a user viewing contents takes action of stopping viewing the contents and, after that, the state that contents are able to be viewed is established, reverting (reproducing) a contents presenting (displaying) state so as to be near to the state at the time of stopping the viewing of the contents. In the embodiment, there are reverting processes of the three reverting modes #1, #2, and #3.

In the reverting mode #1, for example, in the case where a user viewing contents broadcasted through a channel takes action of stopping viewing the contents and, after that, the state that contents are able to be viewed by the user is established, the contents (actually) broadcasted through the channel which broadcasts the contents of which the viewing is stopped are presented.

In the reverting mode #2, for example, in the case where a user viewing contents broadcasted through a channel takes action of stopping viewing the contents, the recording of the contents are started from the time of stopping the viewing of the contents, and after that, in the case where the state that contents are able to be viewed by the user is established, the recorded contents are reproduced.

In the reverting mode #3, in the case where a user viewing recorded contents takes action of stopping viewing the contents, the reproducing of the recorded contents is stopped, and after that, in the case where the state that contents are able to be viewed by the user is established, the reproducing of the recorded contents is restarted.

### Example of Configuration of Recorder 11

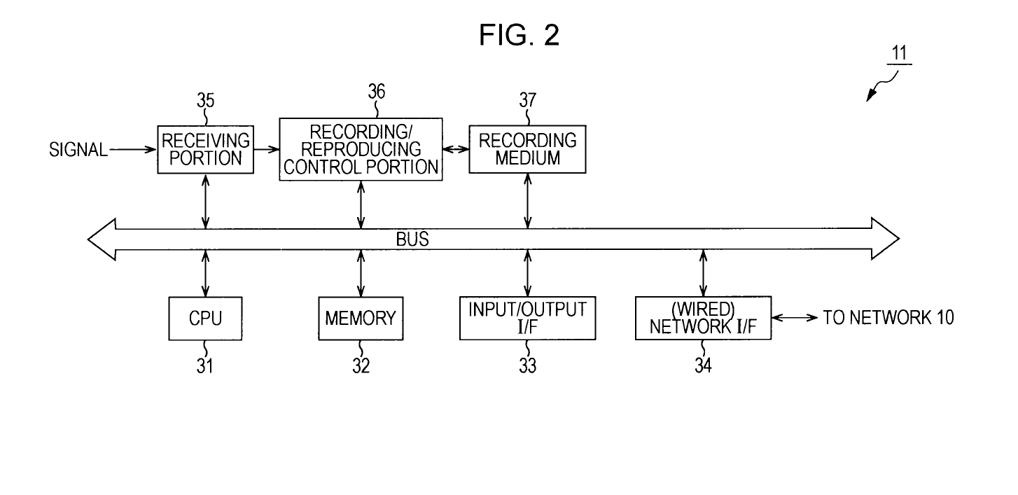

FIG. 2 is a block diagram illustrating an example of a configuration of the recorder 11 of FIG. 1.

In FIG. 2, the recorder 11 is configured by connecting a CPU (Central Processing Unit) 31, a memory 32, an input/output I/F (Interface) 33, a network I/F 34, a receiving portion 35, a recording reproducing control portion 36, and a recording medium 37 to each other through a bus.

The CPU 31 performs controlling blocks constituting the recorder 11 and other various processes by executing programs stored in the memory 32.

The memory 32 stores data or the like which are used for operations of the CPU 31.

The input/output I/F 33 is an interface for controlling input and output with respect to external portions. Devices such as buttons (keyboard) (not shown), a display panel, and a speaker for performing input and output with respect to the external portions are connected thereto.

The network I/F 34 is an interface for controlling communication with the wired network 10 such as a wired LAN. The network 10 is connected thereto.

The network I/F 34 controls communication with the digital TV 12 or 13 through the network 10 and controls communication with the mobile terminal 21 through the access point 14.

The receiving portion 35 is, for example, a TV tuner. A television broadcasting signal such as a terrestrial wave is supplied to the receiving portion 35.

The receiving portion 35 receives the supplied television broadcasting signal, acquires contents of a television broadcasting program (image and audio data thereof) of a predetermined channel by extracting a television broadcasting signal of the predetermined channel from the television broadcasting signal and supplies the contents to the recording reproducing control portion 36.

The recording reproducing control portion 36 controls recording the contents in the recording medium 37 and reproducing the contents.

In other words, the recording reproducing control portion 36 records the contents from the receiving portion 35 in the recording medium 37. In addition, the recording reproducing control portion 36 reproduces the contents recorded in the recording medium 37 from the recording medium 37.

Herein, the contents reproduced from the recording medium 37 may be transmitted from the network I/F 34 through the network 10 to the digital TV 12 or 13.

In addition to recording the contents acquired by the receiving portion 35 in the recording medium 37, the recording reproducing control portion 36 may transmits the contents from the network I/F 34 through the network 10 to the digital TV 12 or 13.

Moreover, as described later, the recording reproducing control portion 36 may receive the contents, which are transmitted through the network 10 by the digital TV 12 or 13, through the network I/F 34 and record the contents in the recording medium 37.

The recording medium 37 is constructed with, for example, an HD or a semiconductor memory. The contents are recorded on the recording medium 37 under the control of the recording reproducing control portion 36.

In addition to a configuration where the programs executed by the CPU 31 are stored (recorded) in the memory 32 in advance, the programs may be recorded in a removable recording medium such as an optical disk, a magneto-optical disk, a magnetic disk, and a semiconductor memory, and the programs may be installed in the recorder 11 from the removable recording medium.

In addition, the programs executed by the CPU 31 may be, for example, downloaded from a server on the Internet or transmitted in a state that the contents are included in a television broadcasting signal and may be installed in the recorder 11.

### Example of Configuration of Digital TVs 12 and 13

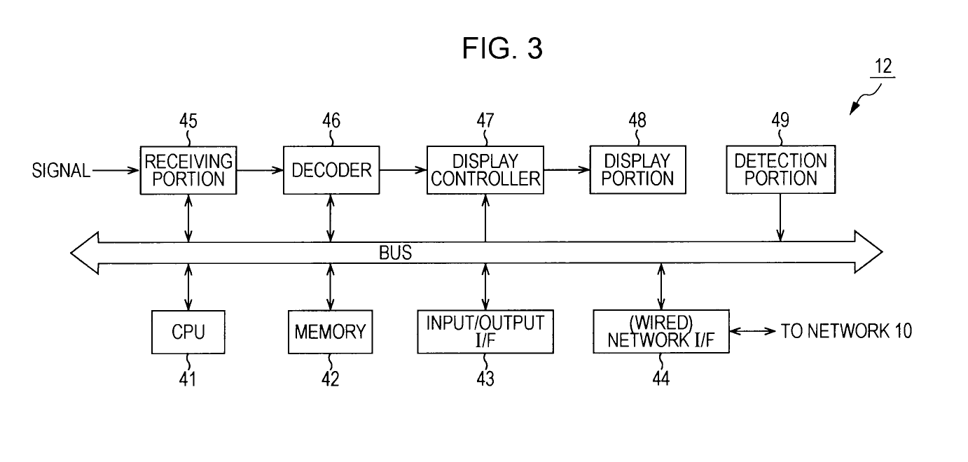

FIG. 3 is a block diagram illustrating an example of a configuration of the digital TV 12 of FIG. 1.

In FIG. 3, the digital TV 12 is configured to include a CPU 41, a memory 42, an input/output I/F 43, a network I/F 44, a receiving portion 45, a decoder 46, a display controller 47, a display portion 48, and a detection portion 49. Among the CPU 41 to the detection portion 49, the blocks excluding the display portion 48 are connected to each other through a bus.

The CPU 41 performs controlling blocks constituting the digital TV 12 and other various processes by executing programs stored in the memory 42.

The memory 42 stores data or the like which are used for operations of the CPU 41.

The input/output I/F 43 is an interface controlling input and output with respect to external portions. Devices such as buttons (keyboard) (not shown) for performing input and output with respect to the external portions are connected thereto.

The network I/F 44 is an interface for controlling communication with the wired network 10 such as a wired LAN. The network 10 is connected thereto.

The network I/F 44 controls communication with the recorder 11 or the digital TV 13 through the network 10 and controls communication with the mobile terminal 21 through the access point 14.

The receiving portion 45 is, for example, a TV tuner. A television broadcasting signal such as a terrestrial wave is supplied to the receiving portion 45.

The receiving portion 45 receives the supplied television broadcasting signal, acquires contents of a television broadcasting program of a predetermined channel by extracting a television broadcasting signal of the predetermined channel from the television broadcasting signal and supplies the contents to the decoder 46.

Herein, in addition to supplying the contents acquired by the receiving portion 45 to the decoder 46, the contents may be transmitted from the network I/F 44 through the network 10 to the recorder 11 or the digital TV 13.

In the case where the contents from the receiving portion 45 are not encoded, the decoder 46 supplies the contents to the display controller 47. In addition, in the case where the contents from the receiving portion 45 are encoded, the decoder 46 decodes the contents and supplies the decoded contents to the display controller 47.

Herein, in addition to the contents from the receiving portion 45, the decoder 46 receives contents, which are transmitted through the network 10 from the recorder 11 or the digital TV 13, through the network I/F 44 and supplies the contents.

The display controller 47 performs display controlling to display the contents (images thereof) from the decoder 46 on the display portion 47.

The display portion 48 is constructed with, for example, a liquid crystal panel, an organic EL (Electro Luminescence) panel, or the like to display contents or the like under the control of the display controller 47.

The detection portion 49 detects whether or not a user viewing the contents exists in the surrounding area (of the digital TV 12).

Herein, in the detection portion 49, the surrounding area is photographed by, for example, a camera, and an image process is performed on an image obtained by the photographing, so that it may be detected whether or not a user exists in the surrounding area. In the case where it is detected by performing an image process on the image photographed by a camera whether or not a user exists, when it is detected that a user exists, face recognition (person recognition) is further performed, so that the user may be identified.

Besides, in the detection portion 49, it may be detected by using, for example, a vibration sensor, a ultrasonic sensor, an infrared pyroelectric sensor, or the like whether or not a user exists.

In addition to a configuration where the programs executed by the CPU 41 are stored (recorded) in the memory 42 in advance, the programs may be recorded in a removable recording medium such as an optical disk, a magneto-optical disk, a magnetic disk, and a semiconductor memory, and the programs may be installed in the digital TV 12 from the removable recording medium.

In addition, the programs executed by the CPU 41 may be, for example, downloaded from a server on the Internet or transmitted in a state that the contents are included in a television broadcasting signal and may be installed in the digital TV 12.

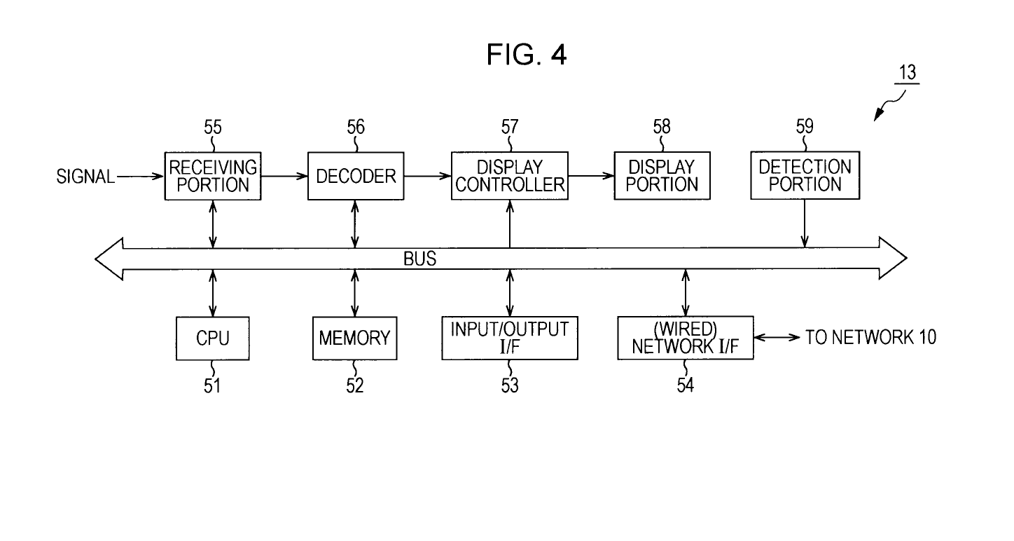

FIG. 4 is a block diagram illustrating an example of a configuration of the digital TV 13 of FIG. 1.

In FIG. 4, the digital TV 13 is configured to include a CPU 51, a memory 52, an input/output I/F 53, a network I/F 54, a receiving portion 55, a decoder 56, a display controller 57, a display portion 58, and a detection portion 59.

The CPU 51 to the detection portion 59 are configured to be similar to the CPU 41 to the detection portion 49 of FIG. 3. Therefore, the description thereof is omitted.

In addition, in FIG. 3, the digital TV 12 includes the display portion 48 of displaying contents. Therefore, the digital TV 12 may function as a display apparatus of displaying contents on the whole. However, the digital TV 12 may be dividably constructed with an apparatus including the CPU 41 to the display controller 47 and the detection portion 59 and an apparatus including the display portion 48. In this case, the apparatus including the CPU 41 to the display controller 47 and the detection portion 59 functions as a display control apparatus for allowing the display portion 48 (the apparatus including the display portion 48) to display images.

The digital TV 13 may be configured to be similar to the digital TV 12.

In addition, in the recorder 11 of FIG. 2, the receiving portion 35 functions as an acquisition portion of acquiring contents by receiving the contents transmitted as television broadcasting signals. The network I/F 34 also functions as an acquisition portion of acquiring contents by receiving the contents transmitted from the digital TV 11 or 12 through the network 10. The same description may be made with respect to the network I/F 44 of FIG. 3 and the network I/F 54 of FIG. 4.

Herein, the network I/Fs 34, 44, and 54 which function as an acquisition portion may also acquire contents of television broadcasting program or the like transmitted from, for example, a server on the Internet.

### First Example of Configuration of Mobile Terminal 21

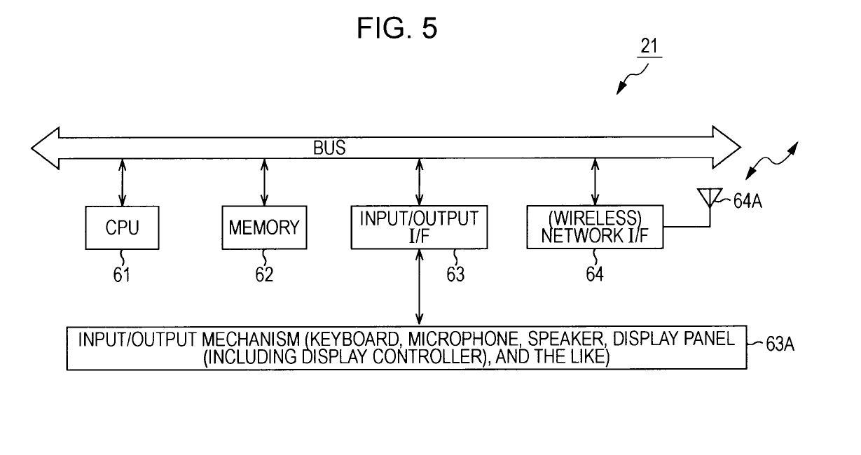

FIG. 5 is a block diagram illustrating a first example of a configuration of the mobile terminal 21 of FIG. 1.

In FIG. 5, the mobile terminal 21 is configured to include a CPU 61, a memory 62, an input/output I/F 63, an input/output mechanism 63A, a network I/F 64, and an antenna 64A. Among the CPU 61, the memory 62, the input/output I/F 63, the input/output mechanism 63A, the network I/F 64, and the antenna 64A, the CPU 61, the memory 62, the input/output I/F 63, and the network I/F 64 are connected to each other through a bus.

The CPU 61 performs controlling blocks constituting the mobile terminal 21 and other various processes by executing programs stored in the memory 62.

The memory 62 stores data or the like which are used for operations of the CPU 61.

The input/output I/F 63 is an interface for controlling input and output with respect to external portions. The input/output mechanism 63A is connected thereto.

The input/output mechanism 63A is a device for performing inputting and outputting with respect to the external portions and includes, for example, a keyboard (buttons), a touch panel, a microphone, a speaker, a display panel or the like.

The network I/F 64 is an interface for controlling communication with, for example, a wireless LAN. The network I/F 64 controls communication with the recorder 11 or the digital TVs 12 and 13 connected to the network 10 by transmitting and receiving signals to and from the access point 14 (FIG. 1) through the antenna 64A.

In addition to a configuration where the programs executed by the CPU 61 are stored (recorded) in the memory 62 in advance, the programs may be recorded in a removable recording medium such as an optical disk, a magneto-optical disk, a magnetic disk, and a semiconductor memory, and the programs may be installed in the mobile terminal 21 from the removable recording medium.

In addition, the programs executed by the CPU 61 may be, for example, downloaded from a server on the Internet or transmitted in a state that the contents are included in a television broadcasting signal and may be installed in the mobile terminal 21.

### Reverting Process of Reverting Mode #1

A reverting process of a reverting mode #1 performed by the home network system of FIG. 1 is described.

In the reverting process of the reverting mode #1, as described above, for example, in the case where a user viewing contents broadcasted through a channel takes the action of stopping viewing the contents and, after that, the user is in a state of capable of viewing the contents, the contents that have been broadcasted through the channel which has broadcasted the viewing-stopped contents are recommended.

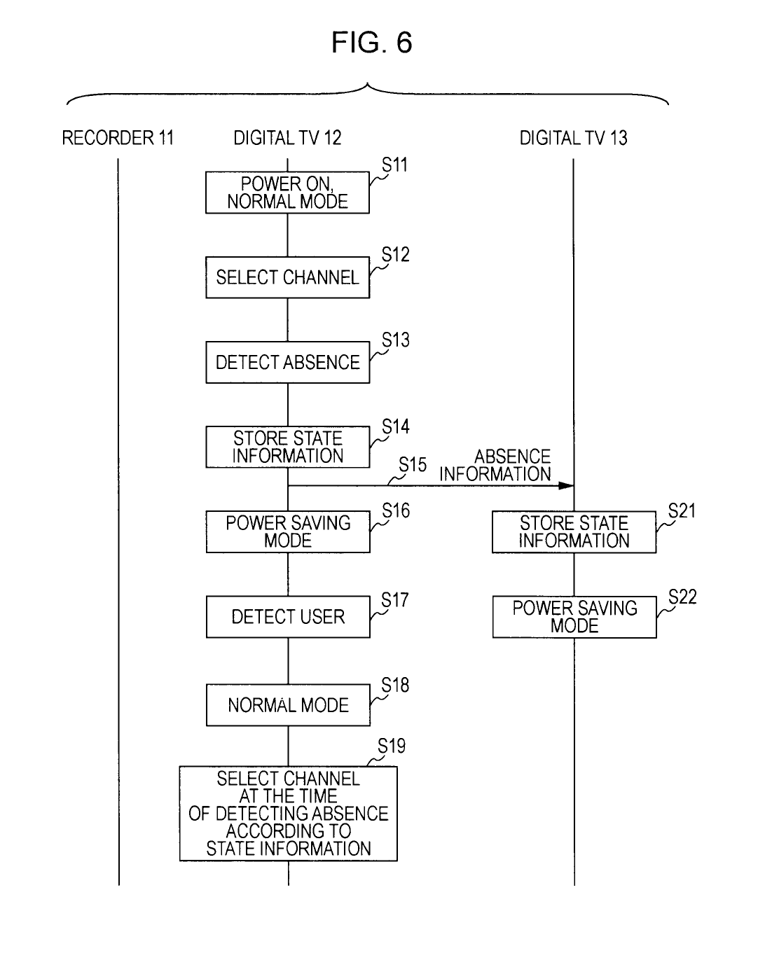

FIG. 6 is a diagram illustrating the reverting process in the reverting mode #1 performed, for example, in the case where a user viewing contents broadcasted through a channel by the digital TV 12 in the room A temporarily leaves the room A due to something to do and comes back to the room A.

For example, if the user manipulates the input/output mechanism 63A of the mobile terminal 21 (FIG. 5) so as to power on the digital TV 12 in the room A, the network I/F 64 of the mobile terminal 21 transmits a command corresponding to the manipulation.

The command from the mobile terminal 21 is received by the network I/F 44 of the digital TV 12 (FIG. 3) and supplied to the CPU 41.

In Step S11, the CPU 41 allows the digital TV 12 to be powered on and sets the operating mode to the normal mode according to the command from the mobile terminal 21.

After that, in the digital TV 12, a predetermined channel is selected, and the contents broadcasted through the channel is displayed on the display portion 48.

In other words, in the digital TV 12 (FIG. 3), the receiving portion 45 acquires the contents broadcasted through the channel by extracting, for example, the television broadcasting signal of the channel which have been extracted at the time of powering off in the last broadcasted program from the television broadcasting signal supplied thereto.

The contents acquired by the receiving portion 45 are supplied through the decoder 46 and the display controller 47 to the display portion 48 and displayed thereon.

Accordingly, the user may view the contents.

Herein, in the display portion 48, the images among the contents acquired by the receiving portion 45 are displayed. The sound among the contents acquired by the receiving portion 45 is output from the speaker (not shown). However, the description with respect to the sound is omitted.

In addition, if the user manipulates the input/output mechanism 63A of the mobile terminal 21 (FIG. 5) so as to select a predetermined channel, the network I/F 64 of the mobile terminal 21 transmits a command corresponding to the manipulation.

The command from the mobile terminal 21 is received by the network I/F 44 of the digital TV 12 (FIG. 3) and supplied to the CPU 41.

The CPU 41 controls the receiving portion 45 so as to select a predetermined channel according to the command from the mobile terminal 21.

In this case, in Step S12, the receiving portion 45 acquires contents broadcasted through the predetermined channel by extracting a television broadcasting signal of the predetermined channel from the television broadcasting signal supplied thereto according to the control of the CPU 41.

In this manner, in the case where the contents are displayed on the display portion 48 of the digital TV 12, when the user viewing the contents displayed on the display portion 48 leaves the room A where the digital TV 12 is installed, for example, due to something to do and disappears from the surrounding area of the digital TV 12, in Step S13, the detection portion 49 detects that the user does not exist in the surrounding area of the digital TV 12 (absence is detected).

In the case where the contents are displayed on the display portion 48 of the digital TV 12, if the absence is detected by the detection portion 49, in Step S14, the CPU 41 of the digital TV 12 generates the state information indicating the state of the digital TV 12 at this time, that is, at the time when it is detected that the user viewing the contents displayed on the display portion 48 does not exist in the surrounding area of the digital TV 12 and stores the state information in the memory 42.

Herein, the state information includes information indicating the channel that is selected (extracted) by the receiving portion 45 of the digital TV 12 or the sound volume state.

After that, in Step S15, the network I/F 44 of the digital TV 12 transmits the absence information indicating that the user does not exist in the surrounding area (of the digital TV 12) together with the state information to another TV (all the TVs other than the digital TV 12), that is, the digital TV 13 on the network 10.

Moreover, in Step S16, the CPU 41 of the digital TV 12 changes the operating mode of the digital TV 12 from the normal mode to the power saving mode.

In this manner, in the case where the contents are displayed on the display portion 48 of the digital TV 12, if the absence is detected by the detection portion 49, the digital TV 12 transmits the absence information and the state information to another TV, that is, the digital TV 13.

Moreover, the digital TV 12 sets the operating mode to the power saving mode.

Therefore, when the user does not view the contents, wasteful power consumption caused by displaying the contents on the display portion 48 may be prevented (reduced).

On the other hand, in the digital TV 13, if the absence information and the state information are transmitted from the digital TV 12, the network I/F 54 (FIG. 4) receives the absence information and the state information from the digital TV 12 and supplies the absence information and the state information to the CPU 51.

In Step S21, the CPU 51 of the digital TV 13 stores the state information from the digital TV 12 in the memory 52.

Moreover, in Step S22, the CPU 51 powers on the digital TV 13 in response to the absence information from the digital TV 12 and sets the operating mode to the power saving mode.

In addition, in the digital TV 13, at the time when the absence information is received from the digital TV 12, in the case where the digital TV 13 is in the power-on state and the operating mode is set to the normal mode, there is a high possibility that another user viewing contents through digital TV 13 in the room B (a user different from the user who viewed the contents through digital TV 12 in the room A) exists. Accordingly, in order to prevent interrupting another user in the room B from viewing contents, the CPU 51 does not perform the processes of Steps S21 and S22.

In addition, in the digital TV 13, at the time when the absence information is received from the digital TV 12, in the case where the digital TV 13 is in the power-on state but the operating mode is set to the power saving mode, the CPU 51 performs the process of Step S21 but it does not perform (may not necessarily perform) the process of Step S22.

After it is detected that the user does not exist in the surrounding area of the digital TV 12 and, thus, the operating modes of the digital TVs 12 and 13 are set to the power saving mode, for example, if the user comes back to the room A where the digital TV 12 is installed, after finishing something to do, in Step S17, the detection portion 49 of the digital TV 12 (FIG. 3) detects that the user exists (person is detected).

In the detection portion 49 of the digital TV 12, if the existence of a user is detected, in Step S18, the CPU 41 of the digital TV 12 changes (reverts) the operating mode of the digital TV 12 from the power saving mode to the normal mode.

Moreover, in Step S19, the CPU 41 controls the receiving portion 45 so as to select a channel indicated by the state information according to the state information stored in the memory 42 just before (in Step S14).

The receiving portion 45 acquires the contents broadcasted through the channel which is selected at the time of absence detection by extracting the television broadcasting signal of the predetermined channel from the television broadcasting signals supplied thereto according to the control of the CPU 41 and supplies the contents through the decoder 46 and the display controller 47 to the display portion 48.

Accordingly, the digital TV 12 is in the reverted state where the contents presenting (displaying) state reverts to the state (a state near to the state) at the time when the user leaves the room A.

Therefore, the user may restart the viewing of the contents broadcasted through the channel, through which the user views the contents just before leaving the room A where the digital TV 12 is installed, without particularly manipulating the digital TV 12 which is in the power saving mode.

In addition, in the case where the absence is detected and, thus, the operating mode is set to the power saving mode, the digital TV 12 operates a timer to count time elapsing after entering into the power saving mode. Next, after entering into the power saving mode, in the case where the user is not detected and a predetermined time, for example, one hour elapses, the digital TV 12 erases the state information stored in the memory 42 (FIG. 3), and the digital TV 12 is allowed to be powered off.

In the case where the user is not detected although some time elapses, it may be estimated that the user does not desire to view the channel (the contents thereof), through which the user viewed the contents just before the operating mode enters into the power saving mode, after that.

In addition, in the digital TV 12, the detection portion 49 (FIG. 3) may detect whether or not a specific user exists.

In other words, in the digital TV 12, in the case where the absence is detected by the detection portion 49 and, thus, the operating mode is set to the power saving mode, after that, with respect to only the (specified) users of which the absence is detected, the detection portion 49 detects whether or not the users exist.

In the case where it is detected by the detection portion 49 whether or not an arbitrary user, but not a specific user, exists, although a user other than the user who leaves the room A enters the room A, the contents presenting state of the digital TV 12 becomes the reverted state. However, in the case where it is detected by the detection portion 49 with respect to only the user whose absence is detected whether or not the user exists, only when the user who leaves the room A comes back to the room A, the contents presenting state of the digital TV 12 becomes the reverted state.

Moreover, in the detection portion 49, in the case where the existence of user is detected, a line of sight of the user may also be detected.

In addition, in the case where the line of sight of the user is directed to the display portion 48 continuously for a predetermined time or more, for example, one second, several seconds, or the like, it is recognized that the user expresses intention of restarting the viewing of the contents, so that the contents presenting state of the digital TV 12 may become the reverted state.

In this case, when the contents presenting state may not necessarily become the reverted state, for example, when the user leaving the room A temporarily comes back to the room A or when the user coming back to the room A does not have intention of restarting the viewing of the contents, the contents presenting state may be prevented from becoming the reverted state.

Similarly, in the digital TV 13 (FIG. 4), the aforementioned timer or the configuration of detecting whether or not a specified user exists or the configuration of detecting the line of sight of the user in the detection portion 59 may be employed.

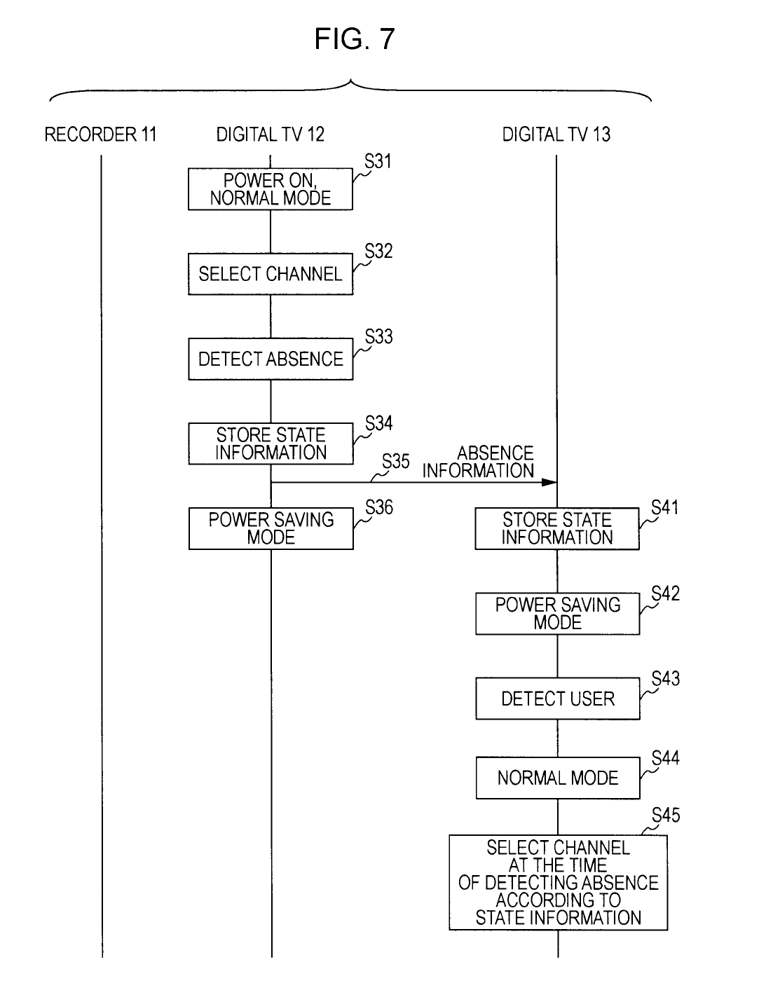

FIG. 7 is a diagram illustrating a reverting process in a reverting mode #1 performed, for example, in the case where a user viewing contents broadcasted through a channel by the digital TV 12 in the room A leaves the room A due to something to do and does not come back to the room A but enter the room B.

For example, if the user manipulates the input/output mechanism 63A of the mobile terminal 21 (FIG. 5) so as to power on the digital TV 12 in the room A, in Steps S31 and S32, the digital TV 12 performs the same processes as those of Steps S11 and S12 of FIG. 6.

In other words, the digital TV 12 (FIG. 3) is allowed to be powered on, and the operating mode is set to the normal mode. Moreover, in the digital TV 12, the contents broadcasted through a predetermined channel are acquired by the receiving portion 45 and are displayed on the display portion 48.

In this manner, in the case where the contents are displayed on the display portion 48 of the digital TV 12, for example, if the user viewing the contents displayed on the display portion 48 leaves the room A, where the digital TV 12 is installed, due to something to do and does not exist in the surrounding area of the digital TV 12, in the digital TV 12, in Steps S33 to S36, the same processes as those of Steps S13 to S16 of FIG. 6 are performed.

In other words, in Step S33, the detection portion 49 performs absence detection, and in Step S34, the CPU 41 generates state information and stores the state information in the memory 42.

Moreover, in Step S35, the absence information and the state information are transmitted from the digital TV 12 to the digital TV 13, and in Step S36, the operating mode of the digital TV 12 is changed from the normal mode to the power saving mode.

Herein, in this manner, in the case where the contents are displayed on the display portion 48 of the digital TV 12, if the absence is detected by the detection portion 49, the digital TV 12 sets the operating mode to the power saving mode. Therefore, when the user does not view the contents, wasteful power consumption caused by displaying the contents on the display portion 48 may be prevented.

On the other hand, in the digital TV 13, if the absence information and the state information are transmitted from the digital TV 12, the network I/F 54 (FIG. 4) receives the absence information and the state information from the digital TV 12 and supplies the absence information and the state information to the CPU 51.

Similarly to Step S21 of FIG. 6, in Step S41, the CPU 51 of the digital TV 13 stores the state information from the digital TV 12 in the memory 52.

Moreover, similarly to Step S22 of FIG. 6, in Step S42, the CPU 51 powers on the digital TV 13 in response to the absence information from the digital TV 12 and sets the operating mode to the power saving mode.

After it is detected that the user does not exist in the surrounding area of the digital TV 12 and, thus, the operating modes of the digital TVs 12 and 13 are set to the power saving mode, for example, if the user who finishes something to do does not come back to the room A where the digital TV 12 is installed but enters the room B where the digital TV 13 is installed, in Step S43, the detection portion 59 of the digital TV 13 (FIG. 4) detects that the user exists (person is detected).

In the detection portion 59 of the digital TV 13, if the existence of user is detected, in Step S44, the CPU 51 of the digital TV 13 changes the operating mode of the digital TV 13 from the power saving mode to the normal mode.

Moreover, in Step S45, the CPU 51 controls the receiving portion 55 so as to select the channel indicated by the state information according to the state information stored in the memory 52 just before (in Step 41).

The receiving portion 55 acquires the contents broadcasted through the channel which is selected at the time of absence detection in the digital TV 12 by extracting the television broadcasting signal of the predetermined channel from the television broadcasting signals supplied thereto according to the control of the CPU 51 and supplies the contents through the decoder 56 and the display controller 57 to the display portion 58 to be displayed.

In this manner, in the digital TV 13 (FIG. 4), in the case where the network I/F 54 receives the absence information and the state information from the digital TV 12, and after that, the existence of user is detected by the detection portion 59, the contents displayed in the digital TV 12 which transmits the absence information are acquired by the receiving portion 55 and displayed on the display portion 58.

Accordingly, the digital TV 13 in the room B is in the reverted state where the contents presenting (displaying) state reverts to the state (a state near to the state) at the time when the user leaves the room A.

Therefore, in the case where the user viewing the contents through the digital TV 12 in the room A enters the room B, the user may restart the viewing of the contents broadcasted through the channel, through which the user viewed the contents just before leaving the room A where the digital TV 12 is installed, without particularly manipulating the digital TV 13 in the room B.

In this manner, since the digital TV 13 in the room B is in the reverted state where contents presenting state reverts to the state at the time when the user leaves the room A, it is possible to improve the convenience of the digital TVs 12 and 13 according to the absence detection in comparison with the case where the operating mode is only set to the power saving mode.

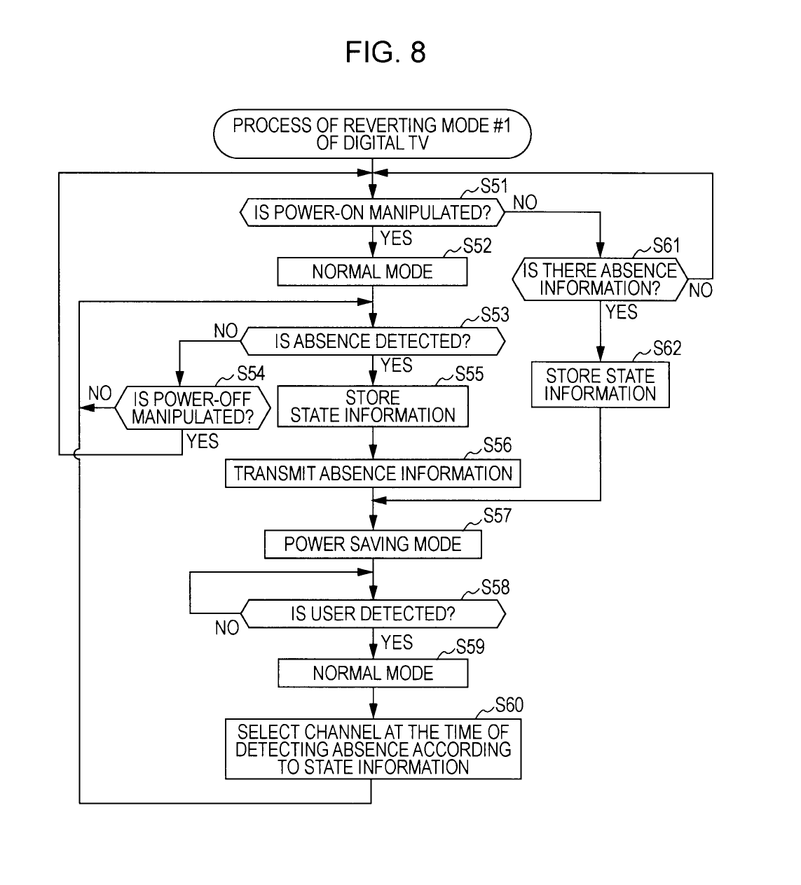

FIG. 8 is a flowchart illustrating a process performed by the digital TV 12 in a reverting process of a reverting mode #1.

In addition, the digital TV 13 also performs the same processes as those of the digital TV 12.

In Step S51, the CPU 41 of the digital TV 12 (FIG. 3) determines whether or not the mobile terminal 21 (FIG. 1) is manipulated so as to power on the digital TV 12.

In Step S51, in the case where the mobile terminal 21 is determined to be manipulated so as to power on the digital TV 12, that is, in the case where a command of requesting for powering on the digital TV 12 is transmitted from the mobile terminal 21 to the digital TV 12, the CPU 41 of the digital TV 12 powers on the digital TV 12 according to the command from the mobile terminal 21, and the process proceeds to Step S52.

In Step S52, the CPU 41 sets the operating mode of the digital TV 12 to the normal mode, and the process proceeds to Step S53.

Herein, in the digital TV 12, if the operating mode is set to the normal mode, a predetermined channel is selected, and contents broadcasted through the channel are displayed on the display portion 48 (FIG. 3).

In Step S53, the CPU 41 determines whether or not it is detected that the user does not exist in the surrounding area of the digital TV 12.

In Step S53, in the case where it is determined that the user does not exist in the surrounding area of the digital TV 12, that is, in the case where the absence is not detected by the detection portion 49 (FIG. 3), the process proceeds to Step S54. The CPU 41 determines whether or not the mobile terminal 21 (FIG. 1) is manipulated so as to power off the digital TV 12.

In Step S54, in the case where it is determined that the mobile terminal 21 is manipulated so as to power off the digital TV 12, that is, in the case where a command of requesting for powering off the digital TV 12 is transmitted from the mobile terminal 21 to the digital TV 12, the CPU 41 of the digital TV 12 powers off the digital TV 12 according to the command from the mobile terminal 21, and the process returns to Step S51.

In addition, in Step S54, in the case where it is determined that the mobile terminal 21 is not manipulated so as to power off the digital TV 12, the process returns to Step S53.

Next, in Step S53, in the case where it is determined that the user is detected not to exist in the surrounding area of the digital TV 12, that is, in the case where the absence is detected by the detection portion 49 (FIG. 3), the process proceeds to Step S55. The CPU 41 (FIG. 3) generates state information indicating the digital TV 12 state at the time when the absence is detected.

Moreover, in Step S55, the CPU 41 stores the state information in the memory 42, and the process proceeds to Step S56.

In Step S56, the network I/F 44 of the digital TV 12 transmits the absence information indicating that the user does not exist in the surrounding area (of the digital TV 12) together with the state information to another TV, that is, the digital TV 13 on the network 10, and the process proceeds to Step S57.

In Step S57, the CPU 41 changes the operating mode of the digital TV 12 from the normal mode to the power saving mode, and the process proceeds to Step S58.

By changing the operating mode of the digital TV 12 to the power saving mode, the digital TV 12 stops displaying the contents on the display portion 48 to be in the state that the digital TV 12 is operated with a necessary minimum power.

In this manner, after the operating mode of the digital TV 12 is set to the power saving mode, in Step S58, the CPU 41 determines whether or not the existence of user in the surrounding area is detected.

In Step S58, in the case where it is determined that the existence of user in the surrounding area is not detected, the process returns to Step S58.

Herein, in this manner, in Step S57, in the case where the operating mode of the digital TV 12 is set to the power saving mode, the digital TV 12 operates a timer to count time elapsing after entering into the power saving mode. Next, after entering into the power saving mode, in Step S58, in the case where the user is not determined to be detected and a predetermined time, for example, one hour elapses, the digital TV 12 erases the state information stored in the memory 42 (FIG. 3), and the digital TV 12 is allowed to be powered off. The process returns to Step S51.

On the other hand, in Step S58, in the case where it is determined that the existence of user in the surrounding area is detected, that is, in the case where the existence of user in the surrounding area is detected by the detection portion 49, the process proceeds to Step S59. The CPU 41 changes the operating mode of the digital TV 12 from the power saving mode to the normal mode, and the process proceeds to Step S60.

In Step S60, the CPU 41 controls the receiving portion 45 so as to select the channel indicated by the state information according to the state information stored in the memory 42 in the just-preceding Step S55 or the later-described Step S62, and the process returns to Step S53.

The receiving portion 45 acquires the contents broadcasted through the channel which is selected at the time of absence detection by extracting the television broadcasting signal of the predetermined channel from the television broadcasting signals supplied thereto according to the control of the CPU 41 and supplies the contents through the decoder 46 and the display controller 47 to the display portion 48 to display the contents on the display portion 48.

On the other hand, in Step S51, in the case where it is determined that the mobile terminal 21 (FIG. 1) is not manipulated so as to power on the digital TV 12, the process proceeds to Step S61. The CPU 41 (FIG. 3) determines whether or not the absence information from another TV, that is, the digital TV 13 is received by the network I/F 44.

In Step S61, in the case where it is determined that the absence information from the digital TV 13 is not received by the network I/F 44, that is, in the case where the absence information is not transmitted from the digital TV 13, the process returns to Step S51.

In addition, in Step S61, in the case where it is determined that the absence information from the digital TV 13 is received by the network I/F 44, that is, in the case where the absence information together with the state information is transmitted from the digital TV 13, the process proceeds to Step S62. The CPU 41 stores the state information, which is transmitted together with the absence information from the digital TV 13, in the memory 42.

After that, the CPU 41 powers on the digital TV 12 in response to the absence information from the digital TV 13, and the process proceeds from Step S62 to Step S57.

In Step S57, the CPU 41 sets the operating mode of the digital TV 12 to the power saving mode, and hereinafter, the same processes as those of the aforementioned case are performed.

### Reverting Process of Reverting Mode #2

A reverting process of a reverting mode #2 performed by the home network system of FIG. 1 is described.

In the reverting process of the reverting mode #2, as described above, for example, in the case where a user viewing contents broadcasted through a channel takes action of stopping viewing the contents, the recording of the contents is started from the time of stopping the viewing of the contents, and after that, in the case where the state that contents are able to be viewed by the user is established, the recorded contents are reproduced.

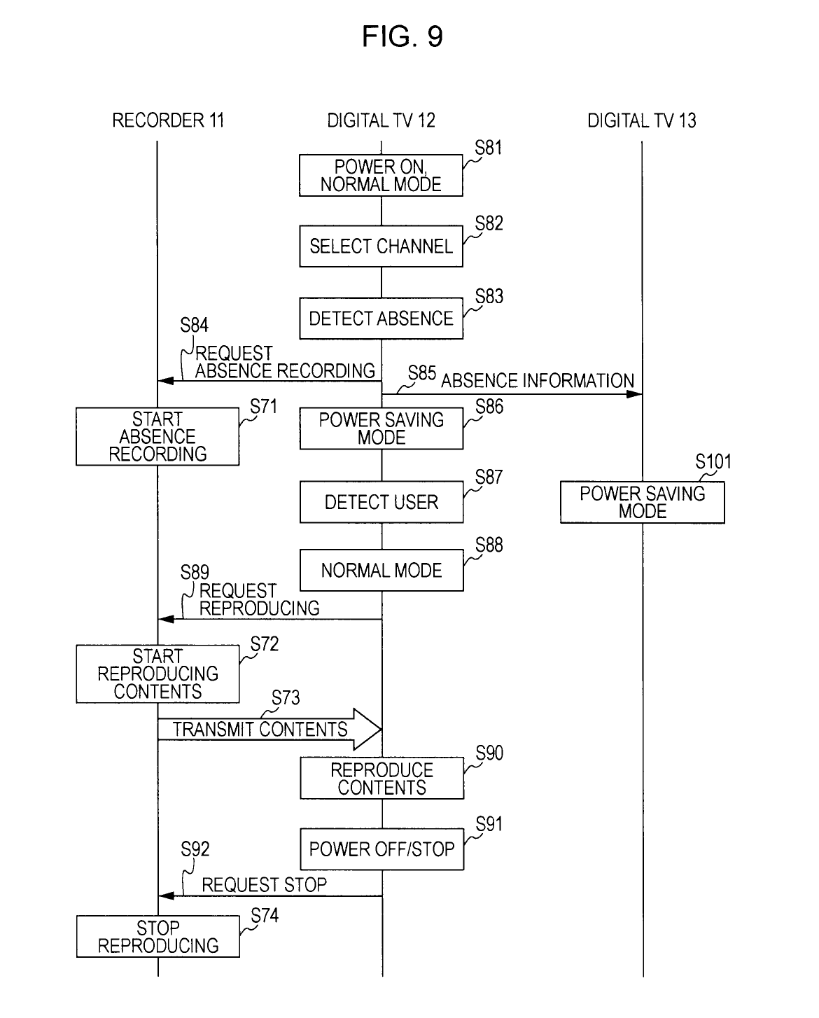

FIG. 9 is a diagram illustrating the reverting process in the reverting mode #2 performed, for example, in the case where a user viewing contents broadcasted through a channel by the digital TV 12 in the room A temporarily leaves the room A due to something to do and comes back to the room A.

For example, if the user manipulates the input/output mechanism 63A of the mobile terminal 21 (FIG. 5) so as to power on the digital TV 12 in the room A, in Steps S81 and S82, the digital TV 12 performs the same processes as those of Steps S11 and S12 of FIG. 6.

In other words, the digital TV 12 (FIG. 3) is allowed to be powered on, and the operating mode is set to the normal mode. Moreover, in the digital TV 12, the contents broadcasted through a predetermined channel are acquired by the receiving portion 45 and displayed on the display portion 48.

In this manner, in the case where the contents are displayed on the display portion 48 of the digital TV 12, when the user viewing the contents displayed on the display portion 48 leaves the room A where the digital TV 12 is installed, for example, due to something to do and disappears from the surrounding area of the digital TV 12, in Step S83, the detection portion 49 detects that the user does not exist in the surrounding area of the digital TV 12 (absence is detected).

In the case where the contents are displayed on the display portion 48 of the digital TV 12, if the absence is detected by the detection portion 49, in Step S84, the CPU 41 of the digital TV 12 performs record control of recording the contents, which are acquired by the receiving portion 45 at the time when the absence is detected and are displayed on the display portion 48, in the recorder 11 (recording medium 37 (FIG. 2) thereof).

In other words, in Step S84, the CPU 41 (FIG. 3) of the digital TV 12 transmits a command of requesting for recording (hereinafter, referred to as absence recording) of the contents, which are acquired by the receiving portion 45 at the time when the absence is detected, from the network I/F 44 to the recorder 11.

The CPU 31 (FIG. 2) of the recorder 11 receives the absence recording request command from the digital TV 12 through the network I/F 34, and in Step S71, starts the recording (absence recording) of the contents, which are acquired by the receiving portion 45 (FIG. 3) at the time when the absence is detected in the digital TV 12, in the recording medium 37 by controlling the receiving portion 35 and the recording reproducing control portion 36 in response to the command.

In other words, the absence recording request command from the digital TV 12 includes information on a channel, which broadcasts the contents which are acquired by the receiving portion 45 (FIG. 3) at the time when the absence is detected in the digital TV 12, and a broadcast ending time. The receiving portion 35 (FIG. 2) of the recorder 11 acquires the contents broadcasted through the channel included in the absence recording request command and supplies the contents to the recording reproducing control portion 36.

The recording reproducing control portion 36 records (absence-records) the contents from the receiving portion 35 in the recording medium 37.

Herein, in the recorder 11, the absence recording is performed up to the broadcast ending time included in the absence recording request command from the digital TV 12.

Therefore, in the absence recording, when the absence is detected, the contents (programs) acquired by the receiving portion 45 of the digital TV 12 which detects the absence are recorded until the broadcast is ended.

In addition, if the recorder 11 starts the recording as the absence recording from the time just after the absence is detected in the digital TV 12, the scenes for several seconds after the user stops viewing the contents displayed in the digital TV 12 (on the display portion 48) in order to leave the room A, where the digital TV 12 is installed, may not be recorded.

Therefore, for example, in the recorder 11, overwrite-type recording, in other words, preliminary recording may be performed so as to maintain a portion of the contents of past several seconds or past tens of seconds in all the channels, and in the case where the absence recording request command is transmitted, as the result of the absence recording, the preliminarily recorded portions may be included in the contents which are to be absence-recorded.

In this case, in the absence recording, the recording of the contents including the scene at the time when the user stops viewing the contents displayed in the digital TV 12 in order to leave the room A, where the digital TV 12 is installed, may be performed.

After transmitting the command of requesting the absence recording, in Step S85, the CPU 41 of the digital TV 12 transmits the absence information from the network I/F 44 to another TV, that is, the digital TV 13 on the network 10.

Moreover, in Step S86, the CPU 41 of the digital TV 12 changes the operating mode of the digital TV 12 from the normal mode to the power saving mode.

In this manner, in the case where the contents are displayed on the display portion 48 of the digital TV 12, if the absence is detected by the detection portion 49, the digital TV 12 allows the recorder 11 to perform the absence recording and transmits the absence information to another TV, that is, the digital TV 13.

Moreover, the digital TV 12 sets the operating mode to the power saving mode.

Therefore, when the user does not view the contents, wasteful power consumption caused by displaying the contents on the display portion 48 may be prevented.

On the other hand, in the digital TV 13, if the absence information is transmitted from the digital TV 12, the network I/F 54 (FIG. 4) receives the absence information from the digital TV 12 and supplies the absence information to the CPU 51.

In Step S101, the CPU 51 of the digital TV 13 powers on the digital TV 13 in response to the absence information from the digital TV 12 and sets the operating mode to the power saving mode.

In addition, similarly to the case of FIG. 6, in the digital TV 13, at the time when the absence information is received from the digital TV 12, in the case where the digital TV 13 is in the power-on state and the operating mode is set to the normal mode, there is a high possibility that another user viewing contents through digital TV 13 in the room B exists. Accordingly, in order to prevent interrupting another user in the room B from viewing contents, the CPU 51 does not perform the processes of Step S101.

In addition, similarly to the case of FIG. 6, in the digital TV 13, at the time when the absence information is received from the digital TV 12, in the case where the digital TV 13 is in the power-on state but the operating mode is set to the power saving mode, the CPU 51 does not perform (may not necessarily perform) the process of Step S101.

After it is detected that the user does not exist in the surrounding area of the digital TV 12 and, thus, the operating modes of the digital TVs 12 and 13 are set to the power saving mode, for example, if the user comes back to the room A where the digital TV 12 is installed, after finishing something to do, in Step S87, the detection portion 49 of the digital TV 12 (FIG. 3) detects that the user exists (person is detected).

In the detection portion 49 of the digital TV 12, if the existence of user is detected, in Step S88, the CPU 41 of the digital TV 12 changes the operating mode of the digital TV 12 from the power saving mode to the normal mode.

Moreover, in Step S89, the CPU 41 transmits a command of requesting for reproducing the contents, of which the absence recording is performed just before, from the network I/F 44 to the recorder 11.

The CPU 31 (FIG. 2) of the recorder 11 receives a command of requesting for reproducing the absence-recorded contents from the digital TV 12 through the network I/F 34 and, in Step S72, restarts the reproducing of the absence-recorded contents recorded in the recording medium 37 by controlling the recording reproducing control portion 36 in response to the command.

Next, in Step S73, in the recorder 11, the contents reproduced from the recording medium 37 are transmitted from the network I/F 34 to the digital TV 12 that transmits the command of requesting for reproducing the contents of which the absence recording is performed.

In Step S90, in the digital TV 12, the contents from the recorder 11 are received by the network I/F 44 (FIG. 3) and reproduced.

In other words, in the digital TV 12, the contents from the recorder 11 are supplied from the network I/F 44 to the decoder 46. The decoder 46 decodes the contents from the network I/F 44, if necessary, and supplies the contents to the display controller 47. The display controller 47 supplies the contents from the decoder 46 to the display portion 48, so that the absence-recorded contents are displayed on the display portion 48.

Accordingly, the digital TV 12 is in the reverted state where the contents presenting (displaying) state reverts to the state at the time when the user leaves the room A.

In other words, in the digital TV 12 in the room A which the user returns to, the contents are displayed from the consecutive scene of the contents that are viewed by the user at the time when the user leaves the room A (the scene just before the scene displayed in the digital TV 12 at the time when the user leaves the room A).

Therefore, the user may restart viewing from the consecutive scene of the contents which the user views just before leaving the room A where the digital TV 12 is installed without particularly manipulating the digital TV 12 which is in the power saving mode. In addition, the user may view the scenes broadcasted from the time when the user leaves the room A to the time when user comes back to the room A without missing any scene.

After that, if the user manipulates the mobile terminal (FIG. 1) so as to stop the reproducing of the contents or so as to power off the digital TV 12, the command corresponding to the manipulation is transmitted from the mobile terminal 21 to the digital TV 12.

In Step S91, the digital TV 12 stops the reproducing of the contents in response to the command from mobile terminal 21, or the digital TV 12 is allowed to be powered off.

Moreover, in the digital TV 12, in Step S92, the command of requesting the stopping of the reproducing of the contents is transmitted to the recorder 11.

In Step S74, the recorder 11 stops the reproducing of the absence-recorded contents in response to the command from digital TV 12.

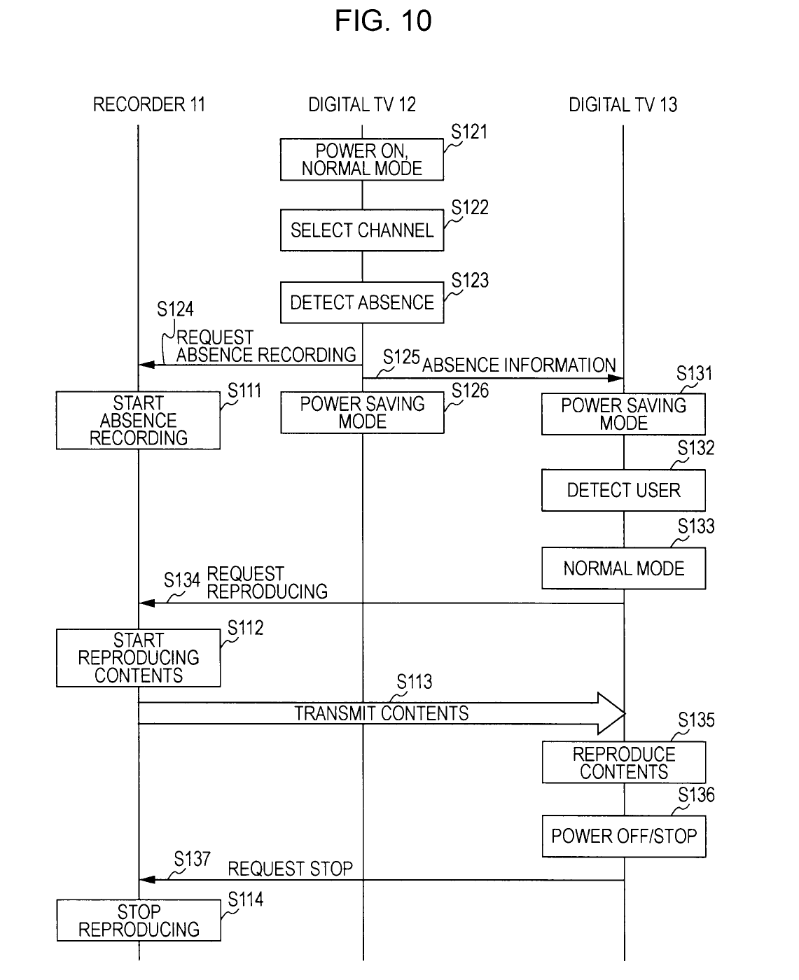

FIG. 10 is a diagram illustrating the reverting process in the reverting mode #2 performed, for example, in the case where a user viewing contents broadcasted through a channel by the digital TV 12 in the room A leaves the room A due to something to do and does not come back to the room A but enters the room B.

For example, if the user manipulates the input/output mechanism 63A of the mobile terminal 21 (FIG. 5) so as to power on the digital TV 12 in the room A, in Steps S121 and S122, the digital TV 12 performs the same processes as those of Steps S11 and S12 of FIG. 6.

In other words, the digital TV 12 (FIG. 3) is allowed to be powered on, and the operating mode is set to the normal mode. Moreover, in the digital TV 12, the contents broadcasted through a predetermined channel are acquired by the receiving portion 45 and are displayed on the display portion 48.

In this manner, in the case where the contents are displayed on the display portion 48 of the digital TV 12, for example, if the user viewing the contents displayed on the display portion 48 leaves the room A, where the digital TV 12 is installed, due to something to do and does not exist in the surrounding area of the digital TV 12, in the digital TV 12, in Steps S123 to S126, the same processes as those of Steps S83 to S86 of FIG. 9 are performed.

In other words, in Step S123, the detection portion 49 performs the absence detection, and in Step S124, the CPU 41 transmits an absence recording request command from the network I/F 44 to the recorder 11 as a recording control for the recorder 11.

Moreover, in Step S125, the absence information is transmitted from the digital TV 12 to the digital TV 13, and in Step S126, the operating mode of the digital TV 12 is changed from the normal mode to the power saving mode.

Herein, in this manner, in the case where the contents are displayed on the display portion 48 of the digital TV 12, if the absence is detected by the detection portion 49, the digital TV 12 sets the operating mode to the power saving mode. Therefore, when the user does not view the contents, wasteful power consumption caused by displaying the contents on the display portion 48 may be prevented.

On the other hand, if the absence recording request command is transmitted, the CPU 31 (FIG. 2) of the recorder 11 receives the command from the digital TV 12 as a recording control and, in Step S111, similarly to Step S71 of FIG. 9, starts the recording (absence recording) of the contents, which are acquired by the receiving portion 45 (FIG. 3) at the time when the absence is detected in the digital TV 12, in the recording medium 37.

In addition, if the absence information is transmitted from the digital TV 12, the digital TV 13 receives the absence information. Next, similarly to Step S101 of FIG. 9, in Step S131, the digital TV 13 is allowed to be powered on in response to the absence information from the digital TV 12 and to set the operating mode to the power saving mode.

After it is detected that the user does not exist in the surrounding area of the digital TV 12 and, thus, the operating modes of the digital TVs 12 and 13 are set to the power saving mode, for example, if the user who finishes something to do does not come back to the room A where the digital TV 12 is installed but enters the room B where the digital TV 13 is installed, in Step S132, the detection portion 59 of the digital TV 13 (FIG. 4) detects that the user exists (person is detected).

In the detection portion 59 of the digital TV 13, if the existence of user is detected, in Step S133, the CPU 51 of the digital TV 13 (FIG. 4) changes the operating mode of the digital TV 13 from the power saving mode to the normal mode.

Moreover, in Step S134, the CPU 51 transmits a command of requesting for reproducing the contents, of which the absence recording is performed just before, from the network I/F 54 to the recorder 11.

The CPU 31 (FIG. 2) of the recorder 11 receives a command of requesting for reproducing the absence-recorded contents from the digital TV 13 through the network I/F 34 and, in Step S112, restarts the reproducing of the absence-recorded contents recorded in the recording medium 37 by controlling the recording reproducing control portion 36 in response to the command.

Next, in the recorder 11, in Step S113, the contents reproduced from the recording medium 37 are transmitted from the network I/F 34 to the digital TV 13 that transmits the command of requesting the reproducing the absence-recorded contents.

In the digital TV 13, in Step S135, the contents from the recorder 11 are received by the network I/F 54 (FIG. 4) and reproduced.

In other words, in the digital TV 13, the contents from the recorder 11 are supplied from the network I/F 54 to the decoder 56. The decoder 56 decodes the contents from the network I/F 54, if necessary, and supplies the contents to the display controller 57. The display controller 57 supplies the contents from the decoder 56 to the display portion 58, so that the absence-recorded contents are displayed on the display portion 58.

Accordingly, the digital TV 13 in the room B is in the reverted state where the contents presenting (displaying) state reverts to the state at the time when the user leaves the room A.

In other words, in the digital TV 13 in the room B which the user enters, the contents are displayed from the consecutive scene of the contents which the user viewed at the time when the user leaves the room A.

In this manner, in the digital TV 13 (FIG. 4), in the case where the network I/F 54 receives the absence information from the digital TV 12 and, after that, the existence of user is detected by the detection portion 59, the (absence-recorded) contents, which are recorded in the recording medium 37 of the recorder 11 according to the record controlling of the digital TV 12 which detects the absence, are reproduced and displayed on the display portion 58 of the digital TV 13 in the room B which the user enters.

Therefore, in the room B, the user may restart viewing from the consecutive scene of the contents which the user views just before leaving the room A where the digital TV 12 is installed without returning to the room A where the user views the contents and without particularly manipulating the digital TV 13 in the room B. In addition, the user may view the scenes broadcasted from the time when the user leaves the room A to the time when the user enters the room B without missing any scene.

In this manner, since the digital TV 13 in the room B is in the reverted state where contents presenting state reverts to the state at the time when the user leaves the room A, it is possible to improve the convenience of the digital TVs 12 and 13 according to the absence detection in comparison with the case where the operating mode is only set to the power saving mode.

After that, if the user manipulates the mobile terminal 21 (FIG. 1) so as to stop the reproducing of the contents or so as to power off the digital TV 13, the command corresponding to the manipulation is transmitted from the mobile terminal 21 to the digital TV 13.

In Step S136, the digital TV 13 stops the reproducing (decoding or the like) of the contents in response to the command from the mobile terminal 21, or the digital TV 13 is allowed to be powered off.

Moreover, in Step S137, the digital TV 13 transmits the command of requesting the stopping of the reproducing of the contents to the recorder 11.

In Step S114, the recorder 11 stops the reproducing of the absence-recorded contents in response to the command from the digital TV 13.

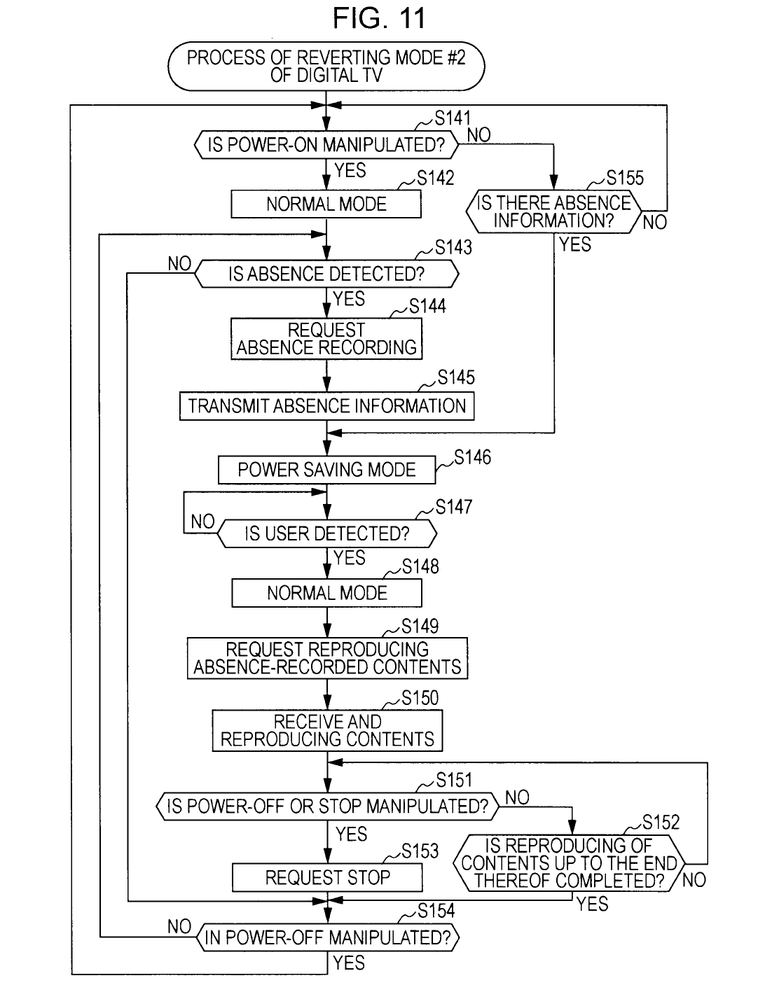

FIG. 11 is a flowchart illustrating a process performed by the digital TV 12 in a reverting process of a reverting mode #2.

In addition, the digital TV 13 also performs the same processes as those of the digital TV 12.

In the digital TV 12, the same processes as those of Steps S51 to S53 of FIG. 8 are performed in Steps S141 to S143.

In other words, in Step S141, the CPU 41 of the digital TV 12 (FIG. 3) determines whether or not the mobile terminal 21 (FIG. 1) is manipulated so as to power on the digital TV 12.

In Step S141, in the case where it is determined that the mobile terminal 21 is manipulated so as to power on the digital TV 12, the CPU 41 of the digital TV 12 powers on the digital TV 12, and the process proceeds to Step S142.

In Step S142, the CPU 41 sets the operating mode of the digital TV 12 to the normal mode, so that the contents broadcasted through a predetermined channel are displayed on the display portion 48 (FIG. 3), and the process proceeds to Step S143.

In Step S143, the CPU 41 determines whether or not it is detected that the user does not exist in the surrounding area of the digital TV 12.

In Step S143, in the case where it is determined not to be detected that the user does not exist in the surrounding area of the digital TV 12, that is, in the case where the absence is not detected by the detection portion 49 (FIG. 3), the process skips Steps S144 to S153 and proceeds to Step S154.

In addition, in Step 143, in the case where it is determined to be detected that the user does not exist in the surrounding area of the digital TV 12, that is, in the case where the absence is detected by the detection portion 49 (FIG. 3), the process proceeds to Step S144. The CPU 41 (FIG. 3) transmits a command (hereinafter, referred to as an absence recording request command) of requesting the absence recording for recording the contents, which are acquired by the receiving portion 45 and displayed on the display portion 48 at the time of the absence detection, in the recorder 11 (the recording medium 37 (FIG. 2) thereof) from the network I/F 44 to the recorder 11.

After that, the process proceeds from Step S144 to Step S145. The CPU 41 transmits the absence information from the network I/F 44 to another TV, that is, the digital TV 13 on the network 10, and the process proceeds to Step S146.

Herein, in Step S145, the absence information transmitted to another TV, that is, the digital TV 13 on the network 10 may include specifying information (for example, a title, a broadcast channel, a broadcast time zone, and the like) for specifying the contents of which the absence recording is requested in Step S144. In this case, in the later-described Step S149, the digital TV 13 receiving the absence information specifies the absence-recorded contents according to the specifying information included in the absence information and requests the recorder 11 to reproduce the contents.

In Step S146, the CPU 41 changes the operating mode of the digital TV 12 from the normal mode to the power saving mode, and the process proceeds to Step S147.

By changing the operating mode of the digital TV 12 to the power saving mode, the digital TV 12 stops displaying the contents on the display portion 48 to be in the state that the digital TV 12 is operated with a necessary minimum power.

In this manner, after the operating mode of the digital TV 12 is set to the power saving mode, in Step S147, the CPU 41 determines whether or not the existence of user in the surrounding area is detected.

In Step S147, in the case where it is determined that the existence of user in the surrounding area is not detected, the process returns to Step S147.

Herein, in this manner, in Step S146, in the case where the operating mode of the digital TV 12 is set to the power saving mode, the digital TV 12 operates a timer to count time elapsing after entering into the power saving mode. Next, after entering into the power saving mode, in Step S147, in the case where the user is not determined to be detected and a predetermined time, for example, one hour elapses, the digital TV 12 is allowed to be powered off. The process returns to Step S141.

On the other hand, in Step S147, in the case where it is determined that the existence of user in the surrounding area is detected, that is, in the case where the existence of user in the surrounding area is detected by the detection portion 49, the process proceeds to Step S148. The CPU 41 changes the operating mode of the digital TV 12 from the power saving mode to the normal mode, and the process proceeds to Step S149.

In Step S149, the CPU 41 transmits a command (hereinafter, referred to as an absence-recorded contents reproducing request command) of requesting for reproducing the contents, of which the absence recording is performed just before, from the network I/F 44 to the recorder 11.

Next, the digital TV 12 waits for transmission of the absence-recoded contents according to the recording control of the digital TV 12 or 13 from the recorder 11 which receives the absence-recorded contents reproducing request command, and the process proceeds from Step S149 to Step S150. The digital TV 12 receives the contents from the recorder 11 through the network I/F 44 (FIG. 3) and reproduces the contents.

In other words, in the digital TV 12, the contents from the recorder 11 are supplied from the network I/F 44 to the decoder 46. The decoder 46 decodes the contents from the network I/F 44, if necessary, and supplies the contents to the display controller 47. The display controller 47 supplies the contents from the decoder 46 to the display portion 48, so that the absence-recorded contents are displayed on the display portion 48.

In this manner, in the digital TV 12, if the displaying of the absence-recorded contents is started, the process proceeds from Step S150 to Step S151. The CPU 41 (FIG. 3) determines whether or not the mobile terminal 21 (FIG. 1) is manipulated so as to stop reproducing the contents or so as to power off the digital TV 12.

In other words, in Step S151, it is determined whether or not a command (hereinafter, referred to as a stop-reproducing request command) of requesting for stopping the reproducing of the contents in the digital TV 12 or a command (hereinafter, referred to as a power-off request command) of requesting for powering off the digital TV 12 is transmitted from the mobile terminal 21.

In Step S151, in the case where it is determined that both of the stop-reproducing request command and the power-off request command are not transmitted, the process proceeds to Step S152. The CPU 41 (FIG. 3) determines whether or not the reproducing of the absence-recorded contents started in Step S150 is performed up to the end thereof.

In Step S152, in the case where it is determined that the absence-recorded contents are not yet reproduced up to the end thereof, the process returns to Step S151.

In addition, in Step S152, in the case where it is determined that the absence-recorded contents are reproduced up to the end thereof, the process proceeds to Step S154.

On the other hand, in Step S151, in the case where it is determined that any one of the stop-reproducing request command and the power-off request command is transmitted from the mobile terminal 21 to the digital TV 12, the process proceeds to Step S153. The CPU 41 (FIG. 3) transmits the stop-reproducing request command from the network I/F 44 to the recorder 11, and the process proceeds to Step S154.

Herein, if the stop-reproducing request command is transmitted, the recorder 11 stops reproducing contents (in this case, absence-recorded contents) in response to the stop-reproducing request command.

In addition, in Step S150, after the starting of the reproducing of the absence-recorded contents from the recorder 11; in Step S152, until the absence-recorded contents are determined to be reproduced up to the end thereof; and in Step S153, after the stop-reproducing request command it transmitted to the recorder 11 until the reproducing of the absence-recorded contents in the recorder 11 is stopped, in the home network system of FIG. 1, the reverting process of the reverting mode #3 may be performed. The reverting process of the reverting mode #3 is described later in detail.

In Step S154, the CPU 41 (FIG. 3) determines whether or not the user manipulates the mobile terminal 21 (FIG. 1) so as to power off the digital TV 12.

In Step S154, in the case where it is determined that the user manipulates the mobile terminal 21 so as to power off the digital TV 12, that is, in the case where the command determined to be transmitted from the mobile terminal 21 in Step S151 is a power-off request command, the CPU 41 powers off the digital TV 12, and the process returns to Step S141.

In addition, in Step S154, in the case where it is determined that the user does not manipulate the mobile terminal 21 so as to power off the digital TV 12, that is, in the case where the command determined to be transmitted from the mobile terminal 21 in Step S151 is a stop-reproducing request command or in the case where the absence-recorded contents are reproduced up to the end thereof, the CPU 41 controls the receiving portion 45 (FIG. 3), for example, so as to select the channel through which the absence-recorded contents are broadcasted, and the process returns to Step S143.

In this case, the receiving portion 45 acquires the contents broadcasted through the channel that is selected at the time of absence detection by extracting the television broadcasting signal of the channel according to the control of the CPU 41 from the television broadcasting signal supplied thereto and supplies the contents through the decoder 46 and the display controller 47 to the display portion 48 to display thereon.

Therefore, in the digital TV 12, in the case where the reproducing of the absence-recorded contents is stopped in the middle of the reproducing or in the case where the reproducing is completed up to the end of the contents, after that, the broadcasted contents are displayed through the channel (actually) through which the contents are broadcasted.

On the other hand, in Step S141, in the case where it is determined that the mobile terminal 21 (FIG. 1) is not manipulated so as to power on the digital TV 12, the process proceeds to Step S155. The CPU 41 (FIG. 3) determines whether or not the network I/F 44 receives absence information from another TV, that is, the digital TV 13.

In Step S155, in the case where it is determined that the network I/F 44 does not receive the absence information from the digital TV 13, that is, in the case where the absence information is not transmitted from the digital TV 13, the process returns to Step S141.

In addition, in Step S155, in the case where it is determined that the network I/F 44 receives the absence information from the digital TV 13, that is, in the case where the absence information is transmitted from the digital TV 13, the CPU 41 powers on the digital TV 12 in response to the absence information from the digital TV 13, and the process proceeds to Step S146.

In Step S146, the CPU 41 sets the operating mode of the digital TV 12 to the power saving mode, and hereinafter, the same processes as those of the aforementioned case are performed.

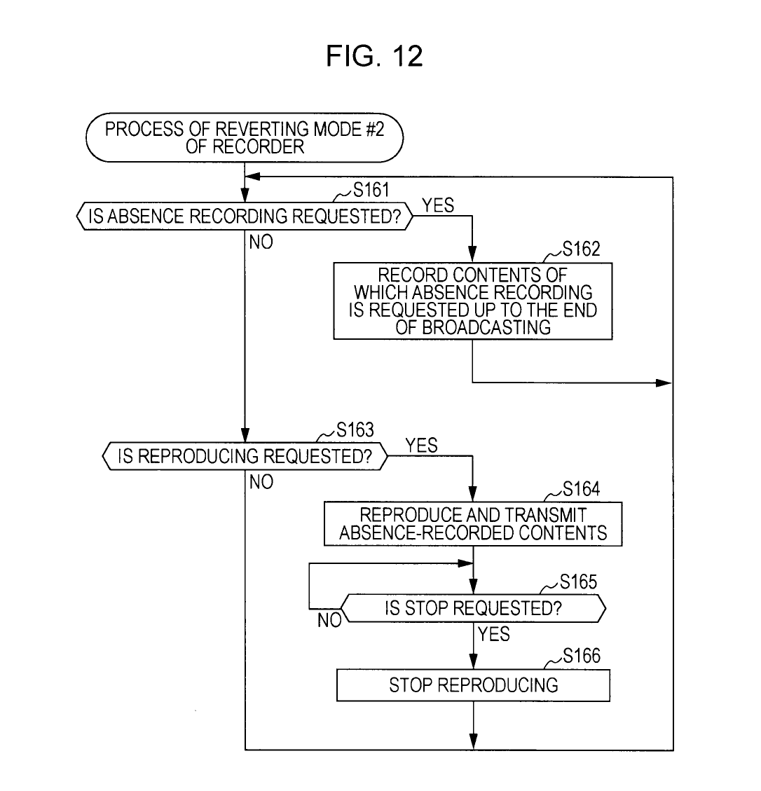

FIG. 12 is a flowchart illustrating a process performed by the recorder 11 in a reverting process of a reverting mode #2.

In Step S161, in the recorder 11, the CPU 31 (FIG. 2) determines whether or not an absence recording request command of requesting absence recording is transmitted from the digital TV 12 or 13.

In Step S161, in the case where it is determined that the absence recording request command is transmitted, that is, in the case where the network I/F 34 (FIG. 2) of the recorder 11 receives the absence recording request command from the digital TV 12 or 13, the process proceeds to Step S162. The CPU 31 starts the recording (absence recording) of the contents broadcasted through a channel included in the absence recording request command in the recording medium 37 by controlling the receiving portion 35 and the recording reproducing control portion 36 of the recorder 11 (FIG. 2), and the process returns to Step S161.

Herein, the recording of the contents broadcasted through the channel included in the absence recording request command in the recording medium 37, which is started in Step S162, is performed up to the end of the contents (up to the broadcast ending time).

On the other hand, in Step S161, in the case where it is determined that the absence recording request command is not transmitted, the process proceeds to Step S163. The CPU (FIG. 2) of the recorder 11 determines whether or not an absence-recorded contents reproducing request command of requesting reproducing the absence-recorded contents is transmitted from the digital TV 12 or 13.

In Step S163, in the case where it is determined that the absence-recorded contents reproducing request command is transmitted, that is, in the case where the network I/F 34 (FIG. 2) of the recorder 11 receives the absence-recorded contents reproducing request command from the digital TV 12 or 13, the process proceeds to Step S164. The CPU 31 (FIG. 2) reproduces the contents (absence-recorded contents) recorded in the recording medium 37 in response to the absence recording request command by controlling the recording reproducing control portion 36 of the recorder 11 (FIG. 2) and transmits the contents from the network I/F 34 to any one of the digital TVs 12 and 13, which transmits the absence-recorded contents reproducing request command (the TV where the user is detected to exist in the surrounding area thereof) (the task is started).

Herein, in the recorder 11, in the case where the contents recorded in the recording medium 37 are reproduced in response to the absence recording request command, the absence recording of the contents may yet be performed. In this case, the recording of the contents in the recording medium 37 and the reproducing (reading) of the contents from the recording medium 37 may be performed in parallel.

For this reason, the recorder 11 is configured to have a function of performing the recording of the contents in the recording medium 37 and the reproducing of the contents from the recording medium 37 in parallel (apparently).

In Step S164, after the reproducing of the absence-recorded contents from the recording medium 37 and the transmitting thereof are started, the process proceeds to Step S165. The CPU 31 (FIG. 2) of the recorder 11 determines whether or not a stop-reproducing request command is transmitted from the TV that transmits the absence-recorded contents reproducing request command among the digital TVs 12 and 13.

In Step S165, in the case where it is determined that the stop-reproducing request command is not transmitted, the process returns to Step S165. The recorder 11 continuously performs the reproducing the absence-recorded contents and the transmitting thereof that are started in Step S164.

In addition, in Step S165, in the case where it is determined that the stop-reproducing request command is transmitted, that is, in the case where the network I/F 34 (FIG. 2) of the recorder 11 receives the stop-reproducing request command, the process proceeds to Step S166. The CPU 31 (FIG. 2) allows the recording reproducing control portion 36 to stop reproducing of the absence-recorded contents from the recording medium 37, and the process returns to Step S161.

In addition, in the case where the reproducing of the absence-recorded contents is performed up to the end thereof, the recorder 11 stops the reproducing.

### Reverting Process of Reverting Mode #3

A reverting process of a reverting mode #3 performed by the home network system of FIG. 1 is described.

In the reverting process of the reverting mode #3, as described above, in the case where the user viewing the recorded contents takes action of stopping the viewing of the contents, the reproducing of the recorded contents is stopped, and after that, in the case where the state where the user may be able to view the contents is established, the reproducing of the contents, of which the reproducing is stopped, is restarted.

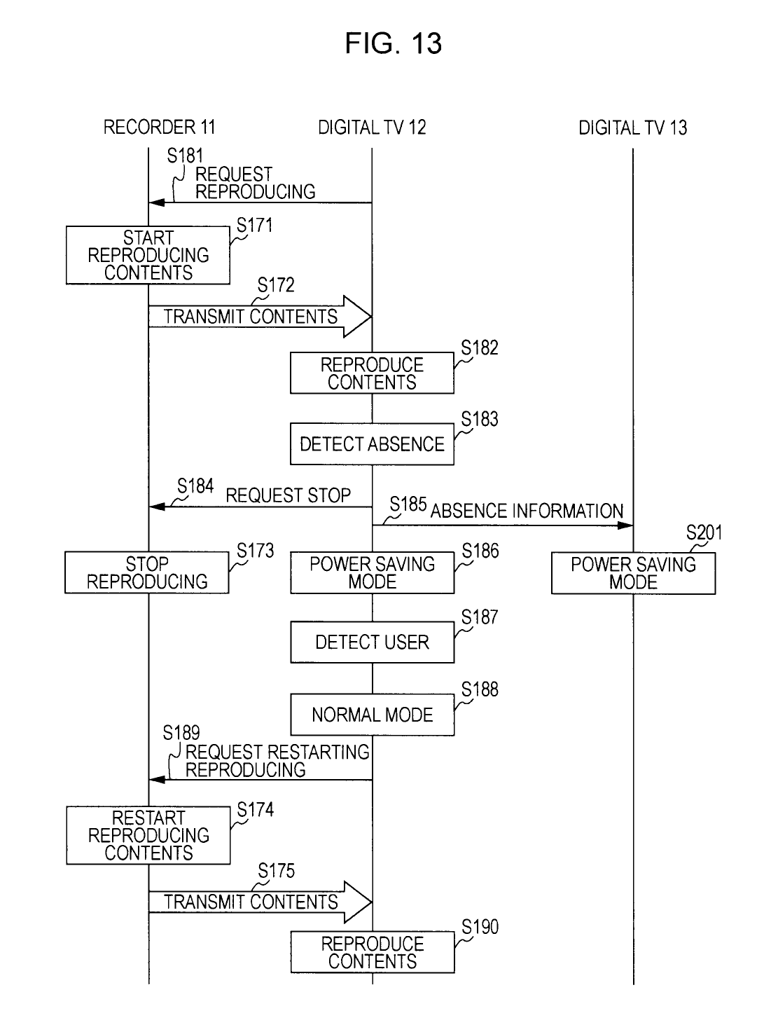

FIG. 13 is a diagram illustrating the reverting process in the reverting mode #3 performed, for example, in the case where a user viewing contents (hereinafter, referred to as recorded contents) recorded in the recorder 11 (in the recording medium 37 (FIG. 2) thereof) by the digital TV 12 in the room A temporarily leaves the room A due to something to do and comes back to the room A.

For example, if the user manipulates the input/output mechanism 63A of the mobile terminal 21 (FIG. 5) so as to power on the digital TV 12 in the room A, the digital TV 12 (FIG. 3) is allowed to be powered on and sets the operating mode to the normal mode.

In addition, after that, for example, if the user manipulates the input/output mechanism 63A of the mobile terminal 21 (FIG. 5) so as to reproduce predetermined recorded contents, the network I/F 64 of the mobile terminal 21 transmits a command corresponding to the manipulation.

The command from the mobile terminal 21 is received by the network I/F 44 of the digital TV 12 (FIG. 3) and supplied to the CPU 41.

In Step S181, the CPU 41 transmits a command of requesting for reproducing of a predetermined recorded contents (hereinafter, referred to as a recorded contents reproducing request command) from the network I/F 44 to the recorder 11 according to the command from the mobile terminal 21.

The CPU 31 (FIG. 2) of the recorder 11 receives the recorded contents reproducing request command from the digital TV 12 through the network I/F 34 and, in Step S171, starts the reproducing of the recorded contents recorded in the recording medium 37 by controlling the recording reproducing control portion 36 in response to the recorded contents reproducing request command.

Next, in Step S172, in the recorder 11, the recorded contents reproduced from the recording medium 37 are transmitted from the network I/F 34 to the digital TV 12 that transmits the command of requesting for reproducing the recorded contents.

Herein, the recorded contents reproducing request command includes specifying information specifying the recorded contents which are to be reproduced. In the recorder 11, the recorded contents which are to be reproduced are specified according to the specifying information and reproduced.

In the digital TV 12, in Step S182, the recorded contents from the recorder 11 are received by the network I/F 44 (FIG. 3) and reproduced.

In other words, in the digital TV 12, the recorded contents from the recorder 11 are supplied from the network I/F 44 to the decoder 46. The decoder 46 decodes the recorded contents from the network I/F 44, if necessary, and supplies the recorded contents to the display controller 47. The display controller 47 supplies the recorded contents from the decoder 46 to the display portion 48, so that the recorded contents are displayed on the display portion 48.

In this manner, in the case where the recorded contents are displayed on the display portion 48 of the digital TV 12, when the user viewing the recorded contents displayed on the display portion 48 leaves the room A where the digital TV 12 is installed, for example, due to something to do and disappears from the surrounding area of the digital TV 12, in Step S183, the detection portion 49 (FIG. 3) detects that the user does not exist in the surrounding area of the digital TV 12 (absence is detected).

In the case where the contents are displayed on the display portion 48 of the digital TV 12, if the absence is detected by the detection portion 49, in Step S184, the CPU 41 of the digital TV 12 transmits the stop-reproducing request command of requesting for stopping the reproducing of the recorded contents from the network I/F 44 to the recorder 11.

The CPU 31 (FIG. 2) of the recorder 11 receives the stop-reproducing request command from the digital TV 12 through the network I/F 34 and, in Step S173, stops reproducing the recorded contents recorded in the recording medium 37 by controlling the recording reproducing control portion 36 in response to the stop-reproducing request command.

In addition, after transmitting the stop-reproducing request command, in Step S185, the CPU 41 of the digital TV 12 transmits the absence information from the network I/F 44 to another TV, that is, the digital TV 13 on the network 10.

Moreover, in Step S186, the CPU 41 of the digital TV 12 changes the operating mode of the digital TV 12 from the normal mode to the power saving mode.

In this manner, in the case where the recorded contents are displayed on the display portion 48 of the digital TV 12, if the absence is detected by the detection portion 49, the digital TV 12 stops (temporarily stops) reproducing the recorded contents in the recorder 11 and transmits the absence information to another TV, that is, the digital TV 13.

Moreover, the digital TV 12 sets the operating mode to the power saving mode.

Therefore, when the user does not view the contents, wasteful power consumption caused by displaying the recorded contents on the display portion 48 may be prevented.

In the digital TV 13, if the absence information is transmitted from the digital TV 12, the network I/F 54 (FIG. 4) receives the absence information from the digital TV 12 and supplies the absence information to the CPU 51.

In Step S201, the CPU 51 of the digital TV 13 powers on the digital TV 13 in response to the absence information from the digital TV 12 and sets the operating mode to the power saving mode.

In addition, similarly to the case of FIG. 6, in the digital TV 13, at the time when the absence information is received from the digital TV 12, in the case where the digital TV 13 is in the power-on state and the operating mode is set to the normal mode, there is a high possibility that another user viewing contents through digital TV 13 in the room B exists. Accordingly, in order to prevent interrupting another user in the room B from viewing contents, the CPU 51 does not perform the processes of Step S201.

Moreover, similarly to the case of FIG. 6, in the digital TV 13, at the time when the absence information is received from the digital TV 12, in the case where the digital TV 13 is in the power-on state but the operating mode is set to the power saving mode, the CPU 51 does not perform (may not necessarily perform) the process of Step S201.

After it is detected that the user does not exist in the surrounding area of the digital TV 12 and, thus, the operating modes of the digital TVs 12 and 13 are set to the power saving mode, for example, if the user comes back to the room A where the digital TV 12 is installed, after finishing something to do, in Step S187, the detection portion 49 of the digital TV 12 (FIG. 3) detects that the user exists (person is detected).

If the existence of user is detected by the detection portion 49 of the digital TV 12, in Step S188, the CPU 41 of the digital TV 12 changes the operating mode of the digital TV 12 from the power saving mode to the normal mode.

Moreover, in Step S189, the CPU 41 transmits a command (hereinafter, referred to as a restarting-reproducing request command) of requesting for the restarting the reproducing of the recorded contents, of which the reproducing is stopped just before from the network I/F 44 to the recorder 11.

The CPU 31 (FIG. 2) of the recorder 11 receives the restarting-reproducing request command from the digital TV 12 through the network I/F 34 and, in Step S174, restarts the reproducing of the recorded contents, of which the reproducing is stopped just before, from the recording medium 37 by controlling the recording reproducing control portion 36 in response to the restarting-reproducing request command.

In other words, in the recorder 11, the reproducing of the recorded contents is started from the scene of which the reproducing is stopped.

Next, in the recorder 11, in Step S175, the recorded contents of which the reproducing from the recording medium 37 is resumed are transmitted from the network I/F 34 to the digital TV 12 that transmits the restarting-reproducing request command.

In the digital TV 12, in Step S190, the recorded contents from the recorder 11 is received by the network I/F (FIG. 3) and reproduced.

In other words, in the digital TV 12, the recorded contents from the recorder 11 are supplied from the network I/F 44 to the decoder 46. The decoder 46 decodes the recorded contents from the network I/F 44, if necessary, and supplies the recorded contents to the display controller 47. The display controller 47 supplies the recorded contents from the decoder 46 to the display portion 48. Therefore, on the display portion 48, the recorded contents are displayed from the scene at the time when the absence is detected.

In this manner, the digital TV 12 becomes the reverted state that the contents presenting (displaying) state reverts to the state at the time when the user leaves the room A.

In other words, in the digital TV 12 in the room A which the user returns to, the recorded contents are displayed from the consecutive scene of the recorded contents that are viewed by the user at the time when the user leaves the room A (the scene displayed in the digital TV 12 at the time when the user leaves the room A).

Therefore, the user may restart the viewing from the consecutive scene of the recorded contents which the user views just before leaving the room A where the digital TV 12 is installed, without particularly manipulating the digital TV 12 which is in the power saving mode.

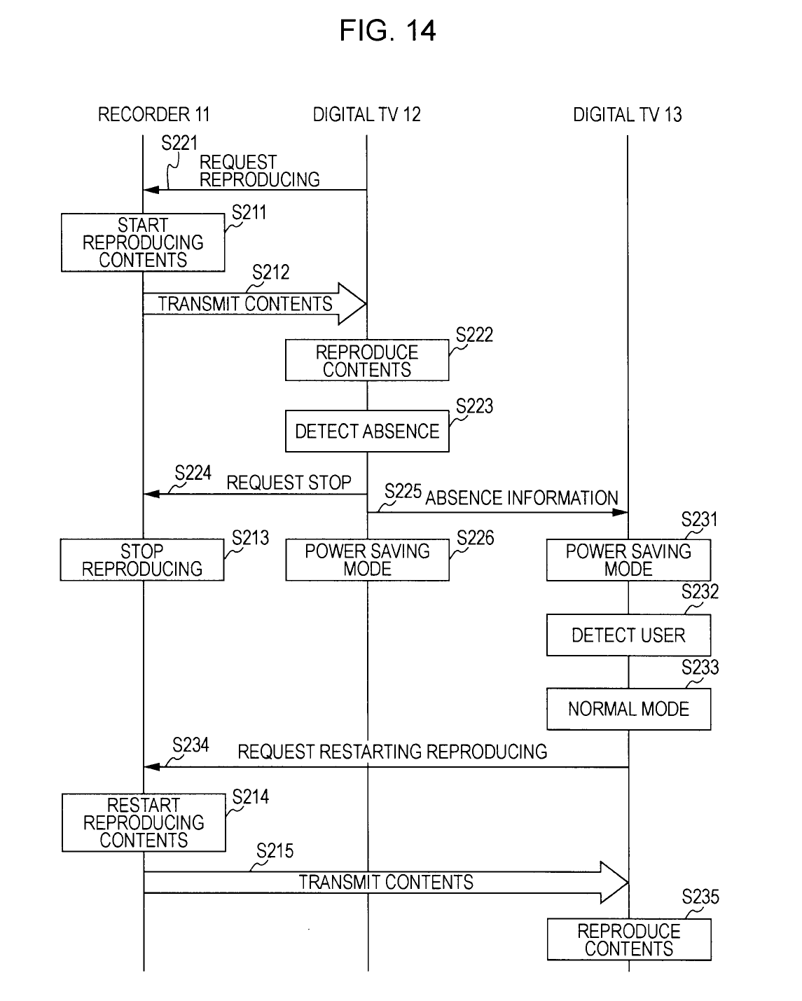

FIG. 14 is a diagram illustrating a reverting process in a reverting mode #3 performed, for example, in the case where a user viewing recorded contents recorded in the recorder 11 by the digital TV 12 in the room A leaves the room A due to something to do and does not come back to the room A but enter the room B.

For example, if the user manipulates the input/output mechanism 63A of the mobile terminal 21 (FIG. 5) so as to power on the digital TV 12 in the room A and if the user manipulates the input/output mechanism 63A of the mobile terminal 21 (FIG. 5) so as to reproduce predetermined recorded contents, similarly the case of FIG. 13, the digital TV 12 is allowed to power on and to set the operating mode to the normal mode.

Moreover, in Step S221, the CPU 41 (FIG. 3) of the digital TV 12 transmits the recorded contents reproducing request command from the network I/F 44 to the recorder 11.

The CPU 31 (FIG. 2) of the recorder 11 receives the recorded contents reproducing request command from the digital TV 12 through the network I/F 34 and performs the same processes as those of the case of FIG. 13 in response to the recorded contents reproducing request command.

In other words, in Step S211, the CPU 31 starts reproducing the recorded contents recorded in the recording medium 37 by controlling the recording reproducing control portion 36.

Moreover, in Step S212, the CPU 31 transmits the recorded contents, which are reproduced from the recording medium 37, from the network I/F 34 to the digital TV 12 which transmits the recorded contents reproducing request command.

In Step S222, in the digital TV 12, the recorded contents from the recorder 11 are received by the network I/F 44 (FIG. 3), reproduced, and displayed on the display portion 48.

In this manner, in the case where the recorded contents are displayed on the display portion 48 of the digital TV 12, when the user viewing the recorded contents displayed on the display portion 48 leaves the room A where the digital TV 12 is installed, for example, due to something to do and disappears from the surrounding area of the digital TV 12, in Step S223, the detection portion 49 (FIG. 3) detects that the user does not exist in the surrounding area of the digital TV 12 (absence is detected).

In the case where the contents are displayed on the display portion 48 of the digital TV 12, if the absence is detected by the detection portion 49, in the digital TV 12, the same processes as those of Steps S184 to S186 of FIG. 13 are performed in Steps S224 to S226.

In other words, in Step S224, the CPU 41 of the digital TV 12 performs a stopping control of transmitting a stop-reproducing request command of requesting for stopping the reproducing of the recorded contents from the network I/F 44 to the recorder 11.

The CPU 31 (FIG. 2) of the recorder 11 receives the stop-reproducing request command from the digital TV 12 through the network I/F 34 and, in Step S213, stops reproducing the recorded contents recorded in the recording medium 37 by controlling the recording reproducing control portion 36 in response to the stop-reproducing request command.

In addition, in Step S225, the CPU 41 of the digital TV 12 transmits the absence information from the network I/F 44 to another TV, that is, the digital TV 13 on the network 10.

Moreover, in Step S226, the CPU 41 changes the operating mode of the digital TV 12 from the normal mode to the power saving mode.

In this manner, in the case where the recorded contents are displayed on the display portion 48 of the digital TV 12, if the absence is detected by the detection portion 49, the digital TV 12 performs stopping controlling for stopping (temporarily stopping) the reproducing of the recorded contents obtained by the recorder 11 and transmits the absence information to another TV, that is, the digital TV 13.

Moreover, the digital TV 12 sets the operating mode to the power saving mode.

Therefore, when the user does not view the contents, wasteful power consumption caused by displaying the recorded contents on the display portion 48 may be prevented.

In the digital TV 13, if the absence information is transmitted from the digital TV 12, the network I/F 54 (FIG. 4) receives the absence information from the digital TV 12 and supplies the absence information to the CPU 51.

In Step S231, similarly to Step S201 of FIG. 13, the CPU 51 of the digital TV 13 powers on the digital TV 13 in response to the absence information from the digital TV 12 and sets the operating mode to the power saving mode.

After it is detected that the user does not exist in the surrounding area of the digital TV 12 and, thus, the operating modes of the digital TVs 12 and 13 are set to the power saving mode, for example, if the user who finishes something to do does not come back to the room A where the digital TV 12 is installed but enters the room B where the digital TV 13 is installed, in Step S232, the detection portion 59 of the digital TV 13 (FIG. 4) detects that the user exists (person is detected).

If the existence of user is detected by the detection portion 59 of the digital TV 13, in Step S233, the CPU 51 of the digital TV 13 (FIG. 4) changes the operating mode of the digital TV 13 from the power saving mode to the normal mode.

Moreover, in Step S234, the CPU 51 transmits a restarting-reproducing request command of requesting for restarting the reproducing of the recorded contents, of which the reproducing is stopped just before from the network I/F 54 to the recorder 11.

The CPU 31 (FIG. 2) of the recorder 11 receives the restarting-reproducing request command from the digital TV 13 through the network I/F 34 and, in Step S214, restarts the reproducing of the recorded contents, of which the reproducing is stopped just before, from the recording medium 37 by controlling the recording reproducing control portion 36 in response to the restarting-reproducing request command.

In other words, in the recorder 11, the reproducing of the recorded contents is started from the scene, of which the reproducing is stopped.

Next, in Step S215, in the recorder 11, the recorded contents, of which the reproducing is restarted from the recording medium 37, are transmitted from the network I/F 34 to the digital TV 13 which transmits the restarting-reproducing request command.

In Step S235, in the digital TV 13, the recorded contents from the recorder 11 are received by the network I/F 54 (FIG. 4) and reproduced.

In other words, in the digital TV 13, the recorded contents of which the reproducing is stopped due to the transmission of the stop-reproducing request command as a stopping control of the digital TV 12 are displayed on the display portion 58 (FIG. 4) from the scene at the time when the absence is detected.

Accordingly, the digital TV 13 in the room B is in the reverted state where the contents presenting (displaying) state reverts to the contents presenting state of the digital TV 12 at the time when the user leaves the room A.

In other words, in the digital TV 13 in the room B which the user enters, the recorded contents are displayed from the consecutive scene (the scene displayed in the digital TV 12 at the time when the user leaves the room A) of the recorded contents which the user views at the time when the user leaves the room A.

In this manner, in the digital TV 13 (FIG. 4), in the case where network I/F 54 receives the absence information from the digital TV 12 and, after that, the existence of user is detected by the detection portion 59, the reproducing of the recorded contents, of which the reproducing is instructed to be stopped according to the stopping controlling of the digital TV 12 which detects the absence, are restarted, and the recorded contents are displayed on the display portion 58.

Therefore, in the room B, the user may restart viewing from the consecutive scene of the recorded contents which the user views just before leaving the room A where the digital TV 12 is installed without returning to the room A where the user views the recorded contents and without particularly manipulating the digital TV 13 in the room B.

In this manner, since the digital TV 13 in the room B is in the reverted state where contents presenting state reverts to the state at the time when the user leaves the room A, it is possible to improve the convenience of the digital TVs 12 and 13 according to the absence detection in comparison with the case where the operating mode is only set to the power saving mode.

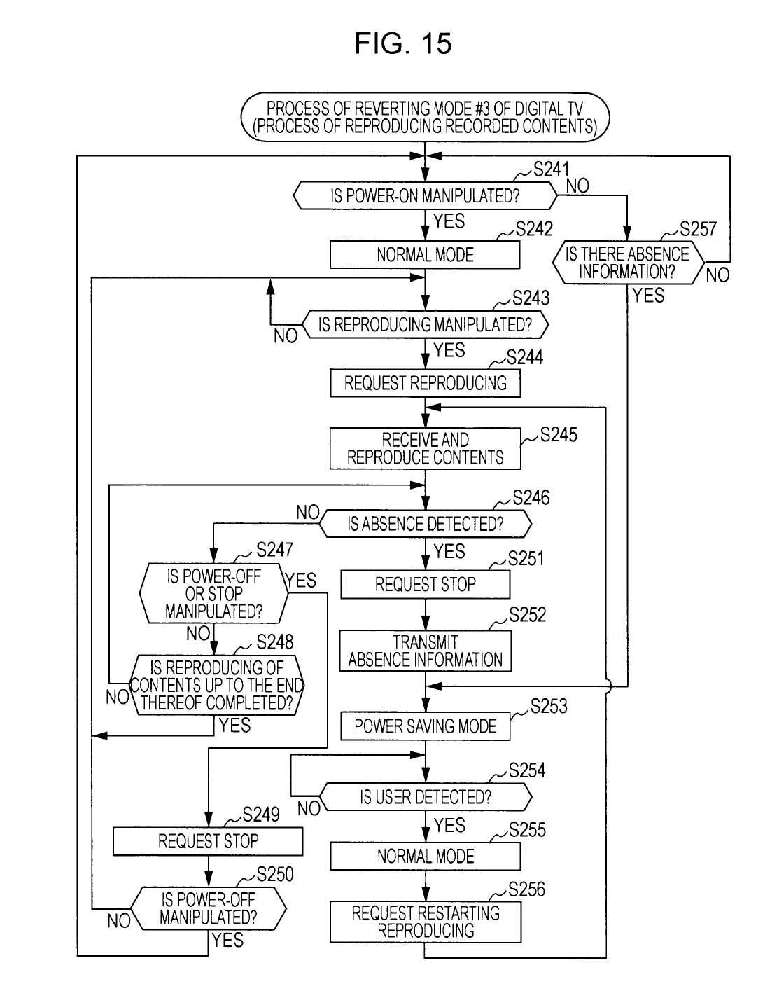

FIG. 15 is a flowchart illustrating a process performed by the digital TV 12 in a reverting process of a reverting mode #3.

In addition, the digital TV 13 also performs the same processes as those of the digital TV 12.

In Step S241, the CPU 41 of the digital TV 12 (FIG. 3) determines whether or not the mobile terminal 21 (FIG. 1) is manipulated so as to power on the digital TV 12.

In Step S241, in the case where it is determined that the mobile terminal 21 is manipulated so as to power on the digital TV 12, the CPU 41 of the digital TV 12 powers on the digital TV 12, and the process proceeds to Step S242.

In Step S242, the CPU 41 sets the operating mode of the digital TV 12 to the normal mode, and the process proceeds to Step S243.

In Step S243, the CPU 41 determines whether or not the mobile terminal 21 (FIG. 1) is manipulated so as to reproduce predetermined recorded contents. In the case where it is determined that the mobile terminal 21 is not manipulated, the process returns to Step S243.

In addition, in Step S243, in the case where it is determined that the mobile terminal 21 is manipulated so as to reproduce the predetermined recorded contents, the process proceeds to Step S244. The CPU 41 transmits a recorded contents reproducing request command of requesting for reproducing the predetermined recorded contents from the network I/F 44 to the recorder 11.

Next, the digital TV 12 waits for transmission of the recorded contents from the recorder 11 which receives the recorded contents reproducing request command, and the process proceeds from Step S244 to Step S245. The digital TV 12 receives and reproduces the recorded contents from the recorder 11 through the network I/F 44 (FIG. 3) and displays the recorded contents on the display portion 48.

In this manner, in the digital TV 12, if the displaying of the recorded contents is started, the process proceeds from Step S245 to Step S246. The CPU 41 (FIG. 3) determines whether or not it is detected that the user does not exist in the surrounding area of the digital TV 12.

In Step S246, in the case where it is determined that it is not detected that the user does not exist in the surrounding area of the digital TV 12, that is, in the case where the absence is not detected by the detection portion 49 (FIG. 3), the process proceeds to Step S247. The CPU 41 (FIG. 3) determines whether or not the mobile terminal 21 (FIG. 1) is manipulated so as to stop reproducing the recorded contents or so as to power off the digital TV 12.

In other words, in Step S247, it is determined whether or not a stop-reproducing request command of requesting for stopping the reproducing of the recorded contents in the digital TV 12 or a power-off request command of requesting for powering off the digital TV 12 is transmitted from the mobile terminal 21.

In Step S247, in the case where it is determined that both of the stop-reproducing request command and the power-off request command are not transmitted, the process proceeds to Step S248. The CPU 41 (FIG. 3) whether or not the reproducing of the recorded contents started (or restarted) in Step S245 is performed up to the end thereof.

In Step S248, if the recorded contents are determined not yet to be reproduced up to the end thereof, the process returns to Step S246.

In addition, in Step S248, if the recorded contents are determined to be reproduced up to the end thereof, the process returns to Step S243.

On the other hand, in Step S247, in the case where it is determined that any one of the stop-reproducing request command and the power-off request command is transmitted from the mobile terminal 21 to the digital TV 12, the process proceeds to Step S249. The CPU 41 (FIG. 3) transmits the stop-reproducing request command from the network I/F 44 to the recorder 11, the process proceeds to Step S250.

Herein, if the stop-reproducing request command is transmitted, the recorder 11 stops reproducing the recorded contents in response to the stop-reproducing request command.

In Step S250, the CPU 41 (FIG. 3) determines whether or not the user manipulates the mobile terminal 21 (FIG. 1) so as to power off the digital TV 12.

In Step S250, in the case where it is determined that the mobile terminal 21 is manipulated so as to power off the digital TV 12, that is, in the case where the command which is determined to be transmitted from the mobile terminal 21 in Step S247 is the power-off request command, the CPU 41 powers off the digital TV 12, and the process returns to Step S241.

In addition, in Step S250, in the case where it is determined that the mobile terminal 21 is not manipulated so as to power off the digital TV 12, that is, in the case where the command that is determined to be transmitted from the mobile terminal 21 in Step S247 is a stop-reproducing request command, the process returns to Step S243.

On the other hand, in Step 246, in the case where it is determined that the user is detected not to exist in the surrounding area of the digital TV 12, that is, in the case where the absence is detected by the detection portion 49 (FIG. 3), the process proceeds to Step S251. The CPU 41 (FIG. 3) performs a stopping control of transmitting a stop-reproducing request command of requesting for stopping the reproducing of the recorded contents of which the reproducing (or the restarting of the reproducing) is started in Step S245 from the network I/F 44 to the recorder 11.

After that, the process proceeds from Step S251 to Step S252. The CPU 41 transmits the absence information from the network I/F 44 to another TV, that is, the digital TV 13 on the network 10, and the process proceeds to Step S253.

In Step S253, the CPU 41 changes the operating mode of the digital TV 12 from the normal mode to the power saving mode, and the process proceeds to Step S254.

By changing the operating mode of the digital TV 12 to the power saving mode, the digital TV 12 stops displaying the recorded contents on the display portion 48 to be in the state that the digital TV 12 is operated with a necessary minimum power.

In this manner, after the operating mode of the digital TV 12 is set to the power saving mode, in Step S254, the CPU 41 determines whether or not the existence of user in the surrounding area is detected.

In Step S254, in the case where it is determined that the existence of user in the surrounding area is not detected, the process returns to Step S254.

Herein, in this manner, in Step S253, in the case where the operating mode of the digital TV 12 is set to the power saving mode, the digital TV 12 operates a timer to count time elapsing after entering into the power saving mode. Next, after entering into the power saving mode, in Step S254, in the case where the user is not determined to be detected and a predetermined time, for example, one hour elapses, the digital TV 12 is allowed to be powered off. The process returns to Step S241.

On the other hand, in Step S254, in the case where it is determined that the existence of user in the surrounding area is detected, that is, in the case where the existence of user in the surrounding area is detected by the detection portion 49 (FIG. 3), the process proceeds to Step S255. The CPU 41 changes the operating mode of the digital TV 12 from the power saving mode to the normal mode, and the process proceeds to Step S256.

In Step S256, the CPU 41 transmits a restarting-reproducing request command of requesting for restarting the reproducing of the recorded contents, of which the reproducing is stopped according to the stopping control, from the network I/F 44 to the recorder 11.

Next, the digital TV 12 waits for transmission of the recorded contents, of which the reproducing is stopped according to the stopping control of the digital TV 12 or 13, from the recorder 11 which receives the restarting-reproducing request command, and the process returns from Step S256 to Step S245. The digital TV 12 receives and reproduces the contents from the recorder 11 through the network I/F 44 (FIG. 3) and displays the recorded contents on the display portion 48.

In other words, in the display portion 48, the displaying of the recorded contents is restarted.

After the displaying of the recorded contents is restarted, the process proceeds from Step S245 to Step S246, and the same processes are repeated hereinafter.

On the other hand, in Step S241, in the case where it is determined that the mobile terminal 21 (FIG. 1) is not manipulated so as to power on the digital TV 12, the process proceeds to Step S257. The CPU 41 (FIG. 3) determines whether or not the absence information from another TV, that is, the digital TV 13 is received by the network I/F 44.

In Step S257, in the case where it is determined that the network I/F 44 does not receives the absence information from the digital TV 13, that is, in the case where the absence information is not transmitted from the digital TV 13, the process returns to Step S241.

In addition, in Step S257, in the case where it is determined that the network I/F 44 receives the absence information from the digital TV 13, that is, in the case where the absence information is transmitted from the digital TV 13, the CPU 41 powers on the digital TV 12 in response to the absence information from the digital TV 13, and the process proceeds to Step S253.

In Step S253, the CPU 41 sets the operating mode of the digital TV 12 to the power saving mode, and hereinafter, the same processes as those of the aforementioned case are performed.

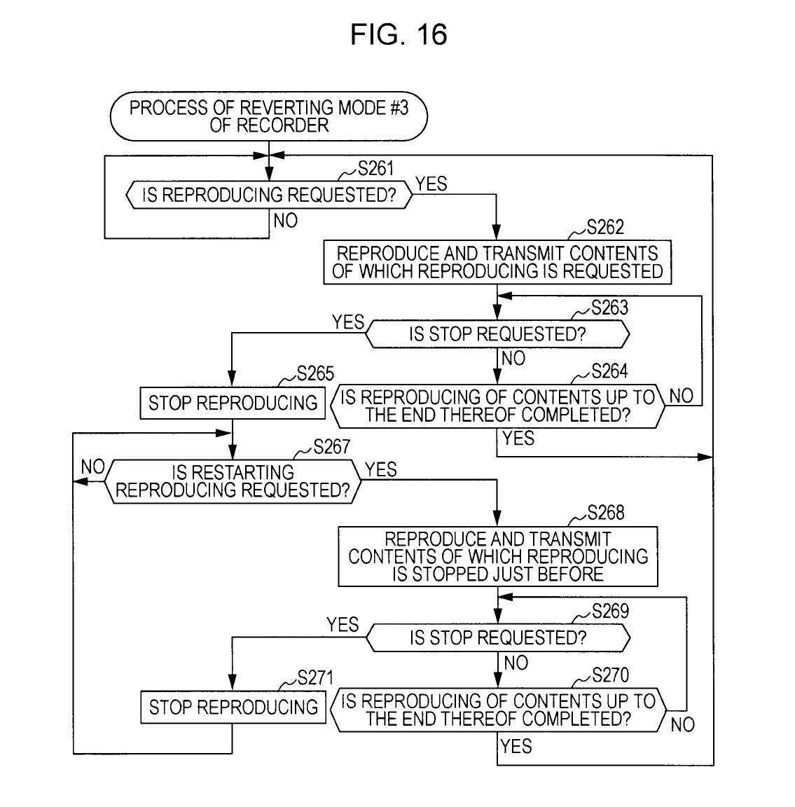

FIG. 16 is a flowchart illustrating a process performed by the recorder 11 in a reverting process of a reverting mode #3.

In the recorder 11, in Step S261, the CPU 31 (FIG. 2) determines whether or not a recorded contents reproducing request command of requesting for reproducing the recorded contents is transmitted.

In Step S261, in the case where it is determined that the recorded contents reproducing request command is not transmitted, the process returns to Step S261.

In Step S261, in the case where it is determined that the recorded contents reproducing request command is transmitted, that is, in the case where the recorded contents reproducing request command from the digital TV 12 or 13 is received by the network I/F 34 (FIG. 2) of the recorder 11, the process proceeds to Step S262. The CPU 31 (FIG. 2) reproduces the recorded contents, of which the reproducing is requested by the recorded contents reproducing request command, among the recorded contents recorded in the recording medium 37 by controlling the recording reproducing control portion 36 of the recorder 11 (FIG. 2) and transmits the contents from the network I/F 34 to any one of the digital TVs 12 and 13, which transmits the absence-recorded contents reproducing request command (the task is started).

In Step S262, after the reproducing and transmitting of the recorded contents from the recording medium 37 are started, the process proceeds to Step S263. The CPU 31 (FIG. 2) of the recorder 11 determines whether or not the stop-reproducing request command is transmitted from any one of the digital TVs 12 and 13, which transmits recorded contents reproducing request command.

In Step S263, in the case where it is determined that the stop-reproducing request command is not transmitted, the process proceeds to Step S264. The CPU 31 determines whether or not the recorded contents, of which the reproducing is started in Step S262, are reproduced up to the end thereof.

In Step S264, in the case where it is determined that the recorded contents are not yet reproduced up to the end thereof, the process returns to Step S263. The recorder 11 continuously performs the reproducing and transmitting of the recorded contents, which are started in Step S262.

In addition, in Step S264, in the case where it is determined that the recorded contents are reproduced up to the end thereof, the process returns to Step S261.

On the other hand, in Step S263, in the case where it is determined that the stop-reproducing request command is transmitted, that is, in the case where the stop-reproducing request command is received by the network I/F 34 (FIG. 2) of the recorder 11, the process proceeds to Step S265. The CPU 31 (FIG. 2) allows the recording reproducing control portion 36 to stop the reproducing of the recorded contents from the recording medium 37, and the process proceeds to Step S267.

In Step S267, the CPU 31 (FIG. 2) of the recorder 11 determines whether or not the restarting-reproducing request command of requesting for restarting the reproducing of the recorded contents is transmitted.

In Step S267, in the case where it is determined that the restarting-reproducing request command is not transmitted, the process returns to Step S267.

In addition, in Step S267, in the case where it is determined that the restarting-reproducing request command is transmitted, that is, in the case where the restarting-reproducing request command from the digital TV 12 or 13 is received by the network I/F 34 (FIG. 2) of the recorder 11, the process proceeds to Step S268. The CPU 31 (FIG. 2) restarts reproducing the recorded contents recorded in the recording medium 37 from the scene, of which the reproducing is stopped just before, by controlling the recording reproducing control portion 36 of the recorder 11 and transmits contents from the network I/F 34 to any one of the digital TVs 12 and 13, which transmits the restarting-reproducing request command (the task is started).

In Step S268, after the reproducing and transmitting of the recorded contents from the recording medium 37 are restarted, the process proceeds to Step S269. The CPU 31 (FIG. 2) of the recorder 11 determines whether or not the stop-reproducing request command is transmitted from any one of the digital TVs 12 and 13, which transmits the restarting-reproducing request command.

In Step S269, in the case where it is determined that the stop-reproducing request command is transmitted, that is, in the case where the network I/F 34 (FIG. 2) of the recorder 11 receives the stop-reproducing request command, the process proceeds to Step S271. The CPU 31 (FIG. 2) allows the recording reproducing control portion 36 to stop the reproducing of the recorded contents from the recording medium 37, and the process returns to Step S267.

In addition, in Step S269, in the case where it is determined that the stop-reproducing request command is not transmitted, the process proceeds to Step S270. The CPU 31 determines whether or not the recorded contents, of which the reproducing is started in Step S268, are reproduced up to the end thereof.

In Step S270, in the case where it is determined that the recorded contents are not yet reproduced up to the end thereof, the process returns to Step S269. The recorder 11 continuously performs the reproducing and transmitting of the recorded contents of which the reproducing is restarted in Step S268.

In addition, in Step S270, in the case where it is determined that the recorded contents are reproduced up to the end thereof, the process returns to Step S261.

In addition, in the aforementioned case, in the case where it is detected that the user does not exist in the surrounding area, the operating mode of the digital TV 12 or 13 is changed from the normal mode to the power saving mode, and after that, in the case where it is detected that the user exists in the surrounding area, the operating mode is changed from the power saving mode to the normal mode, and the contents presenting state becomes the reverted state. Besides, for example, it is detected based on the image obtained by photographing user's face whether the user is asleep or awakes according to the user's eyes being opened or closed. In the case where the user is detected to be asleep, the operating mode of the digital TV 12 or 13 is changed from the normal mode to the power saving mode. After that, in the case where user is detected to be awake, the operating mode is changed from the power saving mode to the normal mode, and the contents presenting state becomes the reverted state.

In addition, in the home network system of FIG. 1, it is determined based on, for example, user's manipulation of the mobile terminal 21 which one of the reverting processes of reverting modes are to be performed.

Besides, for example, in the case where the user views the television broadcasting program actually broadcasted as the contents by the digital TV 12 or 13, when the recorder 11 (or an apparatus having a recording reproducing function such as the recorder 11) does not exist on the network 10, the reverting process of the reverting mode #1 may be performed, and when the recorder 11 exists on the network 10, the reverting process of the reverting mode #2 may be performed.

In addition, for example, in the case where a user views recorded contents by the digital TV 12 or 13, the reverting process of the reverting mode #3 may be performed.

### Second Example of Configuration of Mobile Terminal 21

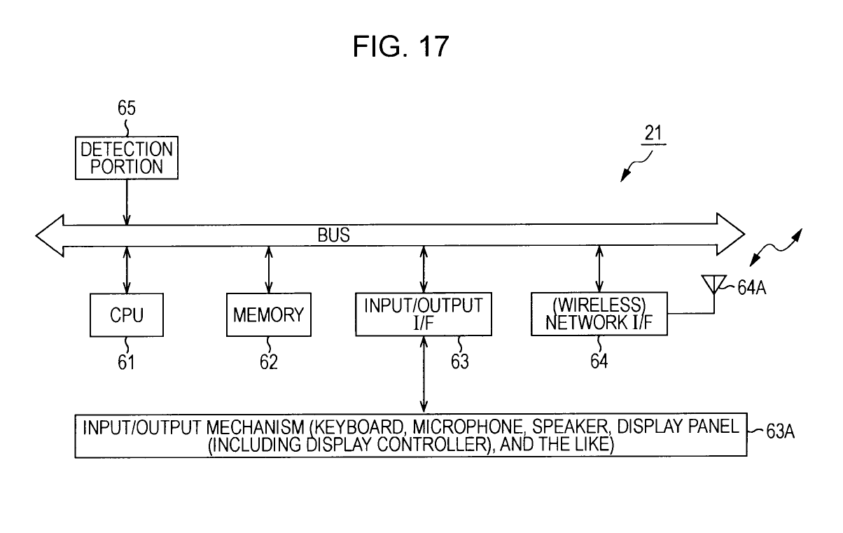

FIG. 17 is a block diagram illustrating a second example of a configuration of the mobile terminal 21 of FIG. 1.

In addition, in the figure, the components corresponding to the case of FIG. 5 are denoted by the same reference numerals, and hereinafter, the description thereof is appropriately omitted.

The mobile terminal 21 of FIG. 17 is the same as the case of FIG. 5 in that the CPU 61 to the antenna 64A is included.

However, the mobile terminal 21 of FIG. 17 is different from the case of FIG. 5 in that the detection portion 65 is further included.

The detection portion 65 detects movement of a user (movement of the mobile terminal 21) who carries the mobile terminal 21.

In the detection portion 65, an arbitrary method may be employed as a method of detecting the movement of the user who carries the mobile terminal 21.

For example, the detection portion 65 may measure an intensity of a signal received through the antenna 64A from the access point 14 and detect the movement of the user who carries the mobile terminal 21 according to the intensity (a change thereof).

In addition, for example, the digital TVs 12 and 13 or the like are allowed to output a wireless signal such as light or an electromagnetic wave, and the detection portion 65 measures an intensity of the signal and detects the movement of the user carrying the mobile terminal 21 according to the intensity.

Moreover, for example, the detection portion 65 may detect the movement of the user carrying the mobile terminal 21 by using a GPS (Global Positioning System).

In the home network system of FIG. 1 which includes the mobile terminal 21 having the configuration as illustrated in FIG. 17, as described above, the digital TV 12 or 13 may perform the aforementioned reverting process by detecting whether or not the user exists in the surrounding area thereof, and the detection portion 65 included in the mobile terminal 21 of FIG. 17 may also perform the reverting process by detecting the movement of the user (carrying the mobile terminal 21).

In addition, in the case where the reverting process is performed by detecting the movement of the user by the detection portion 65 included in the mobile terminal 21 of FIG. 17, the digital TV 12 (FIG. 3) may be configured so that the detection portion 49 is not provided. Similarly, the digital TV 13 (FIG. 4) may also be configured so that the detection portion 59 is not provided.

The reverting process performed by detecting the movement of the user in the detection portion 65 included in the mobile terminal 21 of FIG. 17 is different from the reverting process performed by detecting whether or not the user exists in the surrounding area in the digital TV 12 or 13 in that the reverting process performed by detecting whether or not the user exists in the surrounding area in the digital TV 12 or 13 is performed according to the command transmitted from the digital TV 12 or 13 by detecting the movement of the user by the mobile terminal 21.

Therefore, in the case where the mobile terminal 21 of FIG. 17 detects the movement of the user, the process performed by the digital TVs 12 and 13 is the same the case of detecting whether or not the user exists in the surrounding area of the digital TV 12 or 13 except that the it is not detected whether or not the user does exist in the surrounding area and that the process is performed according to the command from the mobile terminal 21.

Hereinafter, a reverting process performed by detecting movement of user in the detection portion 65 included in the mobile terminal 21 of FIG. 17 is described in detail.

### Reverting Process of Reverting Mode #1

A reverting process of a reverting mode #1 performed by the home network system of FIG. 1 in the case where user's movement is detected by the mobile terminal 21 (detection portion 65 included therein) of FIG. 17 is described.

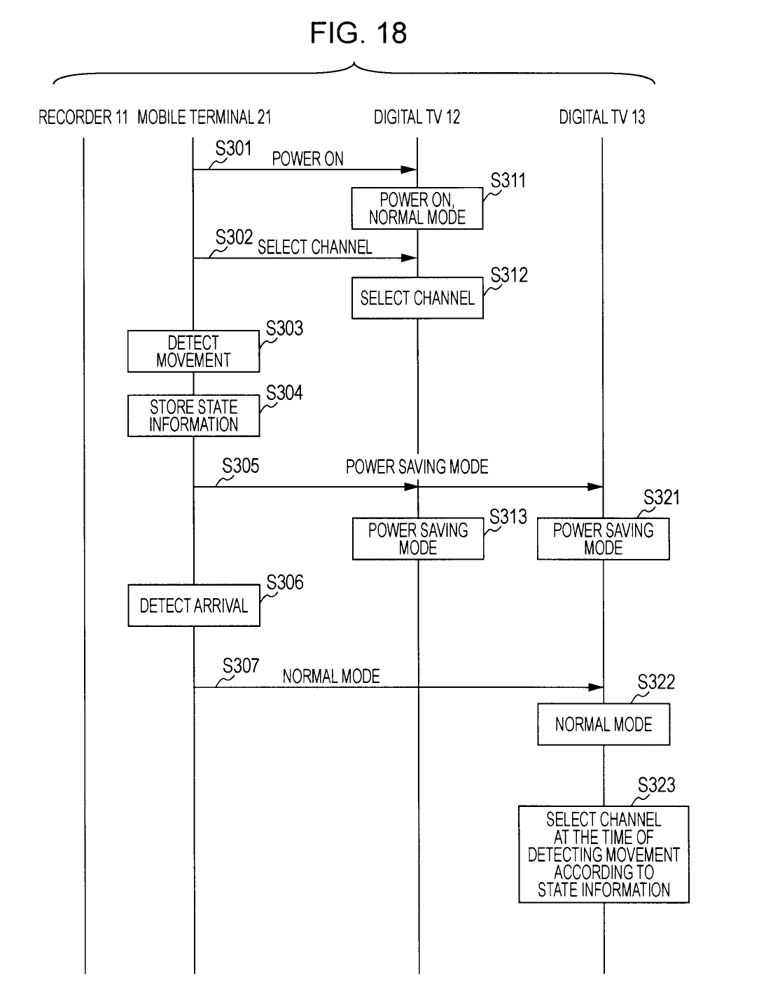

FIG. 18 is a diagram illustrating a reverting process in a reverting mode #1 performed, for example, in the case where a user viewing contents broadcasted through a channel by the digital TV 12 in the room A leaves the room A due to something to do and does not come back to the room A but enter the room B.

For example, if the user manipulates the input/output mechanism 63A of the mobile terminal 21 (FIG. 17) so as to power on the digital TV 12 in the room A, in Step S301, the CPU 61 (FIG. 17) of the mobile terminal 21 transmits a command corresponding to the manipulation of the input/output mechanism 63A from the network I/F 64.

The command from the mobile terminal 21 is received by the network I/F 44 of the digital TV 12 (FIG. 3) and supplied to the CPU 41.

In Step S311, the CPU 41 allows the digital TV 12 to be powered on and sets the operating mode to the normal mode according to the command from the mobile terminal 21.

After that, if the user manipulates the input/output mechanism 63A of the mobile terminal 21 (FIG. 17) so as to select a predetermined channel, in Step S302, the mobile terminal 21 transmits a command corresponding to the manipulation.

The command from the mobile terminal 21 is received by the network I/F 44 of the digital TV 12 (FIG. 3) and supplied to the CPU 41.

The CPU 41 controls the receiving portion 45 so as to select a predetermined channel according to the command from the mobile terminal 21.

In this case, in the digital TV 12, the receiving portion 45 acquires the contents broadcasted through a predetermined channel by extracting a television broadcasting signal of the predetermined channel from the television broadcasting signals supplied thereto according to the control of the CPU 41.

The contents acquired by the receiving portion 45 are supplied through the decoder 46 and the display controller 47 to the display portion 48 and displayed thereon.

Accordingly, the user may view the contents.

In this manner, in the case where the contents are displayed on the display portion 48 of the digital TV 12, for example, when the user viewing the contents displayed on the display portion 48 leaves the room A where the digital TV 12 is installed due to something to do and disappears from the surrounding area of the digital TV 12, in Step S303, the detection portion 65 (FIG. 17) of the mobile terminal 21 detects that the user moves from the surrounding area of the digital TV 12 (movement is detected).

In the case where the contents are displayed on the display portion 48 of the digital TV 12, if the movement is detected by the detection portion 65, in Step S304, the CPU 61 (FIG. 17) of the mobile terminal 21 generates the state information indicating the state of the digital TV 12 at the time when it is detected that the user viewing the contents displayed on the display portion 48 of the digital TV 12 moves from the surrounding area of the digital TV 12 and stores the state information in the memory 62 (FIG. 17).

After that, in Step S305, the CPU 61 of the mobile terminal 21 controls the network I/F 64 to transmit a command (hereinafter, referred to as a power saving mode command) of requesting for setting the operating mode to the power saving mode to the digital TV 12, through which the user views the contents until the movement is detected, and to any TV (all the TVs other than the TV 12), that is the digital TV 13 on the network 10.

If the power saving mode command is transmitted from the mobile terminal 21, the digital TVs 12 and 13 receive the power saving mode command.

Next, in Step S313, the CPU 41 (FIG. 3) of the digital TV 12 sets the operating mode of the digital TV 12 to the power saving mode in response to the power saving mode command from the mobile terminal 21.

Moreover, in Step S321, the CPU 51 (FIG. 4) of the digital TV 13 sets the operating mode of the digital TV 13 to the power saving mode in response to the power saving mode command from the mobile terminal 21.

In this manner, in the case where the contents are displayed on the display portion 48 of the digital TV 12, if the movement is detected by the detection portion 65, the digital TV 12 sets the operating mode to the power saving mode.

Therefore, when the user does not view the contents, wasteful power consumption caused by displaying the contents on the display portion 48 may be prevented.

After it is detected that the user moves from the surrounding area of the digital TV 12 and, thus, the operating mode of the digital TVs 12 and 13 is set to the power saving mode, for example, if the user, who finishes something to do, does not come back to the room A where the digital TV 12 is installed and enters the room B where the digital TV 13 is installed, in Step S306, the detection portion 65 (FIG. 17) of the mobile terminal 21 detects that the user moves to the surrounding area of the digital TV 13 (arrival is detected).

If the detection portion 65 of the mobile terminal 21 detects that the user arrives to the surrounding area of the digital TV 13 (a TV other than the digital TV 12 in the vicinity of the user just before the movement is detected), in Step S307, the CPU 61 (FIG. 17) of the mobile terminal 21 controls the network I/F 64 to transmit a command (hereinafter, referred to as a normal mode command) of requesting for changing the operating mode to the normal mode together with the state information stored in the memory 62 in Step 304 to the digital TV 13, which is in the vicinity of the user at the time of detecting the arrival.

If the normal mode command is transmitted from the mobile terminal 21, the digital TV 13 receives the normal mode command.

Next, in Step S322, the CPU 51 (FIG. 4) of the digital TV 13 sets the operating mode of the digital TV 13 to the normal mode in response to the normal mode command from the mobile terminal 21.

Moreover, in Step S323, the CPU 51 controls the receiving portion 55 (FIG. 4) so as to select the channel indicated by the state information according to the state information included in the normal mode command from the mobile terminal 21.

The receiving portion 55 acquires the contents broadcasted through the channel which is selected by the digital TV 12 at the time of detecting the movement at the time when the user moves from the surrounding area of the digital TV 12 by extracting television broadcasting signal of a predetermined channel according to the control of the CPU 51 from the television broadcasting signal supplied thereto and supplies the contents through the decoder 56 and the display controller 57 to the display portion 58 to be displayed thereon.

In this manner, in the case where the movement of the user viewing the contents by the digital TV 12 is detected and, after that, the movement of the user to the surrounding area of the digital TV 13 is detected, the mobile terminal 21 remotely controls the digital TV 13 so that the contents displayed in the digital TV 12 before the movement are acquired by the receiving portion 55 of the digital TV 13 (FIG. 4) at the destination of the movement and displayed on the display portion 58.

Accordingly, the digital TV 13 in the room B is in the reverted state where the contents presenting (displaying) state reverts to the state (a state near to the state) at the time when the user leaves the room A.

Therefore, in the case where the user viewing the contents through the digital TV 12 in the room A enters the room B, the user may restart the viewing of the contents broadcasted through the channel, through which the user viewed the contents just before leaving the room A where the digital TV 12 is installed, without particularly manipulating the digital TV 13 in the room B.

In this manner, since the digital TV 13 in the room B is in the reverted state where contents presenting state reverts to the state at the time when the user leaves the room A, it is possible to improve the convenience of the digital TVs 12 and 13.

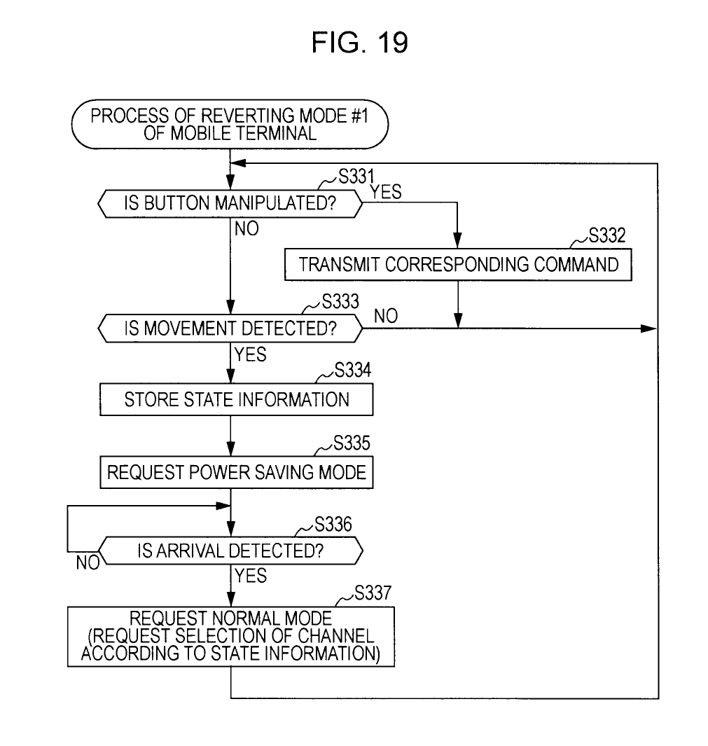

FIG. 19 is a diagram illustrating a process performed by the mobile terminal 21 of FIG. 17 in a reverting process of a reverting mode #1.

In addition, hereinafter, any one of the digital TVs 12 and 13, which exists in the vicinity of the mobile terminal 21, is appropriately referred to as a to-be-controlled TV.

In Step S331, the CPU 61 (FIG. 17) of the mobile terminal 21 determines whether or not the input/output mechanism 63A is manipulated (button-manipulated) so as to request the to-be-controlled TV to perform a predetermined process.

Herein, when the process of Step S331 is performed, the to-be-controlled TV is powered on; the operating mode is set to the normal mode; and the contents broadcasted through a predetermined channel are displayed.

In Step S331, in the case where it is determined that the input/output mechanism 63A is manipulated, the process proceeds to Step S332. The CPU 61 (FIG. 17) transmits a command corresponding to the manipulation of the input/output mechanism 63A from the network I/F 64 to the to-be-controlled TV, and the process returns to Step S331.

In addition, in Step S331, in the case where it is determined that the input/output mechanism 63A is not manipulated, the process proceeds to Step S333. The CPU 61 (FIG. 17) of the mobile terminal 21 determines whether or not the user is detected to move from the surrounding area of the to-be-controlled TV.

In Step S333, in the case where it is determined that the user is not detected to move from the surrounding area of the to-be-controlled TV, the process returns to Step S331.

In addition, in Step S333, in the case where it is determined that the user is detected to move from the surrounding area of the to-be-controlled TV, that is, in the case where the movement is detected by the detection portion 65 (FIG. 17), the process proceeds to Step S334. The CPU 61 (FIG. 17) generates the state information of the to-be-controlled TV at the time just before the movement is detected and stores the state information in the memory 62, and the process proceeds to Step S335.

In Step S335, the CPU 61 transmits the power saving mode command from the network I/F 64 to all the digital TVs 12 and 13 on the network 10 (FIG. 1), and the process proceeds to Step S336.

In Step S336, the CPU 61 (FIG. 17) of the mobile terminal 21 determines whether or not the user is detected to arrive at the surrounding area of any one of the digital TVs 12 and 13 on the network 10.

In Step S336, in the case where it is determined that the user is not detected to arrive at the surrounding area of any one of the digital TVs 12 and 13 on the network 10, the process returns to Step S336.

In addition, in Step S336, in the case where it is determined that the user is detected to arrive at the surrounding area of any one of the digital TVs 12 and 13 on the network 10, that is, in the case where the arrival is detected by the detection portion 65 and, thus, the digital TV 12 or 13 exists in the vicinity of the user, that is, in the vicinity of the mobile terminal 21 carried by the user, the process proceeds to Step S337. The CPU 61 (FIG. 17) of the mobile terminal 21 sets the TV in the vicinity of the user at the time of arrival detection among the digital TVs 12 and 13 as the to-be-controlled TV and transmits a normal mode command including the state information stored in the memory 62 from the network I/F 64 to the to-be-controlled TV, and the process returns to Step S331.

Herein, the to-be-controlled TV that receives the normal mode command from the mobile terminal 21 sets the operating mode to the normal mode, and the contents broadcasted through the channel indicated by the state information are displayed according to the state information included in the normal mode command.

### Reverting Process of Reverting Mode #2

A reverting process of a reverting mode #2 performed by the home network system of FIG. 1 in the case where user's movement is detected by the mobile terminal 21 (detection portion 65 included therein) of FIG. 17 is described.

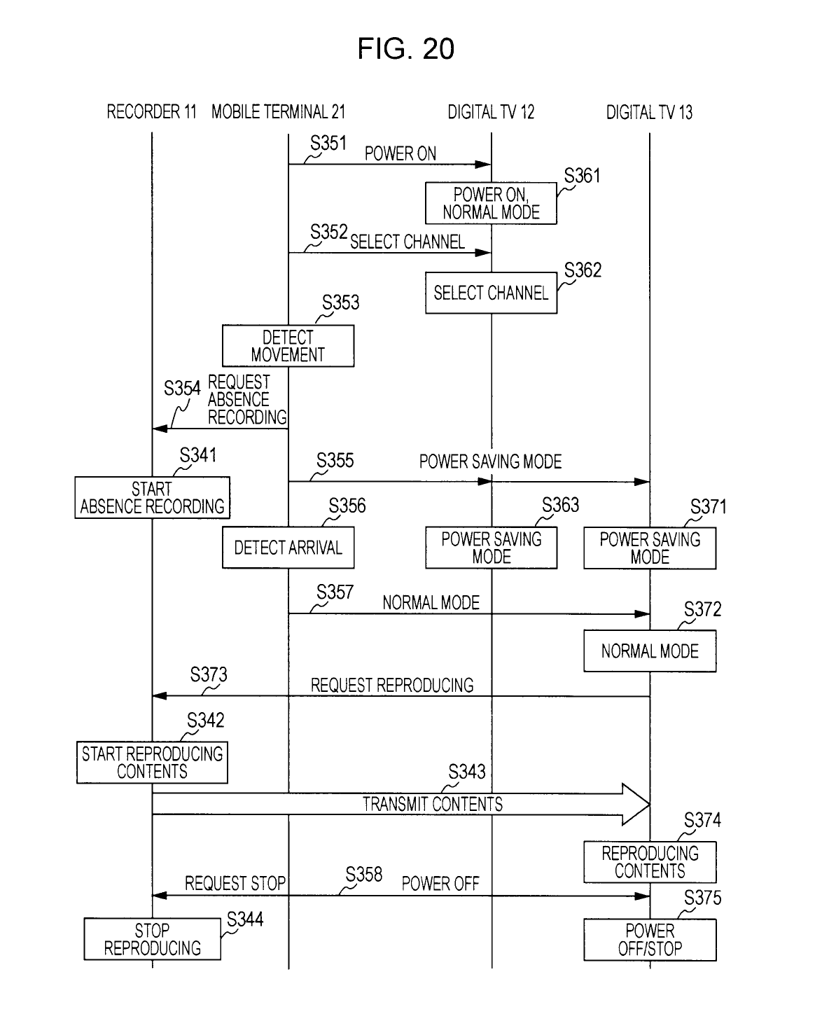

FIG. 20 is a diagram illustrating a reverting process in a reverting mode #2 performed, for example, in the case where a user viewing contents broadcasted through a channel by the digital TV 12 in the room A leaves the room A due to something to do and does not come back to the room A but enter the room B.

For example, if the user manipulates the input/output mechanism 63A of the mobile terminal 21 (FIG. 17) so as to power on the digital TV 12 in the room A and if the user manipulates the input/output mechanism 63A so as to select a predetermined channel, in Steps S351 and S352, similarly to the Steps S301 and S302 of FIG. 18, the CPU 61 (FIG. 17) of the mobile terminal 21 transmits commands corresponding to the manipulations of the input/output mechanism 63A from the network I/F 64.

The command from the mobile terminal 21 is received by the network I/F 44 of the digital TV 12 (FIG. 3) and supplied to the CPU 41.

In Step S361, similarly to Step S311 of FIG. 18, the CPU 41 allows the digital TV 12 to be powered on and sets the operating mode to the normal mode according to the command from the mobile terminal 21.

Moreover, in Step S362, the CPU 41 controls the receiving portion 45 (FIG. 3) so as to select a predetermined channel according to the command from the mobile terminal 21.

Accordingly, in the digital TV 12 (FIG. 3), the contents broadcasted through a predetermined channel are acquired by the receiving portion 45 and displayed on the display portion 48.

In this manner, in the case where the contents are displayed on the display portion 48 of the digital TV 12, for example, when the user viewing the contents displayed on the display portion 48 leaves the room A where the digital TV 12 is installed due to something to do and disappears from the surrounding area of the digital TV 12, in Step S353, the detection portion 65 (FIG. 17) of the mobile phone 21 detects that the user moves from the surrounding area of the digital TV 12 (movement is detected).

In the case where the contents are displayed on the display portion 48 of the digital TV 12, if the movement is detected by the detection portion 65 of the mobile terminal 21, in Step S354, the CPU 61 of the mobile terminal 21 performs a recording control of recording the contents, which are acquired by the receiving portion 45 of the digital TV 12 at the time when the movement is detected and displayed on the display portion 48, in the recorder 11 (the recording medium 37 (FIG. 2) thereof).

In other words, in Step S354, the CPU 61 (FIG. 17) of the mobile terminal 21 transmits an absence recording request command of requesting for recording (absence recording) of the contents, which are acquired by the receiving portion 45 at the time when the movement is detected, from the network I/F 64 to the recorder 11.

The CPU 31 (FIG. 2) of the recorder 11 receives the absence recording request command from the mobile terminal 21 through the network I/F 34, and in Step S341, starts the recording (absence recording) of the contents, which are acquired by the receiving portion 45 (FIG. 3) of the digital TV 12 at the time when the movement is detected in the mobile terminal 21, in the recording medium 37 by controlling the receiving portion 35 and the recording reproducing control portion 36.

In other words, the absence recording request command from the mobile terminal 21 includes information on a channel, which broadcasts the contents which are acquired by the receiving portion 45 (FIG. 3) of the digital TV 12 at the time when the movement is detected in the mobile terminal 21 and a broadcast ending time. The receiving portion 35 (FIG. 2) of the recorder 11 acquires the contents broadcasted through the channel included in the absence recording request command and supplies the contents to the recording reproducing control portion 36.

The recording reproducing control portion 36 records (absence-records) the contents from the receiving portion 35 in the recording medium 37.

Herein, in the recorder 11, as described above, the absence recording is performed up to the broadcast ending time included in the absence recording request command from the digital TV 12.

After the mobile terminal 21 transmits the absence recording request command, in Step S355, similarly to Step S305 of FIG. 18, the CPU 61 of the mobile terminal 21 controls the network I/F 64 to transmit a power saving mode command of requesting setting the operating mode to the power saving mode to the digital TV 12, through which the user views the contents until the movement is detected, and to another TV, that is, the digital TV 13 on the network 10.

If the power saving mode command is transmitted from the mobile terminal 21, the digital TVs 12 and 13 receive the power saving mode command.

Next, in Step S363, the CPU 41 (FIG. 3) of the digital TV 12 sets the operating mode of the digital TV 12 to the power saving mode in response to the power saving mode command from the mobile terminal 21.

Moreover, in Step S371, the CPU 51 (FIG. 4) of the digital TV 13 sets the operating mode of the digital TV 13 to the power saving mode in response to the power saving mode command from the mobile terminal 21.

In this manner, in the case where the contents are displayed on the display portion 48 of the digital TV 12, if the movement is detected by the detection portion 65, the digital TV 12 sets the operating mode to the power saving mode.

Therefore, when the user does not view the contents, wasteful power consumption caused by displaying the contents on the display portion 48 of the digital TV 12 may be prevented.

After it is detected that the user moves from the surrounding area of the digital TV 12 and, thus, the operating mode of the digital TVs 12 and 13 is set to the power saving mode, for example, if the user, who finishes something to do, does not come back to the room A where the digital TV 12 is installed and enters the room B where the digital TV 13 is installed, in Step S356, similarly to Step S306 of FIG. 18, the detection portion 65 (FIG. 17) of the mobile terminal 21 detects that the user moves to the surrounding area of the digital TV 13 (arrival is detected).

If the detection portion 65 of the mobile terminal 21 detects that the user arrives to the surrounding area of the digital TV 13, in Step S357, the CPU 61 (FIG. 17) of the mobile terminal 21 controls the network I/F 64 to transmit a normal mode command of requesting for changing the operating mode to the normal mode together with the absence recording information indicating that the absence recording is performed to the digital TV 13 in the vicinity of the user at the time when the arrival is detected, so that the remote control of the digital TV 13 is performed so as to display the contents recorded (absence-recorded) in the recorder 11 (the recording medium 37 (FIG. 2) thereof) by the recording control of the mobile terminal 21.

If the normal mode command including the absence recording information is transmitted from the mobile terminal 21, the digital TV 13 receives the normal mode command.

Next, in Step S372, the CPU 51 (FIG. 4) of the digital TV 13 sets the operating mode of the digital TV 13 to the normal mode in response to the normal mode command from the mobile terminal 21.

Moreover, in the case where the normal mode command including the absence recording information is received, in Step S373, the CPU 51 transmits the absence-recorded contents reproducing request command of requesting for the reproducing of the contents, of which the absence recording is performed just before, according to the absence recording information included in the normal mode command from the network I/F 54 to the recorder 11.

The CPU 31 (FIG. 2) of the recorder 11 receives the absence-recorded contents reproducing request command from the digital TV 13 through the network I/F 34 and, in Step S342, starts reproducing the contents, which are absence-recorded and recorded in the recording medium 37, by controlling the recording reproducing control portion 36.

Next, in Step S343, in the recorder 11, the contents reproduced from the recording medium 37 are transmitted from the network I/F 34 to the digital TV 13 which transmits the absence-recorded contents reproducing request command.

In the digital TV 13, in Step S374, the contents from the recorder 11 are received by the network I/F 54 (FIG. 4) and reproduced, and the contents are reproduced on the display portion 58.

Accordingly, the digital TV 13 in the room B is in the reverted state where the contents presenting (displaying) state reverts to the state at the time when the user leaves the room A.

In other words, in the digital TV 13 in the room B which the user enters, the contents are displayed from the consecutive scene of the contents which the user views at the time when the user leaves the room A.

In this manner, in the case where it is detected that the user moves to the surrounding area of the digital TV 13, the mobile terminal 21 performs the remote control of controlling the digital TV 13 so as to display the contents recorded (absence-recorded) in the recorder 11 (the recording medium 37 (FIG. 2) thereof) by the recording control of the mobile terminal 21.

Next, in the digital TV 13, the absence-recorded contents are displayed in response to the remote control from the mobile terminal 21, that is, the normal mode command including the absence recording information.

Therefore, in the room B, the user may restart viewing from the consecutive scene of the contents which the user views just before leaving the room A where the digital TV 12 is installed without returning to the room A where the user views the contents and without particularly manipulating the digital TV 13 in the room B. In addition, the user may view the scenes broadcasted from the time when the user leaves the room A to the time when the user enters the room B without missing any scene.

In this manner, since the digital TV 13 in the room B is in the reverted state where contents presenting state reverts to the state at the time when the user leaves the room A, it is possible to improve the convenience of the digital TVs 12 and 13.

After that, if the user manipulates the mobile terminal 21 (FIG. 1) so as to stop the reproducing of the contents or so as to power off the digital TV 13, in Step S358, the stop-reproducing request command of requesting for stopping the reproducing of the contents or the power-off request command of requesting for powering off in response to the manipulation is transmitted from the mobile terminal 21 to the digital TV 13.

Moreover, in Step S358, the stop-reproducing request command is transmitted from the mobile terminal 21 to the recorder 11.

In Step S375, the digital TV 13 stops the reproducing of the contents in response to the stop-reproducing request command or the power-off request command from the mobile terminal 21, or the digital TV 13 is allowed to be powered off.

In addition, in Step S344, the recorder 11 stops the reproducing of the absence-recorded contents in response to the stop-reproducing request command from the mobile terminal 21.

In addition, in FIG. 20, in Step S373, although the absence-recorded contents reproducing request command of requesting for the reproducing of the absence-recorded contents is transmitted from the digital TV 13 to the recorder 11, the absence-recorded contents reproducing request command may also be transmitted, for example, from the mobile terminal 21 to the recorder 11.

In addition, in FIG. 20, in Step S358, although the stop-reproducing request command is transmitted from the mobile terminal 21 to the recorder 11, in the digital TV 13, the stop-reproducing request command may be transmitted to the recorder 11 in response to the transmission of the stop-reproducing request command from the mobile terminal 21 to the digital TV 13 or the power-off request command.

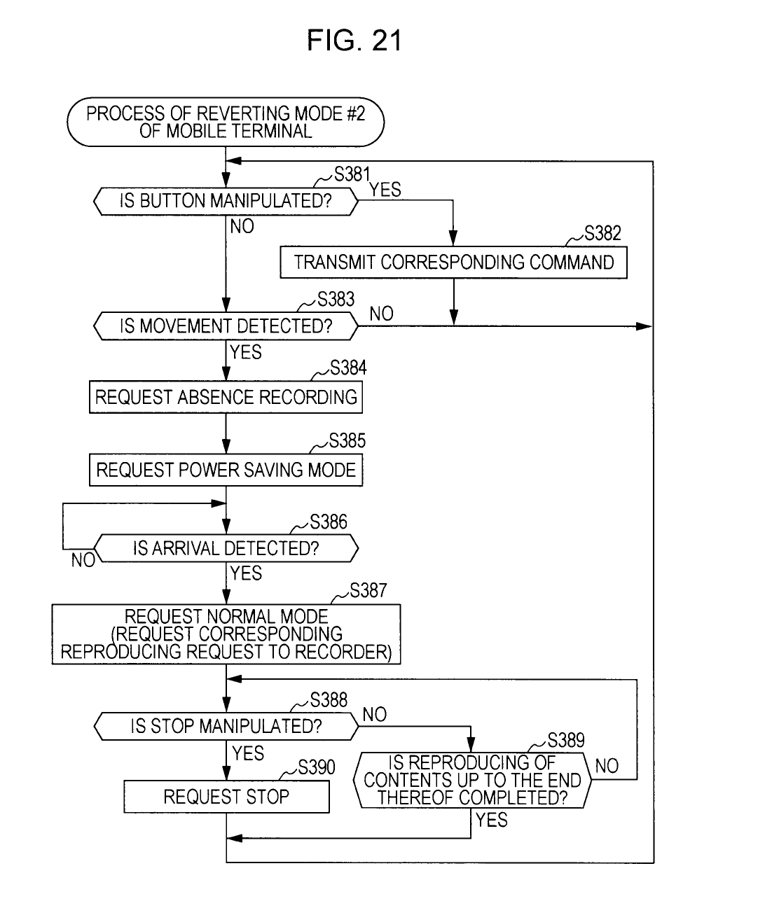

FIG. 21 is a flowchart illustrating a process performed by the mobile terminal 21 of FIG. 17 in a reverting process of a reverting mode #2.

In the mobile terminal 21, the same processes as those of Steps S331 to S333 of FIG. 19 are performed in Steps S381 to S383.

In other words, in Step S381, the CPU 61 (FIG. 17) of the mobile terminal 21 determines whether or not the input/output mechanism 63A is manipulated (button-manipulated) so as to request a predetermined process with respect to the to-be-controlled TV (that is, the digital TV 12 or 13).

Herein, when the process of Step S381 is performed, the to-be-controlled TV is powered on; the operating mode is set to the normal mode; and the contents broadcasted through a predetermined channel are displayed.

In Step S381, in the case where it is determined that the input/output mechanism 63A is manipulated, the process proceeds to Step S382. The CPU 61 (FIG. 17) transmits a command corresponding to the manipulation of the input/output mechanism 63A from the network I/F 64 to the to-be-controlled TV, and the process returns to Step S381.

In addition, in Step S381, in the case where it is determined that the input/output mechanism 63A is not manipulated, the process proceeds to Step S383. The CPU 61 (FIG. 17) of the mobile terminal 21 determines whether or not the user is detected to move from the surrounding area of the to-be-controlled TV.

In Step S383, in the case where it is determined that the user is not detected to move from the surrounding area of the to-be-controlled TV, the process returns to Step S381.

In addition, in Step S383, in the case where it is determined that the user is detected to move from the surrounding area of the to-be-controlled TV, that is, in the case where the movement is detected by the detection portion 65 (FIG. 17), the process proceeds to Step S384. The CPU 61 (FIG. 17) of the mobile terminal 21 transmits the absence recording request command of recording the contents, which are acquired and displayed by the to-be-controlled TV at the time when the movement is detected, in the recorder 11 (the recording medium 37 (FIG. 2) thereof) from the network I/F (FIG. 17) to the recorder 11, and the process proceeds to Step S385.

In Step S385, the CPU 61 of the mobile terminal 21 transmits the power saving mode command from the network I/F 64 to all the digital TVs 12 and 13 on the network 10 (FIG. 1), and the process proceeds to Step S386.

In Step S386, the CPU 61 (FIG. 17) of the mobile terminal 21 determines whether or not the user is detected to arrive at the surrounding area of any one of the digital TVs 12 and 13 on the network 10.

In Step S386, in the case where it is determined that the user is not detected to arrive at the surrounding area of any one of the digital TVs 12 and 13 on the network 10, the process returns to Step S386.

In addition, in Step S386, in the case where it is determined that the user is detected to arrive at the surrounding area of any one of the digital TVs 12 and 13 on the network 10, that is, in the case where the arrival is detected by the detection portion 65 and, thus, the digital TV 12 or 13 exists in the vicinity of the user, that is, in the vicinity of the mobile terminal 21 carried by the, user, the process proceeds to Step S387. The CPU 61 (FIG. 17) of the mobile terminal 21 sets the TV in the vicinity of the user at the time of detecting the arrival among the digital TVs 12 and 13 as the to-be-controlled TV and transmits a normal mode command including the absence recording information from the network I/F 64 to the to-be-controlled TV, and the process proceeds to Step S388.

Herein, the to-be-controlled TV that receives the normal mode command including the absence recording information from the mobile terminal 21 sets the operating mode to the normal mode in response to the normal mode command and transmits the absence-recorded contents reproducing request command to the recorder 11 in response to the absence recording information included in the normal mode command. Accordingly, the recorder 11 transmits the absence-recorded contents to the to-be-controlled TV, and the contents from the recorder 11 are displayed in the to-be-controlled TV.

In Step S388, the CPU 61 (FIG. 17) of the mobile terminal 21 determines whether or not the mobile terminal 21 is manipulated so as to stop the reproducing of the contents.

In Step S388, in the case where it is determined that the mobile terminal 21 is not manipulated so as to stop the reproducing of the contents, the process proceeds to Step S389. The mobile terminal 21 determines whether or not the absence-recorded contents are reproduced up to the end thereof by communicating with the recorder 11.

In Step S389, in the case where it is determined that the absence-recorded contents are not yet reproduced up to the end thereof, the process returns to Step S388.

In addition, in Step S388, in the case where it is determined that the mobile terminal 21 is manipulated so as to stop the reproducing of the contents, the process proceeds to Step S390. The CPU 61 (FIG. 17) of the mobile terminal 21 transmits a stop-reproducing request command from the network I/F 64 to the recorder 11 and the to-be-controlled TV.

Next, in the case where it is determined that the absence-recorded contents are reproduced up to the end thereof in Step S389, and after the stop-reproducing request command is transmitted in Step S390, the CPU 61 (FIG. 17) of the mobile terminal 21 controls the to-be-controlled TV so as to select the channel through which, for example, the absence-recorded contents are broadcasted, and the process returns to Step S381.

### Reverting Process of Reverting Mode #3

A reverting process of a reverting mode #3 performed by the home network system of FIG. 1 in the case where user's movement is detected by the mobile terminal 21 (detection portion 65 included therein) of FIG. 17 is described.

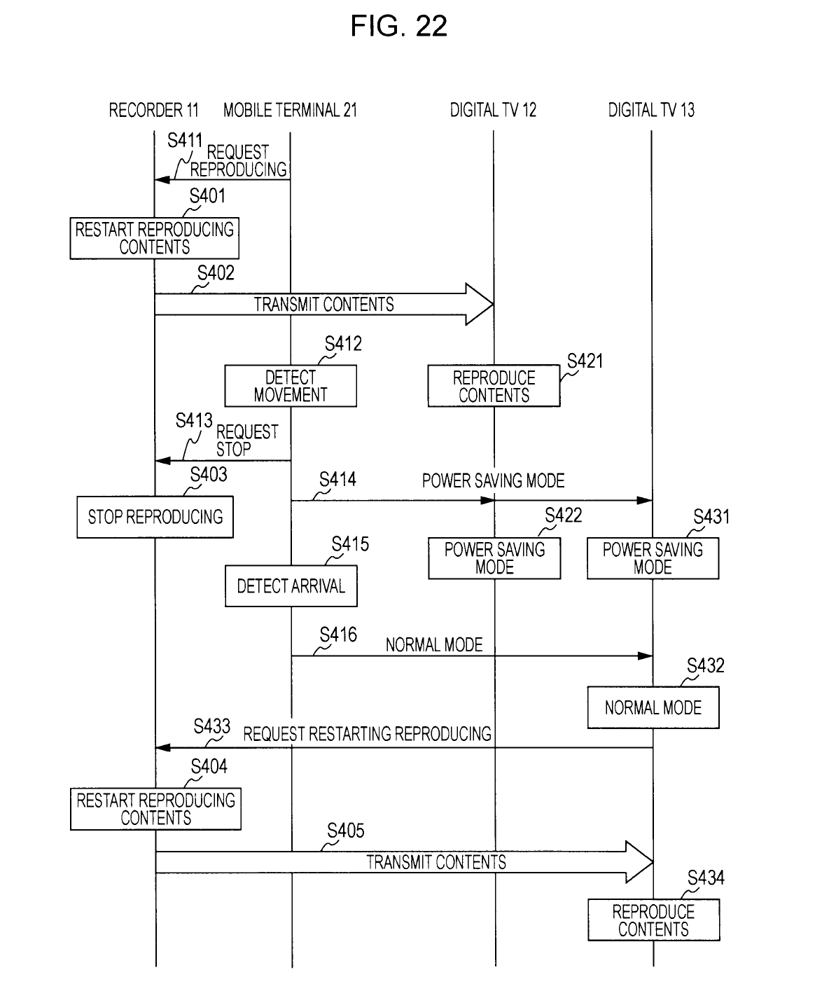

FIG. 22 is a diagram illustrating a reverting process in a reverting mode #3 performed, for example, in the case where a user viewing recorded contents recorded in the recorder 11 by the digital TV 12 in the room A leaves the room A due to something to do and does not come back to the room A but enter the room B.

In addition, the digital TV 12 in the room A is assumed to be powered on, and the operating mode is assumed to be the normal mode.

For example, if the user manipulates the input/output mechanism 63A of the mobile terminal 21 (FIG. 17) so as to reproduce predetermined recorded contents in the room A where the digital TV 12 is installed, the network I/F 64 of the mobile terminal 21 transmits a recorded contents reproducing request command corresponding to the manipulation.

In Step S411, the recorded contents reproducing request command from the mobile terminal 21 is directly transmitted to the recorder 11 or transmitted through the to-be-controlled TV, that is, the digital TV 12 in the room A, where the user exists, to the recorder 11.

The CPU 31 (FIG. 2) of the recorder 11 receives the recorded contents reproducing request command from the mobile terminal 21 through the network I/F 34, and in Step S401, starts reproducing the recorded contents recorded in the recording medium 37 by controlling recording reproducing control portion 36 in response to the recorded contents reproducing request command.

Next, in Step S402, in the recorder 11, the recorded contents reproduced from the recording medium 37 are transmitted from the network I/F 34 to the to-be-controlled TV, that is, the digital TV 12.

In Step S421, in the digital TV 12, the recorded contents from the recorder 11 are received through the network I/F 44 (FIG. 3), reproduced, and displayed on the display portion 48.

In this manner, in the case where recorded contents are displayed on the display portion 48 of the digital TV 12, for example, when the user viewing the recorded contents displayed on the display portion 48 leaves the room A where the digital TV 12 is installed due to something to do and disappears from the surrounding area of the digital TV 12, in Step S412, the detection portion 65 (FIG. 17) of the mobile terminal 21 detects that the user moves from the surrounding area of the digital TV 12 (movement is detected).

In the case where the contents are displayed on the display portion 48 of the digital TV 12, if the movement is detected by the detection portion 65, in Step S413, the CPU 61 (FIG. 17) of the mobile terminal 21 performs a stopping control of transmitting a stop-reproducing request command of requesting for stopping the reproducing of the recorded contents from the network I/F 64 directly or through a to-be-controlled TV, that is, the digital TV 12 to the recorder 11.

The CPU 31 (FIG. 2) of the recorder 11 receives the stop-reproducing request command from the mobile terminal 21 through the network I/F 34 and, in Step S403, stops reproducing the recorded contents recorded in the recording medium 37 by controlling the recording reproducing control portion 36 in response to the stop-reproducing request command.

In addition, after transmitting the stop-reproducing request command, in Step S414, the CPU 61 of the mobile terminal 21 transmits a power saving mode command of requesting setting the operating mode to the power saving mode to the digital TV 12, through which the user views the recorded contents until the movement is detected, and to another TV, that is, the digital TV 13 on the network 10.

If the power saving mode command is transmitted from the mobile terminal 21, the digital TVs 12 and 13 receive the power saving mode command.

Next, in Step S422, the CPU 41 (FIG. 3) of the digital TV 12 sets the operating mode of the digital TV 12 to the power saving mode in response to the power saving mode command from the mobile terminal 21.

Moreover, in Step S431, the CPU 51 (FIG. 4) of the digital TV 13 sets the operating mode of the digital TV 13 to the power saving mode in response to the power saving mode command from the mobile terminal 21.

In this manner, in the case where the recorded contents are displayed on the display portion 48 of the digital TV 12, if the movement is detected by the detection portion 65, the digital TV 12 sets the operating mode to the power saving mode.

Therefore, when the user does not view the contents, wasteful power consumption caused by displaying the contents on the display portion 48 of the digital TV 12 may be prevented.

After it is detected that the user moves from the surrounding area of the digital TV 12 and, thus, the operating mode of the digital TVs 12 and 13 is set to the power saving mode, for example, if the user, who finishes something to do, does not come back to the room A where the digital TV 12 is installed and enters the room B where the digital TV 13 is installed, in Step S415, the detection portion 65 (FIG. 17) of the mobile terminal 21 detects that the user moves to the surrounding area of the digital TV 13 (arrival is detected).

If the detection portion 65 of the mobile terminal 21 detects that the user arrives to the surrounding area of the digital TV 13, in Step S416, the CPU 61 (FIG. 17) of the mobile terminal 21 controls the network I/F 64 to transmit a normal mode command of requesting for changing the operating mode to the normal mode together with the midway-of-reproducing information indicating that the reproducing of the recorded contents is performed in the midway of the reproducing to the digital TV 13, which is in the vicinity of the user at the time of detecting the arrival, so that the remote control of the digital TV 13 is performed so as to restart the reproducing of the recorded contents, of which the reproducing is stopped by the stopping control of the mobile terminal 21, and to display the recorded contents.

If the normal mode command including midway-of-reproducing information is transmitted from the mobile terminal 21, the digital TV 13 receives the normal mode command.

Next, in Step S432, the CPU 51 (FIG. 4) of the digital TV 13 sets the operating mode of the digital TV 13 to the normal mode in response to the normal mode command from the mobile terminal 21.

Moreover, in the case where the normal mode command including the midway-of-reproducing information is received, in Step S433, the CPU 51 of the digital TV 13 transmits a restarting-reproducing request command of requesting for restarting the reproducing of the recorded contents, of which the reproducing is stopped just before, from the network I/F 54 to the recorder 11 in response to the midway-of-reproducing information include in the normal mode command.

The CPU 31 (FIG. 2) of the recorder 11 receives the restarting-reproducing request command from the digital TV 13 through the network I/F 34 and, in Step S404, restarts reproducing the recorded contents, of which the reproducing is stopped just before, from the recording medium 37 by controlling the recording reproducing control portion 36 in response to the restarting-reproducing request command.

In other words, in the recorder 11, the reproducing of the recorded contents is restarted from the scene of which the reproducing is stopped.

Next, in Step S405, in the recorder 11, the recorded contents of which the reproducing is restarted from the recording medium 37 are transmitted from the network I/F 34 (FIG. 2) to the digital TV 13 which transmits the restarting-reproducing request command.

In Step S434, in the digital TV 13, the recorded contents from the recorder 11 are received, reproduced, and displayed.

In other words, in the digital TV 13, the recorded contents of which the reproducing is stopped due to the transmission of the stop-reproducing request command as a stopping control of the mobile terminal 21 are displayed on the display portion 58 (FIG. 4) from the scene at the time when the movement is detected.

Accordingly, the digital TV 13 in the room B is in the reverted state where the contents presenting (displaying) state reverts to the state at the time when the user leaves the room A.

In other words, in the digital TV 13 in the room B which the user enters, the recorded contents are displayed from the consecutive scene of the recorded contents which the user views at the time when the user leaves the room A.

Therefore, in the room B, the user may restart viewing from the consecutive scene of the recorded contents which the user views just before leaving the room A where the digital TV 12 is installed without returning to the room A where the user views the recorded contents and without particularly manipulating the digital TV 13 in the room B.

In this manner, since the digital TV 13 in the room B is in the reverted state where contents presenting state reverts to the state at the time when the user leaves the room A, it is possible to improve the convenience of the digital TVs 12 and 13.

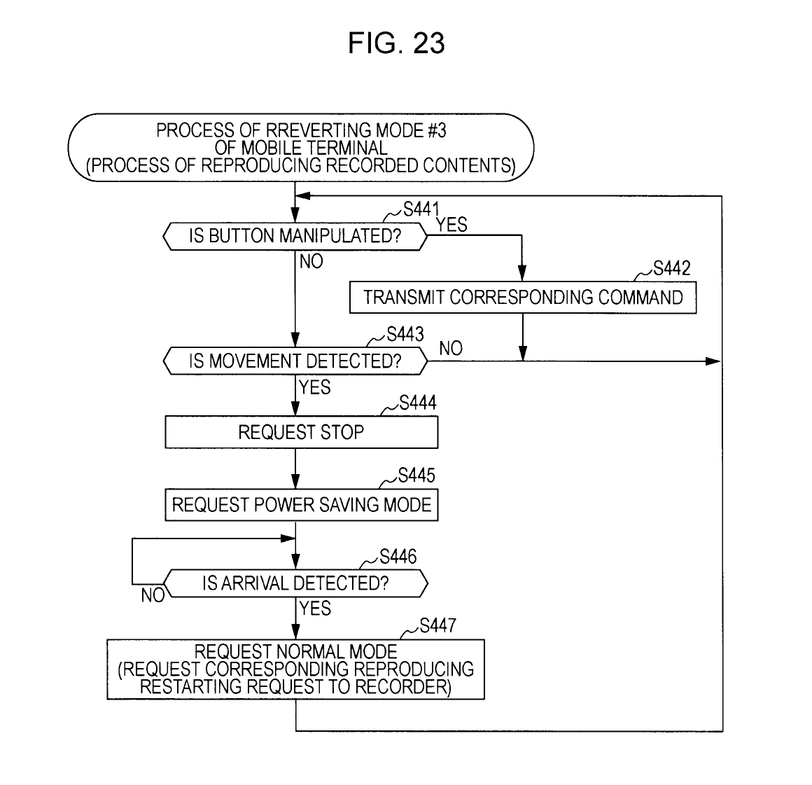

FIG. 23 is a diagram illustrating a process performed by the mobile terminal 21 in a reverting process in a reverting mode #3.

In the mobile terminal 21, in Steps S441 to S443, the same processes as those of Steps S331 to S333 of FIG. 19 are performed.

In other words, in Step S441, the CPU 61 (FIG. 17) of the mobile terminal 21 determines whether or not the input/output mechanism 63A is manipulated (button-manipulated) so as to request the to-be-controlled TV (that is, the digital TV 12 or 13) to perform a predetermined process.

Herein, at the time of performing the process of Step S441, the to-be-controlled TV is powered on, and the operating mode thereof is set to the normal mode. In addition, the recorded contents are configured to be reproduced in the recorder 11 and displayed in the to-be-controlled TV.

In Step S441, in the case where it is determined that the input/output mechanism 63A is manipulated, the process proceeds to Step S442. The CPU 61 (FIG. 17) transmits a command corresponding to the manipulation of the input/output mechanism 63A from the network I/F 64 to the to-be-controlled TV, and the process returns to Step S441.

In addition, in Step S441, in the case where it is determined that the input/output mechanism 63A is not manipulated, the process proceeds to Step S443. The CPU 61 (FIG. 17) of the mobile terminal 21 determines whether or not it is detected that the user moves from the surrounding area of the to-be-controlled TV.

In Step S443, in the case where it is determined that it is not detected that the user moves from the surrounding area of the to-be-controlled TV, the process returns to Step S441.

In addition, in Step S443, in the case where it is determined that it is detected that the user moves from the surrounding area of the to-be-controlled TV, that is, in the case where the movement is detected by the detection portion 65 (FIG. 17), the process proceeds to Step S444. When the movement is detected, the CPU 61 (FIG. 17) of the mobile terminal 21 transmits a stop-reproducing request command of requesting for stopping the reproducing of the reproduced contents displayed in the to-be-controlled TV from the network I/F 64 (FIG. 17) to the recorder 11, and the process proceeds to Step S445.

Herein, if the stop-reproducing request command is transmitted from the mobile terminal 21, the recorder 11 stops the reproducing of the recorded contents.

In Step S445, the CPU 61 of the mobile terminal 21 transmits the power saving mode command from the network I/F 64 to the all the digital TVs 12 and 13 on the network 10 (FIG. 1), and the process proceeds to Step S446.

In Step S446, the CPU 61 (FIG. 17) of the mobile terminal 21 determines whether or not the user is detected to arrive at the surrounding area of any one of the digital TVs 12 and 13 on the network 10.

In Step S446, in the case where it is determined that the user is not detected to arrive at the surrounding area of any one of the digital TVs 12 and 13 on the network 10, the process returns to Step S446.

In addition, in Step S446, in the case where it is determined that the user is detected to arrive at the surrounding area of any one of the digital TVs 12 and 13 on the network 10, that is, in the case where the arrival is detected by the detection portion 65 and, thus, the digital TV 12 or 13 exists in the vicinity of the user, that is, in the vicinity of the mobile terminal 21 carried by the user, the process proceeds to Step S447. The CPU 61 (FIG. 17) of the mobile terminal 21 sets the TV in the vicinity of the user at the time of arrival detection among the digital TVs 12 and 13 as the to-be-controlled TV and transmits a normal mode command including the midway-of-reproducing information from the network I/F 64 to the to-be-controlled TV, the process returns to Step S441.

The to-be-controlled TV that receives the normal mode command including the midway-of-reproducing information from the mobile terminal 21 sets the operating mode to the normal mode according to the normal mode command and transmits the restarting-reproducing request command to the recorder 11 according to the midway-of-reproducing information included in the normal mode command.

If the restarting-reproducing request command is transmitted from the to-be-controlled TV, the recorder 11 restarts reproducing the recorded contents and transmits the recorded contents to the to-be-controlled TV.

In the to-be-controlled TV, the recorded contents from the recorder 11 are received and displayed.

In addition, in the case where the detection portion 65 of the mobile terminal 21 performs the arrival detection according to the intensity of the signal from, for example, the access point 14 (FIG. 1), the arrival detection may not be performed at good accuracy.

In this case, when the movement is detected, the mobile terminal 21 may transmit the power saving mode command to the digital TVs 12 and 13 and transmit necessary commands to the recorder 11, and when the arrival is detected, the mobile terminal 21 may transmit the normal mode command to the to-be-controlled TV by using the user's manipulation of the input/output mechanism 63A as a trigger.

### Third Example of Configuration of Mobile Terminal 21

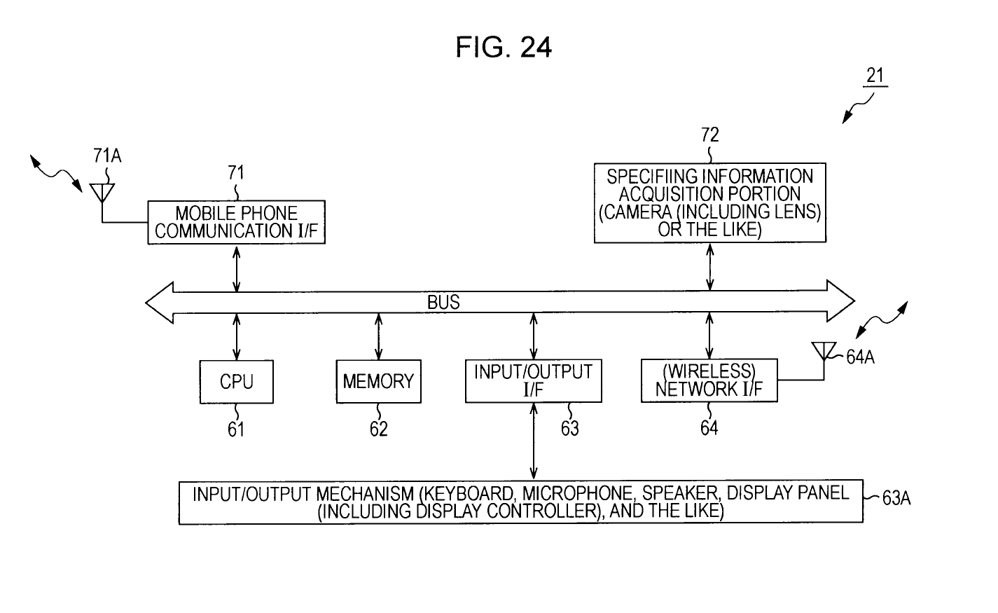

FIG. 24 is a block diagram illustrating a third example of a configuration of the mobile terminal 21 of FIG. 1.

In addition, in the figure, the components corresponding to the case of FIG. 5 are denoted by the same reference numerals, and hereinafter, the description thereof is appropriately omitted.

The mobile terminal 21 of FIG. 24 is the same as the case of FIG. 5 in that the CPU 61 to the antenna 64A are included.

However, the mobile terminal 21 of FIG. 24 is different from the case of FIG. 5 in that the mobile phone communication I/F 71, the antenna 71A, and the specifying information acquisition portion 72 are further included.

In other words, in FIG. 24, the mobile terminal 21 is, for example, a mobile phone, and similarly to the case of FIG. 5, the mobile terminal 21 which is the mobile phone has a function as a remote commander and a function as a wireless LAN client.

In FIG. 24, the mobile phone communication I/F 71 controls communication with a base station by exchanging signals with the base station of the mobile phone through an antenna 71A.

The specifying information acquisition portion 72 acquires specifying information which is information for specifying a device which becomes a device (hereinafter, referred to as a to-be-controlled device) that is to be remotely controlled by the function as a remote commander of the mobile terminal 21.

Herein, as specifying information of a device, an image of the device, an image of a surrounding area of the device, and the like may be used.

In this case, in the case where a camera (including a lens) of photographing images is built in the mobile terminal 21 which is a mobile phone, the camera may be used as the specifying information acquisition portion 72.

The specifying information acquisition portion 72 using a camera acquires an image of a device or an image of a surrounding area of the device by photographing the device or the surrounding area of the device.

In addition, in the mobile terminal 21 of FIG. 24, although the detection portion 65 of FIG. 17 is not provided, the detection portion 65 may be provided.

Herein, in the case where the mobile terminal 21 transmits a command by using infrared rays, for example, when a user in a room B is to remotely control the digital TV 13 in the room B, since the infrared ray transmitted from the mobile terminal 21 does not reach the digital TV 12 in a room A different from the room B, the user may remotely control the digital TV 13 although the digital TV 13 in the room B is not specified as the to-be-controlled device.

On the other hand, in the case where the mobile terminal 21 transmits a command by using a wireless LAN, the command is received through the network 10 by all the devices on the network 10, that is, the recorder 11 and the digital TVs 12 and 13 in the home network system of FIG. 1.

Therefore, among the devices on the network 10, in order to set, for example, a device located in the vicinity of the user as a to-be-controlled device which is to be remotely controlled according to a command transmitted by the mobile terminal 21 and to remotely control the device, it is necessary to specify which device on the network 10 the device located in the vicinity of the user is.

As a method of specifying which device on the network the device located in front of the user's eyes is, a method of using both of the directionality of infrared ray and the convenience of the network is disclosed in, for example, Japanese Unexamined Patent Application Publication No. 2006-115196.

In the method disclosed in Japanese Unexamined Patent Application Publication No. 2006-115196, a device searching command is emitted from the remote commander by using infrared rays, and a device receiving the device searching command notifies existence thereof to the remote commander through a TCP/IP network.

Therefore, in the method disclosed in Japanese Unexamined Patent Application Publication No. 2006-115196, it is necessary that a device which becomes the to-be-controlled device has a function of starting communication through the network in response to a device searching command as infrared rays.

Moreover, it is necessary that each of the remote commander and the device which becomes the to-be-controlled device has a communication function using infrared rays and a communication function using the TCP/IP network.

In addition, as a method of specifying a device which becomes a to-be-controlled device, a method of designating the device which becomes the to-be-controlled device by manipulating direction buttons provided to a remote commander is disclosed in, for example, Japanese Unexamined Patent Application Publication No. 2003-284168.

In other words, in the method disclosed in Japanese Unexamined Patent Application Publication No. 2003-284168, in the remote commander, physical layout information necessary to generate a physical topological map describing a physical layout of a plurality of devices are automatically collected by using wireless or network characteristics, and the physical topological map is generated by using the layout information. Next, in the remote commander, if a user manipulates direction buttons of the remote commander according to an appearance layout, the device which becomes the to-be-controlled device is specified by referring to the physical topological map according to the manipulation of the direction buttons.

Therefore, in the method disclosed in Japanese Unexamined Patent Application Publication No. 2003-284168, it is necessary that, before the remote control is performed, the direction button of the remote commander is manipulated.

Moreover, it is necessary that the device which becomes the to-be-controlled device is provided with wireless or network function used to generate the physical topological map.

On the other hand, with respect to the mobile terminal 21 of FIG. 24, the recorder 11 and the digital TVs 12 and 13 on the network 10, which become the to-be-controlled devices, and the mobile terminal 21 functioning as the remote commander have a function of performing communication through the network 10. In addition, in the case where the mobile terminal 21 is a mobile phone and a camera is built in the mobile phone, the device which becomes the to-be-controlled device may be specified by using the camera as the specifying information acquisition portion 72 which acquires the specifying information for specifying the device which becomes the to-be-controlled device, so that the remote control of the device may be performed.

Hereinafter, processes of the mobile terminal 21 of FIG. 24 are described.

### Device Information Collection Process

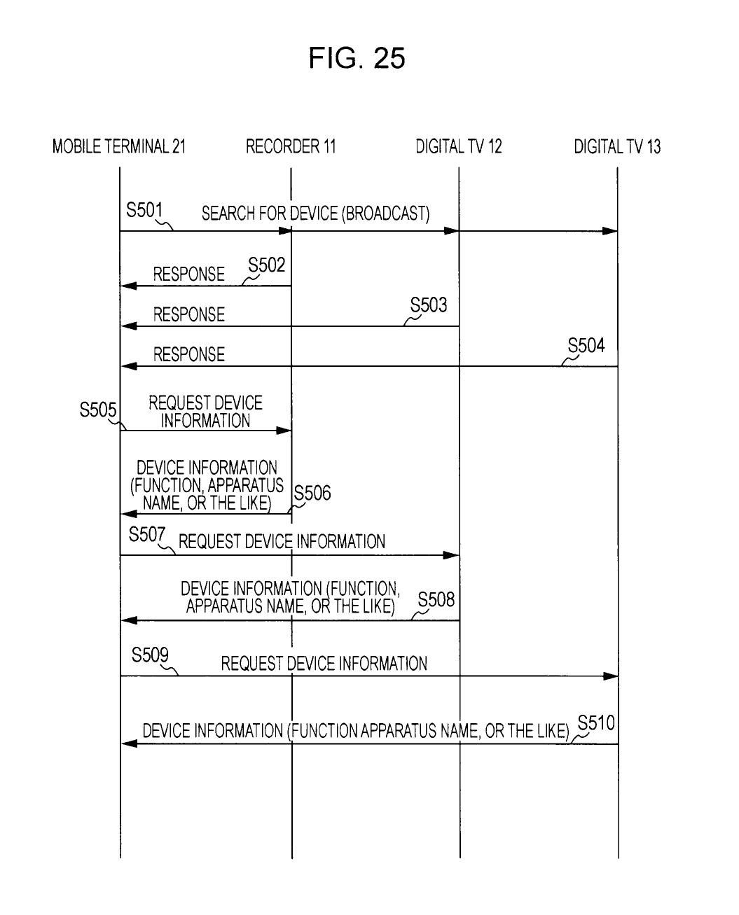

FIG. 25 is a diagram illustrating a device information collection process performed by the mobile terminal 21 of FIG. 24.

For example, if the input/output mechanism 63A (FIG. 24) is manipulated so as to function as a remote commander or if the input/output mechanism 63A is manipulated so as to perform a device information collection process, the mobile terminal 21 performs the device information collection process of collecting device information which is information on a device which becomes a to-be-controlled device of the network 10 (FIG. 1).

In the device collection process, in Step S501, the mobile terminal 21 broadcasts a search packet for searching the device (device), which becomes a to-be-controlled device on the network 10, on the network 10.

The search packet transmitted by the mobile terminal 21 is received by all the devices which become the to-be-controlled devices on the network 10, that is, the recorder 11 and the digital TVs 12 and 13.

The recorder 11 receives the search packet from the mobile terminal 21 and, in Step S502, returns a response packet as a response to the search packet through the network 10 to the mobile terminal 21.

The digital TV 12 also receives the search packet from the mobile terminal 21 and, in Step S503, returns a response packet to the search packet through the network 10 to the mobile terminal 21.

In addition, the digital TV 13 also receives the search packet from the mobile terminal 21 and, in Step S504, returns a response packet to the search packet through the network 10 to the mobile terminal 21.

The mobile terminal 21 receives the response packets returning with respect to the search packet and recognizes all the to-be-controlled device on the network 10, that is, the recorder 11 and the digital TVs 12 and 13 (existence thereof) according to the response packets.

Next, the mobile terminal 21 transmits a request for device information, which is information on the devices such as a function of a device or a name of a device (device name), to each of the to-be-controlled devices existing on the network 10.

In other words, in Step S505, the mobile terminal 21 transmits a device information request (packet) through the network 10 to the recorder 11.

The recorder 11 receives the device information request from the mobile terminal 21 and, in Step S506, transmits the device information of the recorder 11 as a response to the device information request through the network 10 to the mobile terminal 21.

In addition, in Step S507, the mobile terminal 21 transmits a device information request through the network 10 to the digital TV 12.

The digital TV 12 receives the device information request from the mobile terminal 21 and, in Step S508, transmits the device information of the digital TV 12 as a response to the device information request through the network 10 to the mobile terminal 21.

Moreover, in Step S509, the mobile terminal 21 transmits a device information request through the network 10 to the digital TV 13.

The digital TV 13 receives the device information request from the mobile terminal 21 and, in Step S510, transmits the device information of the digital TV 13 as a response to the device information request through the network 10 to the mobile terminal 21.

The mobile terminal 21 receives the device information from the recorder 11 and the digital TVs 12 and 13 and generates a device list where the device information is registered.

Next, the mobile terminal 21 stores the device list in the memory 62 (FIG. 24) and finishes the device information collection process.

In addition, for communication between the mobile terminal 21 and the device, which is a to-be-controlled device on the network 10, for example, an existing protocol such as UPnP (Universal Plug and Play) or DLNA (Digital Living Network Alliance) or a dedicated protocol may be used.

In addition, the device information of the device of the network 10 includes an address (IP (Internet Protocol) address or MAC (Media Access Control) address or the like) for identifying the device on the network 10.

In the mobile terminal 21, after the device list is generated, the remote control of the recorder 11 and the digital TVs 12 and 13 may be able to be performed by the mobile terminal 21.

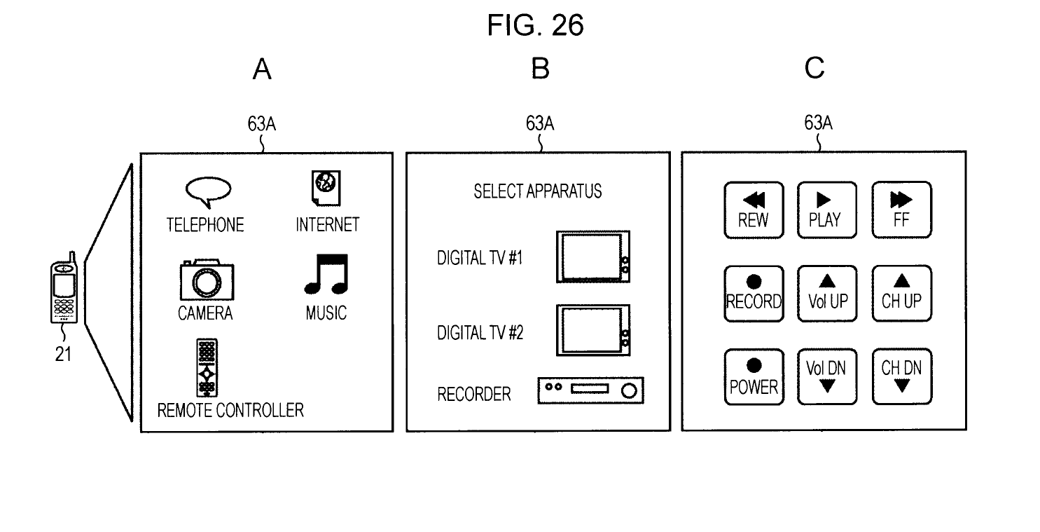

In other words, FIGS. 26A to 26C are diagrams illustrating examples of the display screen displayed on the input/output mechanism 63A (FIG. 24) of the mobile terminal 21 in the case where the mobile terminal 21 is allowed to function as a remote commander.

FIG. 26A is a diagram illustrating a top menu screen displayed on the input/output mechanism 63A of the mobile terminal 21.

In the menu screen of FIG. 26A, icons of “phone”, “Internet”, “camera”, “music”, and “remote controller” are displayed.

If the icon “phone” is selected by, for example, user's manipulation, the mobile terminal 21 functions as a phone, and if the icon “Internet” is selected, the mobile terminal 21 functions as a browser for the Internet.

In addition, if the icon “camera” is selected, the mobile terminal 21 functions as a camera, and if the icon “music” is selected, the mobile terminal 21 functions as a music player (recorder).

In addition, if the icon “remote controller” is selected, the mobile terminal 21 functions as a remote commander.

FIG. 26B is a diagram illustrating an example of selection screen for selecting a to-be-controlled device displayed on the input/output mechanism 63A of the mobile terminal 21 in the case where the icon “remote controller” is selected on the menu screen of FIG. 26A.

If the icon “remote controller” is selected in the menu screen, the mobile terminal 21 generates a selection screen by referring to the device list generated in the device information collection process of FIG. 25 and displays the selection screen.

In the embodiment, in the mobile terminal 21, as described in FIG. 25, since the device list where the device information of the recorder 11 and the digital TVs 12 and 13 is registered is generated, the selection screen displaying the icon “recorder” representing the recorder 11. the icon “digital TV #1” representing the digital TV 12, and the icon “digital TV #2” representing the digital TV 13 is generated according to the device information on the device list.

In the mobile terminal 21, if any one of the icons displayed on the selection screen of FIG. 26B is selected by, for example, user's manipulation, the device represented by the icon is specified as the to-be-controlled device, a manipulation panel including buttons used to manipulate the to-be-controlled device is displayed on the input/output mechanism 63A.

FIG. 26C is a diagram illustrating an example of the manipulation panel displayed on the input/output mechanism 63A of the mobile terminal 21 in the case where the icon “recorder” is selected in the selection screen of FIG. 26B.

The manipulation panel of FIG. 26C includes a “reproduce” button for allowing the recorder 11 represented by the icon “recorder” to perform reproducing, “record” button for allowing the recorder 11 to perform recording, and the like.

In addition, in the mobile terminal 21, the buttons displayed on the manipulation panel are determined according to the device information of the to-be-controlled device (the device represented by the icon selected in the selection screen (FIG. 26B)) among the device information registered in the device list.

Therefore, the buttons displayed on the manipulation panel are different according to the to-be-controlled device.

In the mobile terminal 21 of FIG. 24, in the case where the icon “remote controller” is selected in the menu screen of FIG. 26A, the camera is driven as the specifying information acquisition portion 72 to start photographing images.

Next, the specifying information acquisition portion 72 acquires the image (still image) photographed at a predetermined timing among the images photographed by the cameras as specifying information of the device which is the current to-be-controlled device.

In other words, the specifying information acquisition portion 72 acquires, for example, an image photographed by the camera at the time, when any one of the icons displayed on the selection screen of FIG. 26B is selected, as specifying information of the device (hereinafter, referred to as a selected device) indicated by the icon selected from the selection screen.

The CPU 61 of the mobile phone 21 (FIG. 24) registers the specifying information of the selected device in correspondence with the device information of the selected device in the device list stored in the memory 62.

Herein, the specifying information that is registered in correspondence with the device information in the device list is referred to as registered specifying information.

In addition, the time when the user selects an icon on the selection screen denotes the time when the user desires to perform the remote control of the device (the selected device) indicated by the icon. Therefore, the user is located in the vicinity of the selected device.

Therefore, in the case where the user selects an icon in the selection screen, the specifying information acquisition portion 72 of the mobile terminal 21 carried by the user acquires an image of the selected device or the surrounding area of the selected device as specifying information.

In this manner, with respect to the device of which the registered specifying information is registered in correspondence with the device information in the device list, the user may perform the remote control but not selecting the icon indicating the device on the selection screen (FIG. 26B).

In other words, in the mobile terminal 21, in the case where the icon “remote controller” is selected in the menu screen of FIG. 26A, as described above, the camera is driven as the specifying information acquisition portion 72 to start photographing images.

Next, in the mobile terminal 21, the specifying information acquisition portion 72 (FIG. 24) acquires one or more images among the images photographed by the camera as the specifying information of the to-be-controlled device and supplies the images to the CPU 61.

The CPU 61 compares an image as the specifying information from the specifying information acquisition portion 72 with an image as the registered specifying information registered in the device list stored in the memory 62 and determines whether or not the image as the registered specifying information, which may be considered to match with the image as the specifying information from the specifying information acquisition portion 72, exists.

Next, in the case where the image as the registered specifying information, which may be considered to match with the image as the specifying information from the specifying information acquisition portion 72, exists, the CPU 61 specifies the device of the device information corresponding to the image as the registered specifying information as the to-be-controlled device and displays the manipulation panel (FIG. 26C) of the to-be-controlled device on the input/output mechanism 63A.

On the other hand, in the case where the image as the registered specifying information, which may be considered to match with the image as the specifying information from the specifying information acquisition portion 72, does not exist, the CPU 61 displays the selection screen of FIG. 26B on the input/output mechanism 63A.

Therefore, in the mobile terminal 21, first, after the icon “remote controller” is selected in the menu screen of FIG. 26A, the selection screen (FIG. 26B) for selecting the device which becomes the to-be-controlled device is displayed. However, after that, the displaying frequency of the selection screen is reduced according to the registration of the registered specifying information in the device list.

Next, in the mobile terminal 21, finally, after the icon “remote controller” is selected in the menu screen of FIG. 26A, the device located in the vicinity of the mobile terminal 21 is specified as the to-be-controlled device. Without displaying the selection screen, the manipulation panel (FIG. 26C) of the to-be-controlled device is immediately displayed.

Therefore, the user may remotely control the device in the vicinity thereof as the to-be-controlled device by using the mobile terminal 21 without manipulation of selecting the device in the vicinity thereof in the selection screen, so that it is possible to improve the convenience of the mobile terminal 21.

In addition to acquiring as the image which becomes the registered specifying information an image photographed by the camera at the time when any one of the icons displayed on the selection screen of FIG. 26B is selected, the specifying information acquisition portion 72 (FIG. 24) may acquire as the image which becomes the registered specifying information an image photographed by the camera at the time when a message of urging the user to photograph the image which becomes the registered specifying information is displayed on the input/output mechanism 63A and the user manipulates the mobile terminal 21 so as to photograph according to the message.

Which one of the image photographed by the camera at the time when any one of the icons displayed on the selection screen of FIG. 26B is selected and the image photographed by the camera at the time when the user manipulates the mobile terminal 21 so as to photograph is to be acquired as the image which becomes the registered specifying information is, for example, predetermined in the mobile terminal 21 or switchably determined in response to user's manipulation.

In addition, in the mobile terminal 21, the comparison of the image as the specifying information from the specifying information acquisition portion 72 with the image as the registered specifying information registered in the device list stored in the memory 62 may be performed just after the icon “remote controller” is selected in the menu screen of FIG. 26A and the camera as the specifying information acquisition portion 72 is driven or may be performed during the time when the mobile terminal 21 functions as the remote commander.

Moreover, the determination whether or not the image as the registered specifying information, which may be considered to match with the image as the specifying information acquired by the specifying information acquisition portion 72, exists, may be performed by comparing all the images between the images as the specifying information from the specifying information acquisition portion 72 and the images as the registered specifying information registered in the device list stored in the memory 62 or may be performed by comparing only the textures (colors, shapes, or the like) of floors or walls reflected in the images.

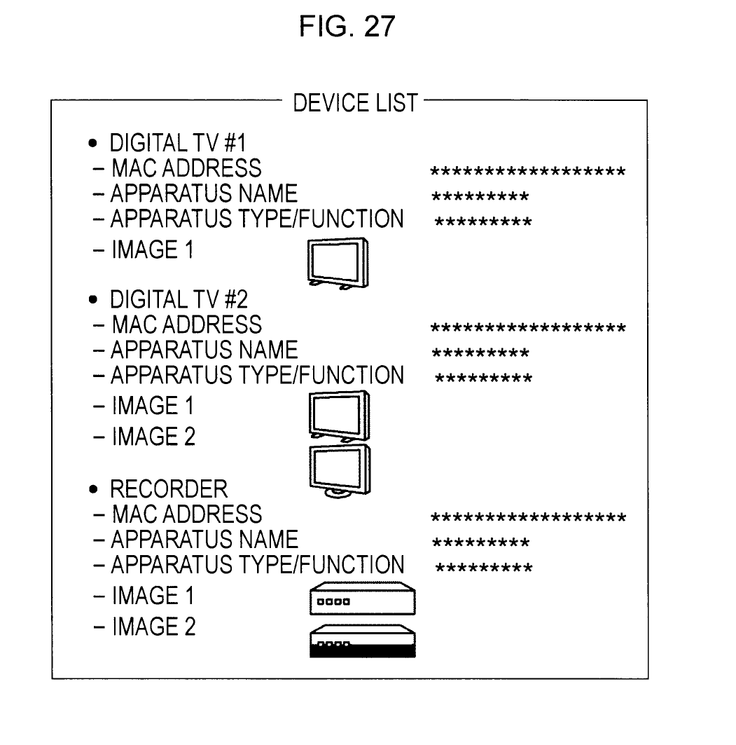

FIG. 27 is a diagram schematically illustrating a device list generated through the mobile terminal 21.

In FIG. 27, in the device list, MAC addresses, device names, and device functions (device type/function) are registered as device information with respect to three devices of “digital TV #1”, “digital TV #2”, and “recorder”.

Moreover, in FIG. 27, the image as one registered specifying information is registered in correspondence with the device information with respect to the device “digital TV #1”, and the images as two registered specifying information are registered in correspondence with the device information with respect to the devices “digital TV #2” and “recorder”.

For example, in the device “digital TV #2” where a plurality of, that is, the two images as the registered specifying information are registered in correspondence with the device information, in the case where the one of the two images as the registered specifying information is considered to match with the image as the specifying information acquired from the specifying information acquisition portion 72 (FIG. 24), the device “digital TV #2” is specified as the to-be-controlled device.

With respect to the device “recorder” where the two images as the registered specifying information are registered in correspondence with the device information, the similar configuration may be employed.

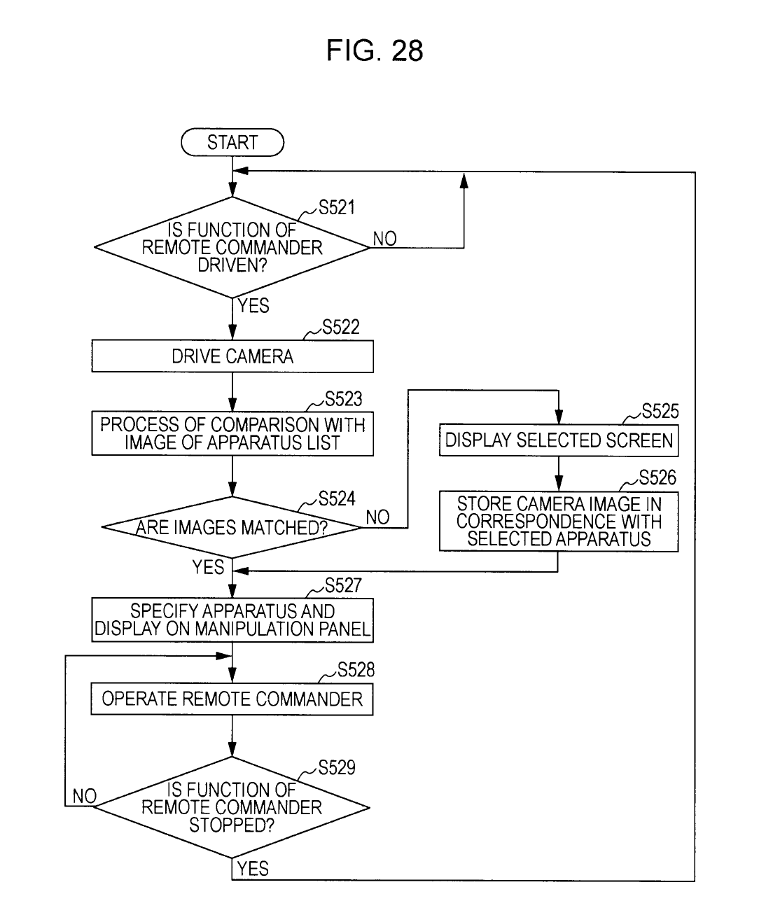

FIG. 28 is a flowchart illustrating a process of the mobile terminal 21 of FIG. 24 while focusing the function as the remote commander.

In Step S521, the mobile terminal 21 determines whether or not the input/output mechanism 63A (FIG. 24) is manipulated so as to function as a remote commander. In the case where the input/output mechanism 63A is determined not to be manipulated, the process returns to Step S521.

In addition, in Step S521, in the case where it is determined that the input/output mechanism 63A is manipulated so as to function as the remote commander, that is, in the case where the menu screen of FIG. 26A is displayed on the input/output mechanism 63A and the icon “remote controller” is selected from the menu screen, the process proceeds to Step S522. The mobile terminal 21 drives the camera as the specifying information acquisition portion 72 (FIG. 24) to photograph images.

Next, the specifying information acquisition portion 72 acquires images photographed by the camera as specifying information, and the process proceeds from Step S522 to Step S523. The mobile terminal 21 compares the image as the specifying information (hereinafter, referred to as acquired specifying information) acquired by the specifying information acquisition portion 72 in the just-preceding Step S522 with the image as the registered specifying information registered in the device list stored in the memory 62 (FIG. 24), and the process proceeds to Step S524.

In Step S524, the mobile terminal 21 determines based on the result of comparison of the image as the acquired specifying information of Step S523 with the image as the registered specifying information whether or not the image as the registered specifying information which is considered to match with the image as the acquired specifying information exists in the device list.

In Step S524, in the case where it is determined that the image as the registered specifying information which is considered to match with the image as the acquired specifying information does not exist in the device list, the process proceeds to Step S525. The mobile terminal 21 displays the selection screen of FIG. 26B on the input/output mechanism 63A.

Next, by waiting for the user's selection of the icon displayed on the selection screen, the process proceeds from Step S525 to Step S526. The mobile terminal 21 registers the image (camera image) as the specifying information acquired by the specifying information acquisition portion 72 in the just-preceding Step S522 as the registered specifying information in the device list in correspondence with the device information of the device (the selected device) represented by the icon selected from the selection screen.

After that, the process proceeds from Step S526 to Step S527. The mobile terminal 21 specifies the selected device as the to-be-controlled device and displays the manipulation panel (FIG. 26C) of the to-be-controlled device on the input/output mechanism 63A, and the process proceeds to Step S528.

On the other hand, in Step S524, in the case where it is determined that the image as the registered specifying information which is considered to match with the image as the acquired specifying information exists in the device list, the process proceeds to Step S527. The mobile terminal 21 specifies the device of the device information corresponding to the image as the registered specifying information, which is considered to match with the image (camera image) as the acquired specifying information, as the to-be-controlled device in the device list and displays the manipulation panel (FIG. 26C) of the to-be-controlled device on the input/output mechanism 63A, and the process proceeds to Step S528.

In Step S528, the mobile terminal 21 operates as the remote commander of remotely controlling the to-be-controlled device in response to user's manipulation of the manipulation panel (FIG. 26C), and the process proceeds to Step S529.

Herein, in Step S528, in the case where the to-be-controlled device is powered off, the mobile terminal 21 may transmit a command of requesting for powering on to the to-be-controlled device without waiting for user's manipulation of the manipulation panel (FIG. 26C).

In this case, the user may immediately perform desired manipulation on the to-be-controlled device (perform the desired manipulation without performing the manipulation of powering on).

In Step S529, the mobile terminal 21 determines whether or not the input/output mechanism 63A is manipulated so as to stop the function (remote commander function) as the remote commander.

In Step S529, in the case where it is determined that the input/output mechanism 63A is not manipulated so as to stop the remote commander function, the process returns to Step S528.

In addition, in Step S529, in the case where it is determined that the input/output mechanism 63A is manipulated so as to stop the remote commander function, the process returns to Step S521.

In this manner, in the device where the image as the registered specifying information is registered in the device list, in the case where the image as the registered specifying information is considered to match with the image as the specifying information acquired from the specifying information acquisition portion 72, the image as the registered specifying information is specified as the to-be-controlled device, and the manipulation panel (FIG. 26C) of the to-be-controlled device is displayed on the input/output mechanism 63A, so that the user may remotely control the device as the user seems to have a remote commander dedicated to the device in front of the user's eyes.

In addition, in the embodiment, the to-be-controlled device is specified by using many types of camera built in mobile phones as the specifying information acquisition portions 72 and by using images acquired by the specifying information acquisition portions 72 as the specifying information. Therefore, irrespective of the types of the devices which become the to-be-controlled device, the user may remotely control the device in front of the user's eyes as the to-be-controlled device.

In addition, in the embodiment, in the case where the device which becomes the to-be-controlled device is selected in the selection screen (FIG. 26B), the image as the registered specifying information is photographed by the camera. However, for example, the image as the registered specifying information may be photographed by the camera when the user performs a setting task of the mobile terminal 21 or the device which becomes the to-be-controlled device.

In addition, as the image which becomes the registered specifying information of the device, one or more images obtained by photographing the device may be employed and stored as the registered specifying information in the device in advance. In this case, the image as the registered specifying information stored in the device in advance may be transmitted from the device through the network 10 to the mobile terminal 21, so that the specifying information acquisition portion 72 may acquire the transmitted image as the registered specifying information.

Moreover, besides the image of the device which becomes the to-be-controlled device or the surrounding area of the device, position information of the mobile terminal 21 acquired by GPS, signal intensities (electric field intensities) of signals from the access point 14, the base station of the mobile phone, or other wireless signal transmission apparatuses, or the like are employed as the specifying information.

Herein, in the case where the image which becomes the registered specifying information are stored in the device which becomes the to-be-controlled device in advance and are transmitted through the network 10 to the mobile terminal 21 to be used as the registered specifying information, it is preferable that a plurality of images obtained by photographing the device at a plurality of angles are stored as the images which become the registered specifying information in the device which becomes the to-be-controlled device.

In addition, in the case where the image of the device is employed as the specifying information, the mobile terminal 21 may display a message of arousing user's attention so that the user directs the photographing direction of the camera to the direction of the device. It may be switchably changed, for example, according to the user's manipulation whether or not the message of arousing user's attention is displayed on the mobile phone 21.

Moreover, in the specification of the invention, the processes performed according to the program by the computer (CPU) may not necessarily be performed in a time sequence according to the procedure illustrated in the flowcharts. In other words, the processes performed according to the program by the computer may include in-parallel or individually performed processes (for example, parallel processes or object-oriented processes).

In addition, the program may be processed by one computer (processor) or may be distributively processed by a plurality of computers.

In addition, the embodiment of the invention is not limited to the aforementioned embodiment, but various modifications may be available without departing from the spirit of the invention.

In other words, for example, the processes performed according to the program by the aforementioned computer (CPU) may be implemented with dedicated hardware.

The present application contains subject matter related to that disclosed in Japanese Priority Patent Application JP 2009-269406 filed in the Japan Patent Office on Nov. 27, 2009, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display control apparatus comprising:
an acquisition portion configured to acquire contents;
a display controller configured to display the contents on a display portion;
a user detection portion configured to detect whether or not a user viewing the contents exist in the surrounding area;
a communication controller configured to control communication with a different display control apparatus displaying the contents; and
a controller configured so that, in the case where the contents are displayed by the different display control apparatus, when the user does not exist in a surrounding area of the different display control apparatus, after absence information indicating that the user does not exist, which is transmitted from the different display control apparatus, is received by the communication controller, in the case where it is detected by the user detection portion that the user exists, the controller allows the acquisition portion to acquire the contents which are displayed by the different display control apparatus which transmits the absence information and displays the contents on the display portion.

2. The display control apparatus according to claim 1, wherein in the case where the contents are displayed on the display portion, when it is detected by the user detection portion that the user does not exist, the communication controller transmits different absence information indicating that the user does not exist to the different display control apparatus.

3. The display control apparatus according to claim 1,
wherein in the case where the contents are displayed by the different display control apparatus, when the user does not exist in the surrounding area of the different display control apparatus, the different display control apparatus performs a recording control of recording the contents displayed by the different display control apparatus in a recording medium, and
wherein after the absence information from the different display control apparatus is received by the communication controller, in the case where it is detected by the user detection portion that the user exists, the controller reproduces the contents recorded in the recording medium by the recording control of the different display control apparatus which transmits the absence information and displays the contents on the display portion.

4. The display control apparatus according to claim 3, wherein in the case where the contents acquired by the acquisition portion are displayed on the display portion, where it is detected by the user detection portion that the user does not exist, the controller records the contents displayed on the display portion in the recording medium.

5. The display control apparatus according to claim 3,
wherein the user detection portion further detects a line of sight of the user, and
wherein after the absence information from the different display control apparatus is received by the communication controller, in the case where it is detected by the user detection portion that the user exists and the line of sight of the user is directed toward the display portion continuously for a predetermined time or more, the controller reproduces the contents recorded in the recording medium by the recording control of the different display control apparatus which transmits the absence information and displays the contents on the display portion.

6. The display control apparatus according to claim 1,
wherein in the case where the contents reproduced from the recording medium are displayed by the different display control apparatus, when the user does not exist in the surrounding area of the different display control apparatus, the different display control apparatus performs a stopping control of stopping the reproducing of the contents from a recording medium, and
wherein after the absence information from the different display control apparatus is received by the communication controller, in the case where it is detected by the user detection portion that the user exists, the controller restarts the reproducing of the contents from the recording medium, which are stopped by the stopping control of the different display control apparatus which transmits the absence information, and displays the contents on the display portion.

7. The display control apparatus according to claim 6, wherein in the case where the contents reproduced from the recording medium are displayed on the display portion, when it is detected by the user detection portion that the user does not exist, the controller stops the reproducing of the contents from the recording medium.

8. A display control system comprising:
a display control apparatus including:
an acquisition portion configured to acquire contents;
a display controller configured to display the contents on a display portion;
a user detection portion configured to detect whether or not a user viewing the contents exist in the surrounding area;
a communication controller configured to control communication with a different display control apparatus displaying the contents; and
a controller configured so that, in the case where the contents are displayed by the different display control apparatus, when the user does not exist in a surrounding area of the different display control apparatus, after absence information indicating that the user does not exist, which is transmitted from the different display control apparatus, is received by the communication controller, in the case where it is detected by the user detection portion that the user exists, the controller allows the acquisition portion to acquire the contents which are displayed by the different display control apparatus which transmits the absence information and displays the contents on the display portion, and
a different display control apparatus including:
a different acquisition portion configured to acquire contents;
a different display controller configured to display the contents on a different display portion;
a different user detection portion configured to detect whether or not a user viewing the contents exist in the surrounding area;
a different communication controller configured to control communication with the display control apparatus so that, in the case where the contents are displayed on the different display portion, when it is detected by the different user detection portion that the user does not exist, the different communication controller transmits the absence information to the display control apparatus.

9. A remote control apparatus comprising:
a communication controller configured to transmit a command of remotely controlling a display control apparatus which displays contents on a display portion;
a user detection portion configured to detect movement of a user viewing the contents;
a controller configured so that, in the case where the contents are displayed by the display control apparatus, after it is detected by the user detection portion that the user moves from a surrounding area of the display control apparatus, when it is detected that the user moves to a surrounding area of a different display control apparatus, the controller controls the different display control apparatus to display the contents displayed in the display control apparatus.

10. The remote control apparatus according to claim 9,
wherein in the case where the contents are displayed by the display control apparatus, when it is detected by the user detection portion that the user moves to the surrounding area of the display control apparatus, the controller performs a recording control of recording the contents displayed by the display control apparatus in a recording medium, and
wherein, after that, in the case where it is detected by the user detection portion that the user moves from the surrounding area of the different display control apparatus, the controller controls the different display control apparatus to display the contents recorded in the recording medium by the recording control.

11. The remote control apparatus according to claim 9,
wherein in the case where the contents reproduced from a recording medium are displayed by the display control apparatus, when it is detected by the user detection portion that the user moves from the surrounding area of the display control apparatus, the controller performs a stopping control of stopping the reproducing of the contents from the recording medium, and
wherein, after that, in the case where it is detected by the user detection portion that the user moves from the surrounding area of the different display control apparatus, the controller restarts the reproducing of the contents from the recording medium, which are stopped by the stopping control, and displays the contents in the different display control apparatus.
